(19) United States
(12) Patent Application Publication
(10) Pub. No.: US 2025/0178280 A1
(43) Pub. Date: Jun. 5, 2025

(54) Methods and Systems for Making Polymeric Microstructures

(71) Applicant: The Board of Trustees of the Leland Stanford Junior University, Stanford, CA (US)

(72) Inventors: Gabriel E. Lipkowitz, Stanford, CA (US); Tim Samuelsen, Stanford, CA (US); Joseph M. DeSimone, Stanford, CA (US); Maria T. Dulay, Stanford, CA (US); Eric S.G. Shaqfeh, Stanford, CA (US)

(21) Appl. No.: 18/843,808

(22) PCT Filed: Mar. 16, 2023
(86) PCT No.: PCT/US2023/015406

§ 371 Date: Sep. 4, 2024

Related U.S. Application Data
(60) Provisional application No. 63/321,052, filed on Mar. 17, 2022.

(51) Int. Cl. B29C 64/336; B29C 64/106; B29C 64/205; B29C 64/393; B33Y 10/00; B33Y 30/00; B33Y 50/02

(52) U.S. Cl. CPC B29C 64/336; B29C 64/106; B29C 64/205; B29C 64/393; B33Y 10/00; B33Y 30/00; B33Y 50/02

(57) ABSTRACT

Aspects of the present disclosure include methods for making a polymeric structure having one or more microchannels. Methods according to certain embodiments include conveying a polymerizable composition through a conduit into a space between a build elevator and a build surface of a liquid interface production module, irradiating the polymerizable composition positioned between the build elevator and the build surface to generate a polymerizable composition having a first polymerized region of the polymerizable composition having a microchannel in contact with the build elevator and a first non-polymerized region of the polymerizable composition in contact with the build surface, displacing the build elevator away from the build surface, irradiating the first non-polymerized region of the polymerizable composition to generate a second polymerized region of the polymerizable composition in contact with the first polymerized region and a second non-polymerized region in contact with the build surface and repeating one or more steps in a manner sufficient to generate a polymeric structure having one or more microchannels positioned within the polymeric structure. Systems having a conduit for conveying a polymerizable composition to a liquid interface polymerization module having a build elevator and a build surface configured are also described. Polymer structures having a predetermined fluidic microchannel network prepared by the subject methods and non-transitory computer readable storage medium for practicing the subject methods are also provided.

### CROSS-REFERENCE TO RELATED APPLICATIONS

Pursuant to 35 U.S.C. § 119 (e), this application claims priority to the filing date of U.S. Provisional Patent Application Ser. No. 63/321,052 filed Mar. 17, 2022; the disclosure of which application is incorporated herein by reference in their entirety.

### INTRODUCTION

Additive manufacturing applications for printing polymeric resins has been used in applications of personalized human protection, wearable electronics functionally graded materials. Printed materials have been shown to have desirable mechanical, electrical, and chemically stable properties. Continuous liquid interface production (CLIP) like other digital light projection (DLP) methods, projects a rapid sequence of ultraviolet patterns (UV) to photopolymerize a resin layer-by-layer. Other DLP methods which require layer by layer delamination between each exposure. CLIP generates a polymer structure by resin renewal underneath the build surface through a continuous liquid interface, the dead zone, created by oxygen, a polymerization inhibitor, fed through the highly oxygen permeable window at the bottom of the resin reservoir. The combination of improved optical projection and CLIP technology has allowed printers to reach sub-micron lateral (XY) resolution at speeds 100 times faster than other 3D printing methods.

The ability to achieve a high Z resolution is needed for fabrication of negative spaces (channels, voids, etc.), an overarching characteristic of microelectronic, microsensor and microfluidic devices. Despite CLIPs ability to resolve sub-micron features in the XY plane, its ability to resolve features on this scale in the build (Z) direction is severely limited in negative feature size. This is due to UV light penetrating previously fabricated layers causing polymerization of trapped unpolymerized resin in negative spaces.

### SUMMARY

Aspects of the present disclosure include methods for making a polymeric structure having one or more microchannels. Methods according to certain embodiments include conveying a polymerizable composition through a conduit into a space between a build elevator and a build surface of a liquid interface production module, irradiating the polymerizable composition positioned between the build elevator and the build surface to generate a polymerizable composition having a first polymerized region of the polymerizable composition having a microchannel in contact with the build elevator and a first non-polymerized region of the polymerizable composition in contact with the build surface, displacing the build elevator away from the build surface, irradiating the first non-polymerized region of the polymerizable composition to generate a second polymerized region of the polymerizable composition in contact with the first polymerized region and a second non-polymerized region in contact with the build surface and repeating one or more steps in a manner sufficient to generate a polymeric structure having one or more microchannels positioned within the polymeric structure. Systems having a conduit for conveying a polymerizable composition to a liquid interface polymerization module having a build elevator and a build surface configured are also described. Polymer structures having a predetermined fluidic microchannel network prepared by the subject methods and non-transitory computer readable storage medium for practicing the subject methods are also provided.

In some embodiments, methods include injecting the polymerizable composition through the conduit with a syringe pump. In some instances, the polymerizable composition is conveyed through two or more conduits into the space between the build elevator and the build surface. In some instances, the conduit is positioned internal to the generated polymeric structure. In other instances, the conduit is positioned external to the generated polymeric structure. In certain instances, the polymerizable composition is conveyed through a conduit that passes through the build elevator. In some embodiments, methods include conveying two or more different polymerizable materials into the space between the build elevator and the build surface. In some instances, a first polymerizable material is conveyed through a first conduit into the space between the build elevator and the build surface and a second polymerizable material is conveyed through a second conduit into the space between the build elevator and the build surface. In certain embodiments, a plurality of different polymerizable materials is conveyed through a plurality of different conduits into the space between the build elevator and the build surface.

In some instances, the polymerizable material has a viscosity of from 100 cP to 7000 cP. In some instances, the polymerizable material is conveyed through the conduit into the space between the build elevator and the build surface at a flow rate of from 0.1 μL/s to 50 μL/s, such as from 5 μL/s to 30 μL/s, such as from 7 μL/s to 27 μL/s. In some embodiments, the polymeric structure is generated at a rate of from 5 mm/hr to 150 mm/hr, such as from 25 mm/hr to 125 mm/hr.

In some embodiments, methods include modeling a predetermined fluidic network geometry for the microchannels positioned within the polymeric structure. In some instances, modeling the predetermined fluidic network geometry for the microchannels positioned within the polymeric structure includes determining the position of one or more injection nodes. In some instances, the injection nodes are determined to be at a position in the fluidic network where suction forces generated when displacing the build elevator away from the build surface are minimized. In some embodiments, modeling the predetermined fluidic network geometry includes determining the size of each microchannel to be generated within the polymeric structure. In some embodiments, modeling the predetermined fluidic network geometry includes determining the number of microchannels to be generated within the polymeric structure. In some instances, the predetermined fluidic network geometry of the microchannels is based on the three-dimensional shape of the generated polymeric structure. In some instances, modeling the predetermined fluidic network geometry includes determining the size and position of the microchannel after each displacement of the build elevator.

In embodiments, the build elevator is displaced from the build surface to generate the polymeric structure having one or more microchannels. In some instances, the build elevator is displaced in predetermined increments of from 0.5 μm to 1.0 μm. In some instances, methods include adding polymerizable composition to the build surface after each displacement of the build elevator away from the build surface. In some instances, the polymerizable composition is irradiated through build surface. In some instances, the polymerizable composition is irradiated in the presence of a polymerization inhibitor (e.g., oxygen). In some instances, the polymerizable composition is continuously polymerized while displacing the build elevator away from the build surface. In certain instances, the build surface is permeable to the polymerization inhibitor.

In embodiments, the polymerizable composition is irradiated in a space between a build elevator and a build surface of the liquid interface production module. In some embodiments, the polymerizable composition is irradiated with light, such as with a micro-digital light projection system. In some instances, the micro-digital light projection system includes a light beam generator component and a light projection monitoring component. In some instances, the light beam generator component includes a light source, a tube lens and one or more projection lenses. In some instances, the light projection monitoring component includes a photodetector.

In certain embodiments, methods include filling at least a portion of the void volume of one or more microchannels of the generated polymeric structure. In some instances, 5% or more of the void volume of the microchannels is filled, such as 50% or more. In certain instances, the void volume of the microchannels is filled with a polymerizable material. In some instances, the void volume of the microchannels is filled with a non-polymerizable material. In certain instances, the void volume of the microchannels is filled with the same polymerizable material used to prepare the polymeric structure.

Aspects of the present disclosure also include systems for making a polymeric structure having one or more microchannels positioned within the polymeric structure. Systems according to certain embodiments include a light source, a liquid interface polymerization module having a build elevator and a build surface configured for generating the polymeric structure having one or more microchannels from a polymerizable composition positioned therebetween and a conduit for conveying polymerizable composition to the liquid interface polymerization module. In some embodiments, systems include a syringe pump configured to inject the polymerizable composition into the liquid interface polymerization module through the conduit. In some instances, the system includes two or more conduits in fluid communication with a source of the polymerizable composition and the liquid interface polymerization module. In certain instances, the conduit passes through the build elevator. In some embodiments, the system is configured to convey the polymerizable composition through the conduit to the liquid interface polymerization module at a flow rate of from 0.1 μL/s to 50 μL/s, such as from 5 μL/s to 30 μL/s, such as from 7 μL/s to 27 μL/s.

In some embodiments, the system includes a processor having memory operably coupled to the processor wherein the memory includes instructions stored thereon, which when executed by the processor, cause the processor to: a) irradiate a polymerizable composition positioned between the build elevator and the build surface to generate a polymerizable composition having a first polymerized region of the polymerizable composition in contact with the build elevator and a first non-polymerized region of the polymerizable composition in contact with the build surface; b) displace the build elevator away from the build surface; c) irradiate the first non-polymerized region of the polymerizable composition to generate a second polymerized region of the polymerizable composition in contact with the first polymerized region and a second non-polymerized region in contact with the build surface; and d) repeat steps a)-c) in a manner sufficient to generate a polymeric structure having one or more microchannels positioned within the polymeric structure. In some instances, the memory includes instructions for modeling a predetermined fluidic network geometry for the microchannels positioned within the polymeric structure. In some instances, the memory includes instructions for determining the position of one or more injection nodes. In some instances, the memory includes instructions for determining the position of one or more injection nodes where suction forces generated when displacing the build elevator away from the build surface are minimized. In some instances, the memory includes instructions for determining the size of each microchannel to be generated within the polymeric structure. In some instances, the memory includes instructions for determining the number of microchannels to be generated within the polymeric structure. In some instances, the predetermined fluidic network geometry of the microchannels is based on the three-dimensional shape of the generated polymeric structure. In some instances, the memory includes instructions for determining the size and position of the microchannel after each displacement of the build elevator. In some instances, the memory includes instructions for displacing the build elevator in predetermined increments, such as in increments of 0.5 μm to 1.0 μm. In certain instances, the memory includes instructions for adding polymerizable composition to the build surface after each displacement of the build elevator away from the build surface.

In embodiments, systems include a light source for irradiating the build surface. In some instances, at least part of the build surface is permeable to a polymerization inhibitor (e.g., oxygen). In some instances, the light source includes micro-digital light projection system having a light beam generator component and a light projection monitoring component. In some instances, the light beam generator component includes a light source, a tube lens and one or more projection lenses. In certain instances, the light projection monitoring component includes a photodetector.

Aspects of the present disclosure also include polymeric structures having one or more microchannels positioned within the polymeric structure prepared by the subject methods described herein. In some instances, the polymer structure includes a plurality of microchannels. In some instances, one or more of the microchannels includes one or more bifurcations, such as 2 or more bifurcations. In some instances, the microchannels extend through the polymeric structure. In some instances, the microchannels are fluidically interconnected. In some instances, the polymeric structure has a single network of fluidically interconnected microchannel networks. In other instances, the polymeric structure has a plurality of fluidically interconnected microchannel networks. In some embodiments, each microchannel has a diameter of from 0.1 μm to 20 μm. In some instances, the polymeric structure has a lattice microstructure. In other instances, the polymeric structure has a solid microstructure.

In some embodiments, the polymeric structure is formed from one or more polymerizable materials, such as two or more different polymerizable materials, such as three or more and including four or more different polymerizable materials. In some instances, each polymerizable material is selected from polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof. In certain instances, one or more of the polymerizable materials includes carbon nanotubes, such as single-walled carbon nanotubes (SWCNTs) or multi-walled carbon nanotubes (MWCNTs). In some embodiments, one or more of the microchannels includes a composition positioned therein which fills at least a portion of the void volume of the microchannels, such as where 5% or more of the void volume of the microchannel is filled with a composition. In some instances, the composition that fills the void volume of the microchannel is a non-polymeric composition. In some instances, the microchannels of the polymeric structure is filled with a polymeric composition, such as a polymerizable material selected from polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof. In certain embodiments, the polymerizable material used to fill the microchannels of the polymeric structure is the same polymerizable material used to form the polymeric structure. In certain instances, the composition that fills the void volume of the microchannels includes carbon nanotubes.

Aspects of the present disclosure also include non-transitory computer readable storage medium for making a polymeric structure in a liquid interface production module. In some instances, the non-transitory computer readable storage medium has instructions stored thereon that include: algorithm for conveying a polymerizable composition through a conduit into a space between a build elevator and a build surface of a liquid interface production module, algorithm for irradiating the polymerizable composition positioned between the build elevator and the build surface to generate a polymerizable composition having a first polymerized region of the polymerizable composition having a microchannel in contact with the build elevator and a first non-polymerized region of the polymerizable composition in contact with the build surface, algorithm for displacing the build elevator away from the build surface, algorithm irradiating the first non-polymerized region of the polymerizable composition to generate a second polymerized region of the polymerizable composition in contact with the first polymerized region and a second non-polymerized region in contact with the build surface and algorithm for repeating one or more steps in a manner sufficient to generate a polymeric structure that includes one or more microchannels positioned within the polymeric structure. In some instances, the non-transitory computer readable storage medium has algorithm for injecting the polymerizable composition through the conduit with a syringe pump.

In some instances, the non-transitory computer readable storage medium has algorithm for conveying a plurality of different polymerizable materials through a plurality of different conduits into the space between the build elevator and the build surface. In certain instances, the non-transitory computer readable storage medium has algorithm for conveying a first polymerizable material through a first conduit into the space between the build elevator and the build surface; and algorithm for conveying a second polymerizable material through a second conduit into the space between the build elevator and the build surface. In certain instances, the non-transitory computer readable storage medium has algorithm for modeling a predetermined fluidic network geometry for the microchannels positioned within the polymeric structure. In some instances, the non-transitory computer readable storage medium has algorithm for determining the position of one or more injection nodes. In certain instances, the non-transitory computer readable storage medium has algorithm for determining the position for injection nodes to be at a position in the fluidic network where suction forces generated when displacing the build elevator away from the build surface are minimized. In some instances, the non-transitory computer readable storage medium has algorithm for determining the size of each microchannel to be generated within the polymeric structure. In some instances, the non-transitory computer readable storage medium has algorithm for determining the number of microchannels to be generated within the polymeric structure. In some instances, the non-transitory computer readable storage medium has algorithm for modeling the predetermined fluidic network geometry for the microchannels positioned within the polymeric structure based on the three-dimensional shape of the generated polymeric structure. In certain instances, the non-transitory computer readable storage medium has algorithm for determining the size and position of the microchannel after each displacement of the build elevator. In some embodiments, the non-transitory computer readable storage medium has algorithm for adding polymerizable composition to the build surface after each displacement of the build elevator away from the build surface.

### BRIEF DESCRIPTION OF THE FIGURES

The invention may be best understood from the following detailed description when read in conjunction with the accompanying drawings. Included in the drawings are the following figures:

FIG. 1A depicts a system for making a polymeric structure according to certain embodiments. FIG. 1B depicts analytically derived dead zone velocity fields and pressure gradients from the lubrication theory while printing a cylindrical geometry by CLIP, where z and r are the vertical and radial distances in the dead zone, respectively, and vᵣ is the radial velocity. Darker hues indicate higher-magnitude velocity vectors, and, conversely, lighter hues indicate stagnation zones of low-fluid velocity. FIG. 1B also depicts analytically derived dead zone velocity fields and pressure gradients from the lubrication theory while printing a cylindrical geometry by iCLIP, with continuous injection through a central viaduct.

FIGS. 2A-2E depict conventional 3D printing approaches which require the use of external support structures.

FIGS. 3A-3I depict polymeric structures having solid and lattice microstructures having a microchannel positioned therein according to certain embodiments.

FIG. 4 depicts deformation of a polymeric structure having a lattice microstructure according to certain embodiments.

FIGS. 5A-5F depict the acceleration printing of 3D geometries by alleviating suction forces according to certain embodiments. FIGS. 5A and 5B depict experimental load cell force data measured for three consecutive layers, each of 3-s duration, while printing a conical geometry with varying cross-sectional areas by CLIP and iCLIP. FIG. 5C-5F depict quantified maximum print volumetric throughputs for two test geometries with varying cross-sectional areas, cone (FIGS. 5C and 5D) and cylinder (FIGS. 5E and 5F), by CLIP (left) and iCLIP (right). Gray dotted lines indicate delamination-free prints. Error bars denote ±1 SD from three independent print trials.

FIGS. 6A-6E depict the negligible impact of post-cured viaduct on iCLIP printed part mechanical properties. FIG. 6A depicts CAD design of test geometry for evaluating effect of viaduct on dogbone mechanical properties. FIG. 6B depicts a picture of an iCLIP printed dogbone, with inset showing optical microscopy image of central viaduct. FIG. 6C depicts a comparison of iCLIP printed dogbone with ASTM Type V specifications. FIGS. 6D-6E depicts ultimate tensile strength and Young's modulus, respectively, of iCLIP printed dogbones under different viaduct post-treatment conditions. All measurements represent the average of three independently printed dogbones, with error bars denoting +/−one standard deviation from the mean.

FIGS. 7A-7E illustrate an embodiment where iCLIP depends upon an oxygen-inhibited deadzone as a destination for injected resin during printing. FIG. 7A depicts a schematic illustration of the oxygen-permeable window set-up for the prototype iCLIP printer, indicating primary and secondary oxygen inlets that feed the highly oxygen-permeable window. FIG. 7B depicts deadzone thicknesses measured with or without active supply of pressurized pure oxygen. FIG. 7C depicts experimentally-measured deadzone thicknesses for the iCLIP window at varying UV exposures. FIG. 7D depicts experimental method for measuring deadzone thicknesses across the area of a part during CLIP (left, grey) and iCLIP (right, red). FIG. 7E depicts experimentally-measured deadzone thicknesses before printing (left, black), after printing by CLIP (middle, grey), and after printing by iCLIP (right, red).

FIGS. 8A-8G depict geometries used to quantify maximum printable speeds of CLIP and iCLIP. FIG. 8A depicts a first test geometry (cone) and associated print parameters to evaluate the relationship between printable speed and area in traditional CLIP (top) and iCLIP (bottom). FIGS. 8B-8C depict print failure mode experiments to determine maximum print speed achievable, for the geometry in (a), by CLIP (black) and iCLIP with a central viaduct (red). FIG. 8D Images of print defects observed due to Stefan adhesion forces while printing a cone geometry by traditional CLIP (left) not observed under the same printing conditions except with injection in iCLIP (right). FIG. 8E depicts a second test geometry (cylinder) and associated print parameters to evaluate the relationship between printable speed and area in traditional CLIP (top) and iCLIP (bottom). FIGS. 8F-8G depicts print failure mode experiments to determine maximum print area achievable, for the geometry in (d), by CLIP (black) and iCLIP with a central viaduct (red).

FIGS. 9A-9E depict the negligible impact of post-cured viaduct on iCLIP printed part mechanical properties. FIG. 9A depicts CAD design of test geometry for evaluating effect of viaduct on dogbone mechanical properties. FIG. 9B depicts a picture of an iCLIP printed dogbone, with inset showing optical microscopy image of central viaduct. FIG. 9C depicts a comparison of iCLIP printed dogbone with ASTM Type V specifications. FIGS. 9D-9E depict ultimate tensile strength and Young's modulus, respectively, of iCLIP printed dogbones under different viaduct post-treatment conditions. All measurements represent the average of three independently printed dogbones, with error bars denoting +/−one standard deviation from the mean.

FIGS. 10A-10G viaduct design for iCLIP printing according to certain embodiments FIG. 10A depicts test geometry for measuring viaduct radii, with UV projected through the oxygen permeable window into the vat while resin is injected through the part. FIG. 10B depicts CAD geometry for evaluating viaduct radius, with a single channel internal to a solid cylinder. FIGS. 10C-10E depict cross section (c), surface (d), and optical microscope image (e) of printed part showing stochastic and unprogrammed microfluidic channels resulting from resin flow through a laterally cured-through viaduct upon UV overexposure. FIG. 10F depicts quantified impact of UV dosage on vertical cured thickness, with measured α and Ec parameters from Beer's law indicated, in a range typical for CLIP printing. FIG. 10G depicts quantified impact of same UV light dosage range as in (c) on lateral cure through into the viaduct for viaducts with radii of 500 μm (dark red), 1000 μm (red), and 1500 μm (pink). Dotted lines indicate CAD specified viaduct radii. Error bars represent +/−one standard deviation from three independent experimental trials. Scale bars represent 5 mm, unless indicated otherwise.

FIGS. 11A-11C depict rheological characterization of resins used to quantify printable viscosities in CLIP and iCLIP according to certain embodiments. FIG. 11A depicts components of the composite photocurable resin formulation, with a low viscosity diacrylate and high viscosity dimethacrylate. FIG. 11B depicts dependence of test resin viscosity on percentage bisphenol A glycerolate dimethacrylate. Light blue and dark blue indicate measured viscosities at 20° C. and 25° C., respectively. FIG. 11C depicts viscosities of a standard CLIP resin from Carbon, Inc. (UMA 90) and a commercially available SLA resin.

FIGS. 12A-12C depict printable viscosities by CLIP and iCLIP according to certain embodiments. FIG. 12A depicts Schematic illustrating mass transport limitations of traditional CLIP, with images of cavitation event viewed from underneath the vat during printing. FIG. 12B depicts images of cavitation events with resins of different viscosities after printing, with blue indicating hollowed out regions in an otherwise solid cone highlighted in grey. FIG. 12C depicts experimentally-quantified part radii at which cavitation failure occurs during CLIP and iCLIP with single or bifurcating viaducts, with comparison to theoretical minimum dead zone pressures during traditional CLIP for resins of varying viscosities printed over varying cross sectional areas. Lighter contours indicate higher (magnitude) negative pressures. Dotted green indicates target CAD area. Error bars denote +/−one standard deviation from three independent print trials.

FIGS. 13A-13D depict rapid printing with high-viscosity resins by iCLIP according to certain embodiments. FIG. 13A depicts strategies for printing a cone geometry by CLIP (gray), iCLIP with one viaduct (red), and iCLIP with one-to four bifurcating viaducts (orange), highlighting resin channels and simulated dead zone pressure gradients. FIG. 13B depicts images of iCLIP printed objects with viaducts facilitating resin flow highlighted. FIG. 13C depicts pressure gradients within the dead zone predicted by CFD simulation (left) and lubrication theory (right). FIG. 13D depicts bottom-up images of CLIP and iCLIP print outcomes with resins of varying viscosities; gray regions indicate cavitation events.

FIGS. 14A-14D depict printing with viscous composite resins by iCLIP according to certain embodiments. FIG. 14A depicts iCLIP strategy for printing a lattice design with viscous MWCNT-filled resin. FIG. 14B depicts dynamic viscosity and UV penetration depth of resins with varying fiber volume fractions of CNTs, which are important factors to calibrate during printing. FIG. 14C depicts load-displacement curves under uniaxial compression for lattices with varying fiber volume fractions of carbon nanotubes (CNTs). FIG. 14D depicts quantified elastic moduli and compressive strength of lattices with varying fiber volume fractions of CNTs under uniaxial compression. Scale bars denote 1 cm and error bars +/−one standard deviation from three experimental print trials.

FIGS. 15A-15E depict multimaterial iCLIP control strategy according to certain embodiments. FIG. 15A depicts test geometry for calibrating injection rates during iCLIP, with control parameters that can be tuned during an iCLIP print to adjust the fraction of the vat to injected resin in a part. Below are images of the dead zone during prints with varying injection rates, with corresponding CFD simulation predictions. FIG. 15B depicts correlation between administered injection rate and the fraction of the part formed by injected resin, for three different injection profiles. FIGS. 15C-15E depicts parameter sweep experiments adjusting one of three control parameters during iCLIP to calibrate material fractions of vat to injected resin in a part. Scale bars, 1 cm. DZ, dead zone.

FIGS. 16A-16C depict calibration studies for multimaterial iCLIP according to certain embodiments. FIG. 16A depicts test geometry for calibrating injection rates during iCLIP, with control parameters that can be tuned during an iCLIP print to adjust the fraction of vat-to-injected resin in a part. An example print result whereby injection rate is increased stepwise over the course of the print is shown to right. FIG. 16B depicts correlation between the fraction of dead zone filled by injected resin and fraction of print formed from injected resin. FIG. 16C depicts print parameter calibration experiments whereby one of three iCLIP print parameters is varied individually and the subsequent ratio of injected-to-vat resin in the final part measured. Error bars indicate +/−one standard deviation from three experimental print trials.

FIGS. 17A-17D depict design of internal and external duct geometries for multi-material iCLIP according to certain embodiments. FIG. 17A depicts an illustrative example of a multimaterial iCLIP print script with a viaduct fully internal to the part, to print a model of St. Basil's Cathedral, with post-printing result shown to right. FIG. 17B depicts an illustrative example of a multimaterial iCLIP print script with a viaduct fully external to the part, to print a model of the Arc de Triomphe, with post-printing result shown to right. FIG. 17C depicts an illustrative example of a multimaterial iCLIP print script with a viaduct both internal and external to the part, to print a model of the Westminster Abbey, with post-printing result shown to right. FIG. 17D depicts an initially external viaduct merging with the part (c), reflected as a migrating circular region of no UV projections during printing. FIG. 17E depicts that the duct is visible as a conduit for white resin during and after printing.

FIGS. 18A-18J depict print scripts for multimaterial iCLIP according to certain embodiments. FIGS. 18A-18E depict five illustrative multimaterial iCLIP design objectives modeled as historically important buildings on which the flag of the country of origin is imprinted in order of increasing complexity. FIGS. 18F-18J depicts iCLIP print strategies highlighting evolving duct geometries over the course of the print. Ducts are engineered internal and/or external to the part to achieve the desired gradients.

FIGS. 19A-19G depict experimental validation of multimaterial iCLIP print strategies according to certain embodiments. FIG. 19A depicts vat resin distribution goals for multimaterial iCLIP printing flow control strategies. FIGS. 19B-19C depict for the St. Basil's Cathedral and Arc de Triomphe prints, respectively, CFD simulations of flow boundaries induced by injection (left) and images of the resin vat from beneath the window (right), with corresponding digitally extracted flow boundaries at varying time points following the onset of injection (bottom). FIGS. 19D-19F depict multimaterial gradients in Westminster Abbey, Independence Hall, and St. Sophia's Cathedral prints. FIG. 19G depicts all tested models following iCLIP printing. Scale bars, 1 cm.

FIGS. 20A-20F depict multiobjective microfluidics-aided digital design for iCLIP according to certain embodiments. FIGS. 20A-20C depict that in order to maximize speed, iCLIP parameters are chosen for an input CAD model to minimize mass transport limitations by (FIG. B) optimizing the number and path of viaducts for changing part cross-sectional area, producing the dynamically changing viaduct path in (FIG. C). FIG. 20D depicts that in order to tune part (multi-) material properties, models are infiltrated with viaducts to transport either stiff or elastic resins to the dead zone. FIG. 20E depicts FEA simulations. FIG. 20F depicts mechanical testing in uniaxial compression (rigid lattices in gray, rigid elastomer composite lattices in equal ratios in light green, and elastomer lattices in dark green). Scale bars, 5 mm. Error bars denote +1 SD from the mean. Simulation deformations are exaggerated for visualization.

FIG. 21 depicts dual simulated annealing algorithm for optimizing mass transport during iCLIP according to certain embodiments. Every digital z axis slice in an input CAD model is computationally analyzed with software that automatically incorporates viaducts to optimally distribute resin to alleviate suction forces and/or cavitation for high viscosity resins. The objective function to minimize by the dual simulated annealing algorithm implemented is the maximum resin reflow distance for a part cross sectional area. For a test geometry that both rotates and changes in area, a B spline smoothened arrangement of multiple, single, or no viaducts is produced.

FIGS. 22A-22C depict viscous fingering during injection into a dead zone during multi-material iCLIP printing according to certain embodiments. FIG. 22A depicts schematic of iCLIP printing of a geometry with cylindrical cross sectional area. FIG. 22B depicts Hele-Shaw cell model system for describing injection of a liquid into a thin gap with lifting upper surface. FIG. 22C depicts during 2.5 hours of iCLIP printing of a cylindrical cross sectional geometry, instabilities in the flow boundary between a lower viscosity resin (red) injected through a central viaduct into the dead zone, and a higher viscosity resin (pink) present in the vat from the start of iCLIP printing, as viewed from beneath the optically transparent window by a digital imaging camera.

FIG. 23 depicts fabrication-informed co-design for 3D printing manufacturability according to certain embodiments. Existing DfAM approaches do not account for the fluid dynamics of the printing process itself, instead imposing cumbersome support structures that fail to prevent print failures. The generative co-design method described herein in certain embodiments integrates design with fluid dynamics modeling to minimize forces during printing and thus maximize printability.

FIGS. 24A-24C depict experimental validation of a microfluidic network for a designer's CAD model according to certain embodiments. FIG. 24A depicts that the CAD model is confirmed to allow flow of multiple resins by digital imaging of the printer vat. FIG. 24B depicts forces during printing are significantly lessened with injection than without injection as shown in FIG. 24C.

FIGS. 25A-25C depict a designer's input CAD analyzed for printability according to certain embodiments. FIGS. 25A-25B depicts slice-by-slice, simulating fluid pressure profiles to flag failure-prone slices, here regions of dark grey indicating highly negative pressure. FIG. 25C depicts a range of real-world machine fabrication parameters, e.g., printing speed for a range of arbitrary mechanical designs from a CAD library.

FIG. 26 depicts analysis of the input CAD geometry slice-by-slice to predict detrimental suction forces during printing, forces are nullified by incrementally adding injection nodes to administer fluid.

FIG. 27A depicts node positions in the initial generatively-designed network. FIG. 27B depicts that the node positions are metaheuristically optimized to minimize the fluid reflow distance objective function until convergence. FIG. 27C depicts yielding a revised B-spline network better minimizing forces during printing.

FIGS. 28A-28E depict flow rate optimization according to certain embodiments. FIG. 28A depicts inputting CAD geometry. FIG. 28B depicts a designer's input CAD geometry with desired fabrication parameters and generatively-designed microfluidic network. FIG. 28C depicts an optimal pump profile is computed using the circuit analogy for pressure driven microfluidics FIGS. 28D-28E depicts supplying resin to all regions of the printed object.

FIG. 29 depicts user interface for Rhinoceros 3D, and specifically its Grasshopper parametric design interface, enables the designer to switch between the input 3D model for printing and the generatively-designed fluidic network to fabricate in parallel, if needed tuning channel orientations and other hyperparameters.

FIG. 30 depicts suction stresses vary nonlinearly while 3D printing layers of even the same cumulative cross sectional area (a and b above). High cross sections (e.g. a) require, depending on previous layers, extensive support structures to prevent print failure.

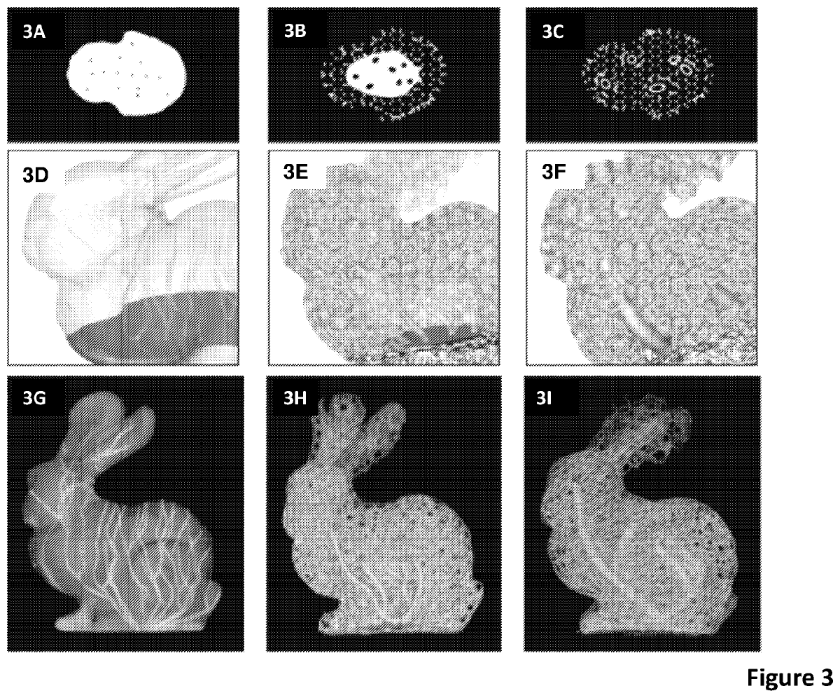

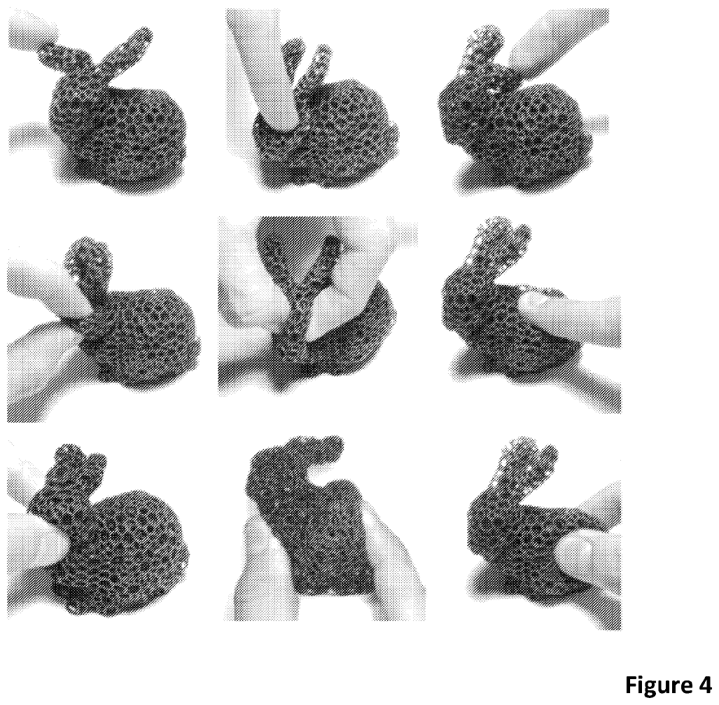

FIG. 3I depicts to left, dark gray regions in traditional 3D printing risk suction related failure, which via fluid injection at optimal locations in the part (middle) are offset with high-fluid pressure regions in injection 3D printing (right).

FIG. 32 depicts inverse designed fluidic networks showing hard design constraints according to certain embodiments.

FIG. 33 depicts illustration of layerwise (left) fabrication-aware design of 3D printable fluidic network N for a part P. To right, UV binary images projected during injection resin printing. Channel outlets are highlighted in red.

FIG. 34 depicts that when a given layer l while printing a 3D object P is considered independently, physical parameters such as print speed U and material viscosity η are positive correlated with failure-inducing suction forces Fₛ. Injection 3D printing incrementally adding high pressure injection sources n, each with a flow rate qₒᵤₜ, can offset such suction.

FIG. 35 depicts generative design of 3D fluidic network according to certain embodiments. The method analyzes 2D layers l comprising the 3D part P, iteratively modeling dead zone fluid pressure profiles p(x), growing the current fluidic network N by adding an injection node n, and incrementing the input injection rate qᵢₙ until negative suction force Fₛ is offset in a given layer l. Above, the current state of the 3D model P, Pt is shown to left, and to right extended branches b are highlighted in dark red with corresponding fluid pressure profiles p(x).

FIG. 36 depicts that in order to predict flow through the generatively designed networks, the circuit analogy for pressure driven fluidics is integrated into Paraflow. Above, a given row displays the current circuit representations for a fluidic network innervating the object fabricated to a certain layer, from layers 50 to 300. From left to right are displayed varying input injection rates, ranging from low (5 μL/s) to high (25 μL/s). The results inform the designer as to what injection rate to administer for e.g. multimaterial printing.

FIG. 37 depicts that combined with fluid modeling within the vat itself, the circuit analogy can predict the distribution of different fluids within the vat at incremental stages during printing, offering a route for physics-guided multimaterial 3D printing. Above are shown, for varying layers l during printing, the fluid pressure distributions within the vat at varying injection rates.

FIG. 38 depicts optimization objective for pressure control during vat 3D printing according to certain embodiments. The method minimizes the distance d from any pixel representing a point in the printed object to an input fluid source.

FIG. 39 depicts 3D printing conditions that necessitate more support according to certain embodiments, including faster printing and printing with more viscous materials, require denser fluidic networks G with more branches b. This is reflected in fabrication aware inverse design pipeline as increasing fluidic network fractions of total part volume, μ/P.

FIG. 40 depicts a range of viable fluidic networks innervating an input model according to certain embodiments. In red are feasible designs, and in black optimal designs that minimize suction. Increasingly dense fluidic networks are required for increasingly viscous materials.

FIG. 41 depicts experimental validation of inverse designed fluidic network functionality. For a simple fluidic network illustrated in top left, flow of injected material from the pump into the printer vat is visualized in bottom left. The ratio of red injected resin to gray vat resin is readily controllable with the pump injection rate. Corresponding load cell force measurements for a range of print conditions (right) show differing force profiles without injection, as a control demonstrating suction forces, and with injection, where this force is reversed.

### DETAILED DESCRIPTION

Aspects of the present disclosure include methods for making a polymeric structure having one or more microchannels. Methods according to certain embodiments include conveying a polymerizable composition through a conduit into a space between a build elevator and a build surface of a liquid interface production module, irradiating the polymerizable composition positioned between the build elevator and the build surface to generate a polymerizable composition having a first polymerized region of the polymerizable composition having a microchannel in contact with the build elevator and a first non-polymerized region of the polymerizable composition in contact with the build surface, displacing the build elevator away from the build surface, irradiating the first non-polymerized region of the polymerizable composition to generate a second polymerized region of the polymerizable composition in contact with the first polymerized region and a second non-polymerized region in contact with the build surface and repeating one or more steps in a manner sufficient to generate a polymeric structure having one or more microchannels positioned within the polymeric structure. Systems having a conduit for conveying a polymerizable composition to a liquid interface polymerization module having a build elevator and a build surface configured are also described. Polymer structures having a predetermined fluidic microchannel network prepared by the subject methods and non-transitory computer readable storage medium for practicing the subject methods are also provided.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

As summarized above, the present disclosure provides methods for making a polymeric structure having one or more microchannels positioned within the polymeric structure. In further describing embodiments of the disclosure, methods including conveying a polymerizable composition through a conduit into a space between a build elevator and a build surface of a liquid interface production module to generate a polymeric structure having one or more microchannels positioned within the polymeric structure are first described in greater detail. Next, systems having a light source, a conduit for conveying polymerizable composition to the liquid interface polymerization module and a liquid interface polymerization module having a build elevator and build surface configured for generating the polymeric structures are provided. Non-transitory computer readable storage medium for practicing the subject methods and polymeric structures having one or more microchannels positioned therein are described.

### Methods for Making a Polymeric Structure Having Microchannels

Aspects of the disclosure include methods for making a polymeric structure having a microstructure with one or more microchannels. Methods according to certain embodiments is a high resolution continuous additive processing method that includes conveying a polymerizable composition through a conduit into a space between a build elevator and a build surface of a liquid interface production module, irradiating the polymerizable composition positioned between the build elevator and the build surface to generate a polymerizable composition having a first polymerized region of the polymerizable composition having a microchannel in contact with the build elevator and a first non-polymerized region of the polymerizable composition in contact with the build surface, displacing the build elevator away from the build surface, irradiating the first non-polymerized region of the polymerizable composition to generate a second polymerized region of the polymerizable composition in contact with the first polymerized region and a second non-polymerized region in contact with the build surface and repeating one or more steps in a manner sufficient to generate a polymeric structure having one or more microchannels positioned within the polymeric structure. These steps are repeated in a manner sufficient to generate a polymeric structure having a microstructure that includes one or more microchannels. For example, the steps may be repeated 2 or more times, such as 3 or more times, such as 4 or more times, such as 5 or more times, such as 10 or more times, such as 20 or more times, such as 30 or more times, such as 40 or more times, such as 50 or more times, such as 100 or more times, such as 250 or more times, such as 500 or more times and including 1000 or more times.

In embodiments, the polymerizable composition is provided to the space between the build elevator and build surface of the liquid interface production module through a conduit in fluid communication with a source of a polymerizable material. In some instances, the polymerizable composition may be provided directly to the build plate from a liquid conduit and reservoir system. In some embodiments, the carrier includes one or more feed channels therein. The carrier feed channels are in fluid communication with the polymerizable composition source, for example a reservoir and associated pump. Different carrier feed channels may be in fluid communication with the same supply and operate simultaneously with one another, or different carrier feed channels may be separately controllable from one another (for example, through the provision of a pump and/or valve for each). Separately controllable feed channels may be in fluid communication with a source (e.g., reservoir) containing the same polymerizable composition, or may be in fluid communication with a reservoir containing different polymerizable compositions. Through the use of valve assemblies, different polymerizable compositions may in some embodiments be alternately fed through the same feed channel, if desired. In some embodiments, methods include injecting the polymerizable composition through the conduit with a syringe pump.

In some embodiments, the polymerizable composition is conveyed to the space between the build elevator and the build surface through two or more conduits, such as 3 or more, such as 4 or more, such as 5 or more, such as 6 or more, such as 7 or more, such as 8 or more, such as 9 or more and including through 10 or more different conduits. In some instances, the conduit is positioned internal to the generated polymeric structure. In other instances, the conduit is positioned external to the generated polymeric structure. In certain instances, one or more of the conduits passes through the build elevator, such as 2 or more of the conduits, such as 3 or more of the conduits and including where polymerizable composition is conveyed through 5 or more of the conduits that pass through the build elevator.

In some embodiments, methods include conveying two or more different polymerizable materials into the space between the build elevator and the build surface. In some instances, a first polymerizable material is conveyed through a first conduit into the space between the build elevator and the build surface and a second polymerizable material is conveyed through a second conduit into the space between the build elevator and the build surface. In certain embodiments, a plurality of different polymerizable materials is conveyed through a plurality of different conduits into the space between the build elevator and the build surface. For example, the number of different polymerizable materials conveyed may be 2 or more, such as 3 or more, such as 4 or more, such as 5 or more, such as 6 or more, such as 7 or more, such as 8 or more, such as 9 or more and including 10 or more. In some instances, the plurality of polymerizable materials is conveyed through 2 or more different conduits, such as 3 or more, such as 4 or more, such as 5 or more, such as 6 or more, such as 7 or more, such as 8 or more, such as 9 or more and including 10 or more different conduits.

The two or more different polymerizable materials may be conveyed into the space between the build elevator and the build surface simultaneously or in a predetermined sequential order. In some instances, two or more different polymerizable materials are conveyed into the space between the build elevator and the build surface, such as to form a blend or mixture of the two or more different polymerizable materials (i.e., a mixed resin). In other instances, two or more different polymerizable materials are conveyed sequentially into the space between the build elevator and the build surface, such as to form layers of different polymerizable materials.

The polymerizable composition may be conveyed through each conduit at a rate that varies, such as from 0.01 μL/s to 200 μL/s, such as from 0.05 μL/s to 150 μL/s, such as from 0.1 μL/s to 100 μL/s, such as from 0.5 μL/s to 90 μL/s, such as from 1 μL/s to 80 μL/s, such as from 2 μL/s to 70 μL/s, such as from 3 μL/s to 60 μL/s, such as from 4 μL/s to 50 μL/s, such as from 5 μL/s to 40 μL/s, such as from 6 μL/s to 30 μL/s and including from 7 μL/s to 27 μL/s. In some instances, the rate for conveying the polymerizable composition is controlled by a syringe pump. In some instances, the rate may be controlled by a rate-limiting valve positioned at a proximal or distal end of the conduit. In certain embodiments, the polymerizable composition is conveyed into the space between the build elevator and the build surface at a rate sufficient to generate the polymeric structure at a rate of 0.01 mm/hr or more, such as 0.05 mm/hr or more, such as 0.1 mm/hr or more, such as 0.5 mm/hr or more, such as 1 mm/hr or more, such as 2 mm/hr or more, such as 3 mm/hr or more, such as 4 mm/hr or more, such as 5 mm/hr or more, such as 6 mm/hr or more, such as 7 mm/hr or more, such as 8 mm/hr or more, such as 9 mm/hr or more, such as 10 mm/hr or more, such as 15 mm/hr or more, such as 20 mm/hr or more, such as 25 mm/hr or more, such as 50 mm/hr or more, such as 75 mm/hr or more, such as 100 mm/hr or more, such as 150 mm/hr or more and including conveying the polymerizable composition through one or more conduits into the space between the build elevator and the build surface at a rate sufficient to generate the polymeric structure at a rate of 250 mm/hr or more. For example, the polymerizable material may be conveyed through one or more conduits at a rate sufficient to generate the polymeric structure at a rate of 1 mm/hr to 250 mm/hr, such as from 2 mm/hr to 225 mm/hr, such as from 3 mm/hr to 200 mm/hr, such as from 4 mm/hr to 175 mm/hr, such as from 5 mm/hr to 150 mm/hr and including from 10 mm/hr to 125 mm/hr.

As described in greater detail below, the polymerizable composition may include one or more different polymerizable materials, such as a polymerizable material selected from polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof. In certain instances, one or more of the polymerizable materials includes carbon nanotubes, such as single-walled carbon nanotubes (SWCNTs) or multi-walled carbon nanotubes (MWCNTs). In some instances, the polymerizable composition conveyed through the conduit has a viscosity of from 100 cP to 7000 cP, such as from 150 cP to 6500 cP, such as from 200 cP to 6000 cP, such as from 250 cP to 5500 cP, such as from 300 cP to 5000 cP, such as from 350 cP to 4500 cP, such as from 400 cP to 4000 cP, such as from 450 cP to 3500 cP and including a viscosity of from 500 cP to 3000 cP.

In certain embodiments, methods include modeling a predetermined fluidic network geometry for the microchannels positioned within the polymeric structure. In some instances, the microchannels that will be formed within the polymeric structure are modeled in a manner sufficient to allow for higher additive manufacturing speeds, reducing or minimizing suction forces (as discussed in greater detail in the experimental section below) in addition to alleviating cavitation by the forming polymeric structure. In some instances, the fluidic network geometry of the microchannels is predetermined such that conveying the polymerizable composition through the conduits prevents dead zone thicknesses from shrinking towards the center of the part where fresh resin from the periphery struggles to reflow. In some instances, the fluidic network geometry for the microchannels positioned within the polymeric structure is determined for each different layer (e.g., each image slice) to be generated during the subject methods. The image slice and initial guess for viaduct placement coordinates may be fed into a dual simulated annealing optimization loop which outputs optimized viaduct placement coordinates. The optimal viaduct number and placement is determined by quantifying the distance from the part edge to the deepest pixel, for increments during the print. The output is, for each image slice in the geometry, a sequence of optimal resin source positions that can be interpolated smoothly with B splines in computer-aided design (CAD) software to reconstruct a revised CAD geometry with viaducts for resin flow.

In some instances, modeling the predetermined fluidic network geometry for the microchannels positioned within the polymeric structure includes determining the position of one or more injection nodes. In some instances, the injection nodes are determined to be at a position in the fluidic network where suction forces generated when displacing the build elevator away from the build surface are minimized. In some embodiments, modeling the predetermined fluidic network geometry includes determining the size of each microchannel to be generated within the polymeric structure. In some embodiments, modeling the predetermined fluidic network geometry includes determining the number of microchannels to be generated within the polymeric structure. In some instances, the predetermined fluidic network geometry of the microchannels is based on the three-dimensional shape of the generated polymeric structure. In some instances, modeling the predetermined fluidic network geometry includes determining the size and position of the microchannel after each displacement of the build elevator.

In some instances, the polymer structure includes a plurality of microchannels. In some instances, one or more of the microchannels includes one or more bifurcations, such as 2 or more bifurcations, such as 3 or more, such as 4 or more, such as 5 or more and including 10 or more different bifurcations. In some instances, the microchannels extend through the polymeric structure. In some instances, the microchannels are fluidically interconnected. In some instances, the polymeric structure has a single network of fluidically interconnected microchannel networks. In other instances, the polymeric structure has a plurality of fluidically interconnected microchannel networks.

In some embodiments, the polymerizable composition in the space between the build elevator and the build surface of the liquid interface production module is irradiated with a light beam generator component of a micro-digital light projection system. In some instances, the light source is a broadband light source that emits light having wavelengths from 400 nm to 1000 nm. In some instances, the broadband light source is a halogen lamp, deuterium arc lamp, xenon arc lamp, stabilized fiber-coupled broadband light source, a broadband LED with continuous spectrum, superluminescent emitting diode, semiconductor light emitting diode, wide spectrum LED white light source, a multi-LED integrated white light source, among other broadband light sources or any combination thereof. In some instances, the light source is a narrow band light source emitting a particular wavelength or a narrow range of wavelengths. In some instances, the narrow band light sources emit light having a narrow range of wavelengths, such as for example, 50 nm or less, such as 40 nm or less, such as 30 nm or less, such as 25 nm or less, such as 20 nm or less, such as 15 nm or less, such as 10 nm or less, such as 5 nm or less, such as 2 nm or less and including light sources which emit a specific wavelength of light. In some instances, the polymerizable composition is irradiated with a narrow band light source such as a narrow wavelength LED, laser diode or a broadband light source coupled to one or more optical bandpass filters, diffraction gratings, monochromators or any combination thereof.

In certain embodiments, the light source is a stroboscopic light source and the polymerizable composition is illuminated with periodic flashes of light, such as where the polymerizable composition is irradiated at a frequency of 0.01 kHz or greater, such as 0.05 kHz or greater, such as 0.1 kHz or greater, such as 0.5 kHz or greater, such as 1 kHz or greater, such as 2.5 kHz or greater, such as 5 kHz or greater, such as 10 KHz or greater, such as 25 kHz or greater, such as 50 kHz or greater and including 100 kHz or greater. In certain instances, the polymerizable composition is irradiated with a laser, such as pulsed laser or a continuous wave laser.

In some embodiments, the polymerizable composition is in contact with the build elevator and the build surface. In some instances, methods include irradiating the polymerizable composition for 1 second or longer to bond the first polymerized region of the polymerizable composition to the build elevator, such as from 5 seconds longer, such as for 10 seconds or longer, such as for 20 seconds or longer, such as for 30 seconds or longer, such as for 1 minute or longer, such as for 5 minutes or longer and including for 10 minutes or longer.

In some embodiments, the build elevator is displaced away from the build surface after the first polymerized region of the polymerizable composition is bonded to the build elevator. In some instances, the build elevator is displaced in increments of 0.001 μm or more, such as 0.005 μm or more, such as 0.01 μm or more, such as 0.05 μm or more, such as 0.1 μm or more, such as 0.5 μm or more, such as 1 μm or more, such as 2 μm or more, such as 3 μm or more, such as 4 μm or more, such as 5 μm or more and including in increments of 10 μm or more. In certain instances, the build elevator is displaced in increments of from 0.001 μm to 20 μm, such as from 0.005 μm to 19 μm, such as from 0.01 μm to 18 μm, such as from 0.05 μm to 17 μm, such as from 0.1 μm to 16 μm, such as from 0.2 μm to 17 μm, such as from 0.3 μm to 16 μm, such as from 0.4 μm to 15 μm, such as from 0.5 μm to 14 μm, such as from 0.6 μm to 13 μm, such as from 0.7 μm to 12 μm, such as from 0.8 μm to 11 μm and including from 0.9 μm to 10 μm.

In certain instances, polymerizable composition is added to the build surface after each displacement of the build elevator away from the build surface. In some instances, the polymerizable composition is continuously added to the build surface. In other instances, the polymerizable composition is added to the build surface in discreet intervals each having a predetermined amount. In some embodiments, the polymerizable composition is selected from polycaprolactone, polyalycolic acid, polylactic acid, polylactic-co-glycolic acid, polyethylene glycol, thiol-enes, anhydrides, polyacrylic acid, poly methylmethacrylate, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof. In certain embodiments, polymeric microneedles are formed from polyethylene glycol dimethacrylate (PEGDMA).

In embodiments, methods include irradiating the polymerizable composition. In some embodiments, the polymerizable composition is irradiated through the build surface. In some instances, the polymerizable composition is irradiated in the presence of a polymerization inhibitor. In certain embodiments, the polymerizable composition is continuously polymerized while displacing the build elevator away from the build surface. In certain cases, the polymerization inhibitor is oxygen and the build surface is permeable to oxygen. In certain instances, polymerizing the polymerizable composition in the presence of a polymerization inhibitor such as oxygen enables continuous (i.e., not layer-by-layer) generation the lattice microstructure with a liquid “dead zone” at the interface between the build surface and the building polymeric structure. In some instances, the dead zone is generated because oxygen acts as a polymerization inhibitor, passing through the oxygen-permeable build surface. Photopolymerization cannot occur in the oxygen containing “dead zone” region such that this region remains fluid, and the polymerized component in contact with the build surface so that the building microstructure does not physically attach to the build surface. Displacement of the build elevator therefore generates a continuous polymeric microstructure having a microchannel which exhibits sufficient mechanical integrity and surface isotropicity.

In certain embodiments, the polymerizable composition is polymerized using a liquid interface polymerization module that is part of a continuous liquid interface production (CLIP) system such as that described in International Patent Publication No. WO 2014/126837; U.S. Patent Publication Nos. 2018/0064920; 2017/0095972; 2021/0246252 and U.S. Patent Publication Nos. 10,155,882; 10,792,857, the disclosures of which are herein incorporated by reference.

In some embodiments, methods include irradiating the polymerizable composition with a micro-digital light projection system. In some instances, methods include determining a focal plane on the build surface using the micro-digital light projection system. In some embodiments, determining the focal plane on the build surface includes irradiating the build surface with a stroboscopic light source through the tube lens and displacing the build surface until the light is focused on the build surface through the tube lens. In certain embodiments, methods for determining the focal plane on the build surface includes irradiating build surface with the stroboscopic light source with periodic flashes of light. For example, the frequency of each light pulse may be 0.0001 kHz or greater, such as 0.0005 kHz or greater, such as 0.001 kHz or greater, such as 0.005 kHz or greater, such as 0.01 kHz or greater, such as 0.05 kHz or greater, such as 0.1 kHz or greater, such as 0.5 kHz or greater, such as 1 kHz or greater, such as 2.5 kHz or greater, such as 5 kHz or greater, such as 10 KHz or greater, such as 25 kHz or greater, such as 50 kHz or greater and including 100 kHz or greater. In certain instances, the frequency of pulsed irradiation by the light source ranges from 0.00001 KHz to 1000 kHz, such as from 0.00005 kHz to 900 kHz, such as from 0.0001 kHz to 800 kHz, such as from 0.0005 kHz to 700 kHz, such as from 0.001 kHz to 600 kHz, such as from 0.005 kHz to 500 kHz, such as from 0.01 kHz to 400 kHz, such as from 0.05 kHz to 300 kHz, such as from 0.1 kHz to 200 kHz and including from 1 kHz to 100 kHz. The duration of light irradiation for each light pulse (i.e., pulse width) may vary and may be 0.000001 ms or more, such as 0.000005 ms or more, such as 0.00001 ms or more, such as 0.00005 ms or more, such as 0.0001 ms or more, such as 0.0005 ms or more, such as 0.001 ms or more, such as 0.005 ms or more, such as 0.01 ms or more, such as 0.05 ms or more, such as 0.1 ms or more, such as 0.5 ms or more, such as 1 ms or more, such as 2 ms or more, such as 3 ms or more, such as 4 ms or more, such as 5 ms or more, such as 10 ms or more, such as 25 ms or more, such as 50 ms or more, such as 100 ms or more and including 500 ms or more. For example, the duration of light irradiation may range from 0.000001 ms to 1000 ms, such as from 0.000005 ms to 950 ms, such as from 0.00001 ms to 900 ms, such as from 0.00005 ms to 850 ms, such as from 0.0001 ms to 800 ms, such as from 0.0005 ms to 750 ms, such as from 0.001 ms to 700 ms, such as from 0.005 ms to 650 ms, such as from 0.01 ms to 600 ms, such as from 0.05 ms to 550 ms, such as from 0.1 ms to 500 ms, such as from 0.5 ms to 450 ms, such as from 1 ms to 400 ms, such as from 5 ms to 350 ms and including from 10 ms to 300 ms. In some instances, methods include irradiating the build surface with a plane of light having a projected image pattern with the stroboscopic light source.

In some instances, determining the focal plane on the build surface includes adjusting the focus of the tube lens. In some instances, the focal point of the tube lens is increased to adjust the focus onto the build surface. For example, the focal point may be increased by 1 μm or more, such as by 5 μm or more, such as by 10 μm or more, such as by 50 μm or more, such as by 100 μm or more, such as by 500 μm or more, such as by 1 mm or more, such as by 5 mm or more, such as by 10 mm or more, such as by 50 mm or more and including by 100 mm or more. In some instances, the focal point of the tube lens is decreased to adjust the focus onto the build surface. For example, the focal point may be decreased by 1 μm or more, such as by 5 μm or more, such as by 10 μm or more, such as by 50 μm or more, such as by 100 μm or more, such as by 500 μm or more, such as by 1 mm or more, such as by 5 mm or more, such as by 10 mm or more, such as by 50 mm or more and including by 100 mm or more.

In some embodiments, methods include displacing the build surface until the projected image pattern is in focus with the build surface. The build surface and build elevator may be displaced using any convenient displacement protocol, such as manually (i.e., movement of the build surface or build elevator directly by hand), with assistance by a mechanical device or by a motor actuated displacement device. For example, in some embodiments the build surface or build elevator is moved with a mechanically actuated translation stage, mechanical leadscrew assembly, mechanical slide device, mechanical lateral motion device, mechanically operated geared translation device. In other embodiments, the build surface or build elevator is moved with a motor actuated translation stage, leadscrew translation assembly, geared translation device, such as those employing a stepper motor, servo motor, brushless electric motor, brushed DC motor, micro-step drive motor, high resolution stepper motor, among other types of motors. In some instances, the build surface is displaced by 1 μm or more, such as by 5 μm or more, such as by 10 μm or more, such as by 50 μm or more, such as by 100 μm or more and including by 500 μm or more. In certain embodiments, the build surface is displaced by 400 μm or less, such as 350 μm or less, such as by 300 μm or less, such as by 250 μm or less, such as by 200 μm or less, such as by 150 μm or less, such as by 100 μm or less and including by 50 μm or less.

In some instances, methods include generating an image stack having a plurality of the projected image patterns. The image stack may include 2 or more projected image patterns, such as 3 or more, such as 4 or more, such as 5 or more, such as 10 or more and including 25 or more projected image patterns. In certain instances, methods include determining the focal plane of the build surface based on the generated image stack. In embodiments, methods as described here for generating polymeric structures having a microstructure that includes a microchannel provide for a resolution of 10 μm or less, such as 5 μm or less. In certain embodiments, the subject methods provide for a resolution of from 1.0 μm to 4 μm, such as from 1.5 μm to 3.8 μm.

In some embodiments, methods include filling at least a portion of the void volume of one or more microchannels of the generated polymeric structure. In some embodiments, methods include filling 5% or more, such as 10% or more, such as 15% or more, such as 20% or more, such as 25% or more, such as 50% or more, such as 75% or more and including 90% or more of the void volume of the microchannel of the generated polymeric structure. In some instances, the void volume of the microchannels is filled with a non-polymerizable material. In some instances, the microchannels are filled with a composition that is non-reactive with the polymeric structure, such as a non-polymerizable composition selected from a Newtonian liquid, a shear thinning liquid, a shear thickening liquid, a magnetorheological liquid, an electric field responsive liquid and a gas. In some instances, the microchannels of the polymeric structure are filled with a polymerizable material. In certain instances, the void volume of the microchannels is filled with the same polymerizable material used to prepare the polymeric structure, such as a polymerizable material selected from polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof. In certain instances, the polymerizable material used to fill the microchannels includes carbon nanotubes, such as single-walled carbon nanotubes (SWCNTs) or multi-walled carbon nanotubes (MWCNTs).

### Systems for Making a Polymeric Structure Having Microchannels

Aspects of the present disclosure also include systems for making a polymeric structure having a microstructure with one or more microchannels. Systems according to certain embodiments include a light source, a liquid interface polymerization module having a build elevator and a build surface configured for generating the polymeric structure having one or more microchannels from a polymerizable composition positioned therebetween and a conduit for conveying polymerizable composition to the liquid interface polymerization module.

In embodiments, systems include a conduit for conveying a polymerizable composition to the space between the build elevator and build surface of the liquid interface production module. In some instances, the conduit is in fluid communication with a source of a polymerizable material. In some instances, the conduit provides for directly adding the polymerizable composition to the build plate from a reservoir system. In some embodiments, the carrier includes or more feed channels therein. The carrier feed channels are in fluid communication with the polymerizable composition source, for example a reservoir and associated pump. Different carrier feed channels may be in fluid communication with the same supply and operate simultaneously with one another, or different carrier feed channels may be separately controllable from one another (for example, through the provision of a pump and/or valve for each). Separately controllable feed channels may be in fluid communication with a source (e.g., reservoir) containing the same polymerizable composition, or may be in fluid communication with a reservoir containing different polymerizable compositions. Through the use of valve assemblies, different polymerizable compositions may in some embodiments be alternately fed through the same feed channel, if desired. In some embodiments, systems include a syringe pump for injecting the polymerizable composition through the conduit.

In some embodiments, the system includes two or more conduits for conveying polymerizable composition to the space between the build elevator and the build surface, such as 3 or more, such as 4 or more, such as 5 or more, such as 6 or more, such as 7 or more, such as 8 or more, such as 9 or more and including through 10 or more different conduits. In some instances, the conduit is positioned internal to the generated polymeric structure. In other instances, the conduit is positioned external to the generated polymeric structure. In certain instances, one or more of the conduits passes through the build elevator, such as 2 or more of the conduits, such as 3 or more of the conduits and including where polymerizable composition is conveyed through 5 or more of the conduits that pass through the build elevator.

In some embodiments, systems are configured to convey two or more different polymerizable materials into the space between the build elevator and the build surface. In some instances, the system is configured to convey a first polymerizable material through a first conduit into the space between the build elevator and the build surface and to convey a second polymerizable material through a second conduit into the space between the build elevator and the build surface. In certain embodiments, the system is configured to convey a plurality of different polymerizable materials through a plurality of different conduits into the space between the build elevator and the build surface. For example, the number of different polymerizable materials conveyed may be 2 or more, such as 3 or more, such as 4 or more, such as 5 or more, such as 6 or more, such as 7 or more, such as 8 or more, such as 9 or more and including 10 or more. In some instances, the system is configured to convey a plurality of polymerizable materials through 2 or more different conduits, such as 3 or more, such as 4 or more, such as 5 or more, such as 6 or more, such as 7 or more, such as 8 or more, such as 9 or more and including 10 or more different conduits.

In some embodiments, the system is configured to convey the two or more different polymerizable materials into the space between the build elevator and the build surface simultaneously or in a predetermined sequential order. In some instances, systems are configured to convey two or more different polymerizable materials into the space between the build elevator and the build surface, such as to form a blend or mixture of the two or more different polymerizable materials (i.e., a mixed resin). In other instances, systems are configured to convey two or more different polymerizable materials sequentially into the space between the build elevator and the build surface, such as to form layers of different polymerizable materials.

In some instances, system are configured to convey the polymerizable composition through each conduit at a rate that varies, such as from 0.01 L/s to 200 μL/s, such as from 0.05 μL/s to 150 μL/s, such as from 0.1 μL/s to 100 μL/s, such as from 0.5 μL/s to 90 μL/s, such as from 1 μL/s to 80 μL/s, such as from 2 μL/s to 70 μL/s, such as from 3 μL/s to 60 μL/s, such as from 4 L/s to 50 μL/s, such as from 5 μL/s to 40 μL/s, such as from 6 μL/s to 30 μL/s and including from 7 L/s to 27 μL/s. In some instances, the rate for conveying the polymerizable composition is controlled by the syringe pump. In some instances, the conduit includes a rate-limiting valve at a proximal or distal end to control the rate of conveying the polymerizable composition. In certain embodiments, systems are configured to convey the polymerizable composition into the space between the build elevator and the build surface at a rate sufficient to generate the polymeric structure at a rate of 0.01 mm/hr or more, such as 0.05 mm/hr or more, such as 0.1 mm/hr or more, such as 0.5 mm/hr or more, such as 1 mm/hr or more, such as 2 mm/hr or more, such as 3 mm/hr or more, such as 4 mm/hr or more, such as 5 mm/hr or more, such as 6 mm/hr or more, such as 7 mm/hr or more, such as 8 mm/hr or more, such as 9 mm/hr or more, such as 10 mm/hr or more, such as 15 mm/hr or more, such as 20 mm/hr or more, such as 25 mm/hr or more, such as 50 mm/hr or more, such as 75 mm/hr or more, such as 100 mm/hr or more, such as 150 mm/hr or more and including where the system is configured to convey the polymerizable composition through one or more conduits into the space between the build elevator and the build surface at a rate sufficient to generate the polymeric structure at a rate of 250 mm/hr or more. For example, the polymerizable material may be conveyed through one or more conduits at a rate sufficient to generate the polymeric structure at a rate of 1 mm/hr to 250 mm/hr, such as from 2 mm/hr to 225 mm/hr, such as from 3 mm/hr to 200 mm/hr, such as from 4 mm/hr to 175 mm/hr, such as from 5 mm/hr to 150 mm/hr and including from 10 mm/hr to 125 mm/hr.

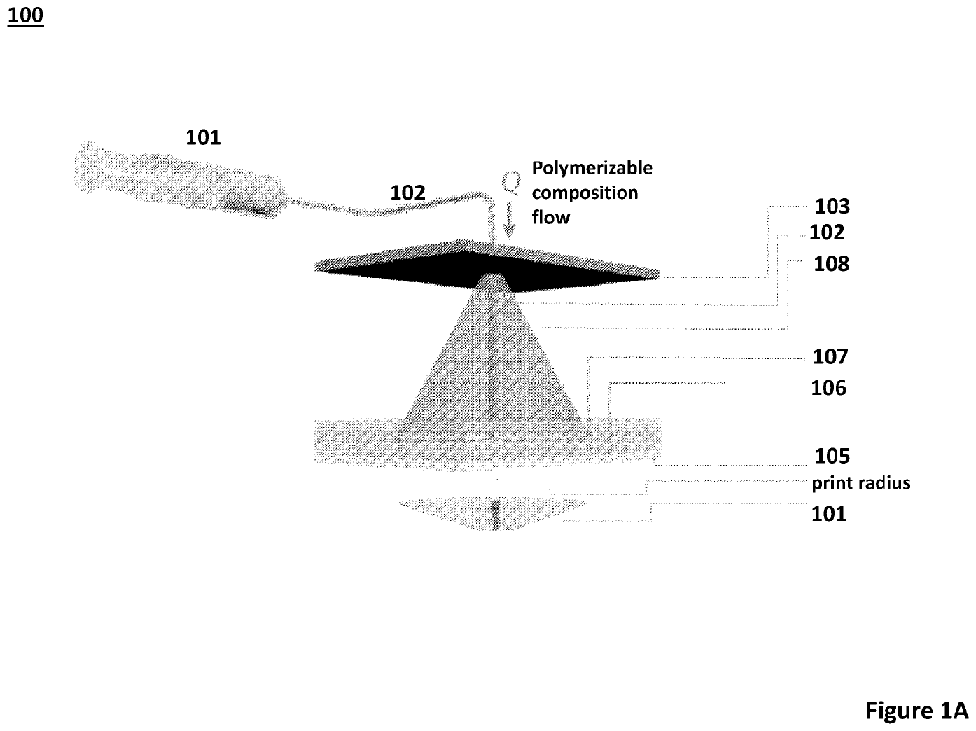

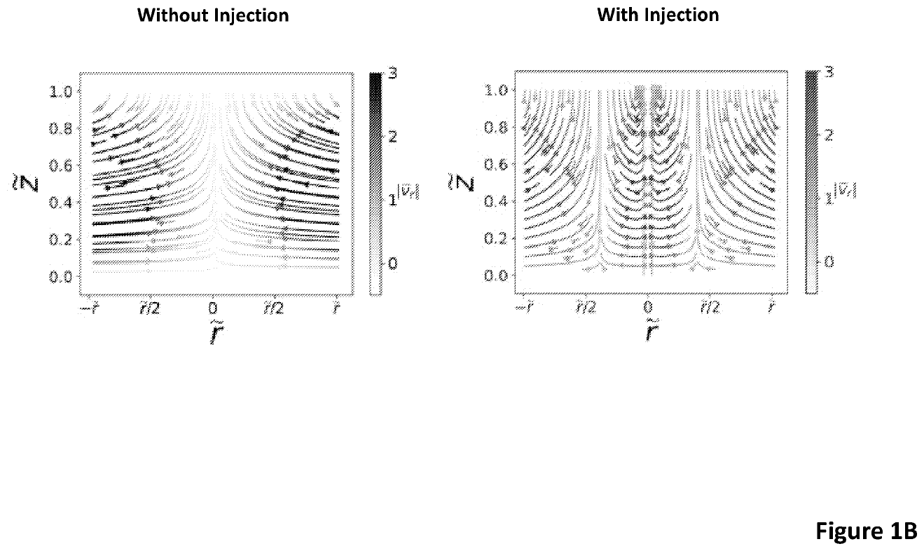

FIG. 1A depicts a system for making a polymeric structure according to certain embodiments. System 100 includes a source 101 of a polymerizable composition in fluid communication with a liquid interface polymerization module through conduit 102. The polymerizable composition is contained in a syringe where the outflow rate of the polymerizable composition is controlled by a syringe pump in certain embodiments. Conduit 102 passes through build elevator 103 where the polymerizable material is irradiated with light source 104 on build surface 105. The build surface includes an oxygen-permeable window 106 which creates a deadzone 107 where polymerization of the polymerizable material is inhibited. The polymeric structure 108 is generated as build elevator 103 is displaced away from build surface 105.

FIG. 1B depicts analytically derived dead zone velocity fields and pressure gradients from the lubrication theory while printing a cylindrical geometry by CLIP, where z and r are the vertical and radial distances in the dead zone, respectively, and vᵣ is the radial velocity. Darker hues indicate higher-magnitude velocity vectors, and, conversely, lighter hues indicate stagnation zones of low-fluid velocity. FIG. 1B also depicts analytically derived dead zone velocity fields and pressure gradients from the lubrication theory while printing a cylindrical geometry by iCLIP, with continuous injection through a central viaduct.

In some embodiments, the system includes a processor having memory operably coupled to the processor wherein the memory includes instructions stored thereon, which when executed by the processor, cause the processor to: a) irradiate a polymerizable composition positioned between the build elevator and the build surface to generate a polymerizable composition having a first polymerized region of the polymerizable composition in contact with the build elevator and a first non-polymerized region of the polymerizable composition in contact with the build surface; b) displace the build elevator away from the build surface; c) irradiate the first non-polymerized region of the polymerizable composition to generate a second polymerized region of the polymerizable composition in contact with the first polymerized region and a second non-polymerized region in contact with the build surface; and d) repeat steps a)-c) in a manner sufficient to generate a polymeric structure having one or more microchannels positioned within the polymeric structure.

In some instances, the memory includes instructions for modeling a predetermined fluidic network geometry for the microchannels positioned within the polymeric structure. In some instances, the memory includes instructions for determining the position of one or more injection nodes. In some instances, the memory includes instructions for determining the position of one or more injection nodes where suction forces generated when displacing the build elevator away from the build surface are minimized. In some instances, the memory includes instructions for determining the size of each microchannel to be generated within the polymeric structure. In some instances, the memory includes instructions for determining the number of microchannels to be generated within the polymeric structure. In some instances, the predetermined fluidic network geometry of the microchannels is based on the three-dimensional shape of the generated polymeric structure. In some instances, the memory includes instructions for determining the size and position of the microchannel after each displacement of the build elevator.

In embodiments, systems include a light source. In some embodiments, the light source includes a light beam generator component. In some embodiments, the light source is a broadband light source, emitting light having a broad range of wavelengths, such as for example, spanning 50 nm or more, such as 100 nm or more, such as 150 nm or more, such as 200 nm or more, such as 250 nm or more, such as 300 nm or more, such as 350 nm or more, such as 400 nm or more and including spanning 500 nm or more. For example, one suitable broadband light source emits light having wavelengths from 200 nm to 1500 nm. Another example of a suitable broadband light source includes a light source that emits light having wavelengths from 400 nm to 1000 nm. Any convenient broadband light source protocol may be employed, such as a halogen lamp, deuterium arc lamp, xenon arc lamp, stabilized fiber-coupled broadband light source, a broadband LED with continuous spectrum, superluminescent emitting diode, semiconductor light emitting diode, wide spectrum LED white light source, a multi-LED integrated white light source, among other broadband light sources or any combination thereof.

In some embodiments, the light source is a narrow band light source emitting a particular wavelength or a narrow range of wavelengths. In some instances, the narrow band light sources emit light having a narrow range of wavelengths, such as for example, 50 nm or less, such as 40 nm or less, such as 30 nm or less, such as 25 nm or less, such as 20 nm or less, such as 15 nm or less, such as 10 nm or less, such as 5 nm or less, such as 2 nm or less and including light sources which emit a specific wavelength of light (i.e., monochromatic light). Any convenient narrow band light source protocol may be employed, such as a narrow wavelength LED, laser diode or a broadband light source coupled to one or more optical bandpass filters, diffraction gratings, monochromators or any combination thereof. The subject systems may include one or more light sources, as desired, such as two or more light sources, such as three or more light sources, such as four or more light sources, such as five or more light sources and including ten or more light sources. The light source may include a combination of types of light sources, for example, where two lights sources are employed, a first light source may be a broadband white light source (e.g., broadband white light LED) and second light source may be a broadband near-infrared light source (e.g., broadband near-IR LED). In other instances, where two light sources are employed, a first light source may be a broadband white light source (e.g., broadband white light LED) and the second light source may be a narrow spectra light source (e.g., a narrow band visible light or near-IR LED). In yet other instances, the light source is an plurality of narrow band light sources each emitting specific wavelengths, such as an array of two or more LEDs, such as an array of three or more LEDs, such as an array of five or more LEDs, including an array of ten or more LEDs.

In certain embodiments, the light source is a stroboscopic light source where the polymerizable composition is illuminated with periodic flashes of light. Depending on the light source (e.g., flash lamp, pulsed laser) the frequency of light strobe may vary, and may be 0.01 kHz or greater, such as 0.05 kHz or greater, such as 0.1 kHz or greater, such as 0.5 kHz or greater, such as 1 kHz or greater, such as 2.5 kHz or greater, such as 5 kHz or greater, such as 10 kHz or greater, such as 25 kHz or greater, such as 50 kHz or greater and including 100 kHz or greater. In these embodiments, the strobe light may be operably coupled to a processor having a frequency generator which regulates strobe frequency. In some instances, the frequency generator of the strobe light is operably coupled to the projection monitoring component of the micro-digital light projection system such that the frequency of the strobe light is synchronized with the frequency of image capture on the build surface of the light interface polymerization module. In certain instances, suitable strobe light sources and frequency controllers include, but are not limited to those described in U.S. Pat. Nos. 5,700,692 and 6,372,506, the disclosures of which are herein incorporated by reference.

In some embodiments, the light beam generator includes one or more lasers. Lasers of interest may include pulsed lasers or continuous wave lasers. The type and number of lasers used in the subject methods may vary and may be a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof. In other instances, the light beam generator includes a dye laser, such as a stilbene, coumarin or rhodamine laser. In yet other instances, the light beam generator includes a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof. In still other instances, the light beam generator includes a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulium YAG laser, ytterbium YAG laser, ytterbium₂O₃ laser or cerium doped lasers and combinations thereof. In still other instances, the light beam generator includes a semiconductor diode laser, optically pumped semiconductor laser (OPSL), or a frequency doubled- or frequency tripled implementation of any of the above-mentioned lasers.

In some embodiments, the light beam generator includes one or more tube lenses that are configured with adjustable focal lengths. In some instances, the tube lens is a telecentric lens. In certain instances, the tube lens is configured for widefield imaging. In some instances, the tube lens has an adjustable focal length which ranges from 10 mm to 1000 mm, such as from 20 mm to 900 mm, such as from 30 mm to 800 mm, such as from 40 mm to 700 mm, such as from 50 mm to 600 mm, such as from 60 mm to 500 mm, such as from 70 mm to 400 mm, such as from 80 mm to 300 mm and including an adjustable focal length of from 100 mm to 200 mm.

In some embodiments, the light beam generator includes one or more projection lenses, such as 2 or more projection lenses, such as 3 or more projection lenses, such as 4 or more projection lenses and including 5 or more projection lenses. In some instances, the projection lenses provide for magnification of 2-fold or more, such as 3-fold or more, such as 4-fold or more, such as 5-fold or more, such as 6-fold or more, such as 7-fold or more, such as 8-fold or more, such as 9-fold or more and including 10-fold or more magnification. In some instances, the projection lenses provide for de-magnification having a magnification ratio ranging from 0.1 to 0.95, such as a magnification ratio of from 0.2 to 0.9, such as a magnification ratio of from 0.3 to 0.85, such as a magnification ratio of from 0.35 to 0.8, such as a magnification ratio of from 0.5 to 0.75 and including a magnification ratio of from 0.55 to 0.7, for example a magnification ratio of 0.6.

In some embodiments, the light beam generator component includes one or more beamsplitters. The beamsplitter may be any an optical component that is configured to propagate a beam of light along two or more different and spatially separated optical paths, such that a predetermined portion of the light is propagated along each optical path. The beamsplitter may be any convenient beamsplitting protocol such as with triangular prism, slivered mirror prisms, dichroic mirror prisms, among other types of beamsplitters. The beamsplitter may be formed from any suitable material so long as the beamsplitter is capable of propagating the desired amount and wavelengths of light along each optical path. For example, beamsplitters of interest may be formed from glass (e.g., N-SF10, N-SF11, N-SF57, N-BK7, N-LAK21 or N-LAF35 glass), silica (e.g., fused silica), quartz, crystal (e.g., CaF₂ crystal), zinc selenide (ZnSe), F₂, germanium (Ge) titanate (e.g., S-TIH11), borosilicate (e.g., BK7). In certain embodiments, the beamsplitter is formed from a polymeric material, such as, but not limited to, polycarbonates, polyvinyl chloride (PVC), polyurethanes, polyethers, polyamides, polyimides, or copolymers of these thermoplastics, such as PETG (glycol-modified polyethylene terephthalate), among other polymeric plastic materials. In certain embodiments, the beamsplitter is formed from a polyester, where polyesters of interest may include, but are not limited to, poly(alkylene terephthalates) such as poly(ethylene terephthalate) (PET), bottle-grade PET (a copolymer made based on monoethylene glycol, terephthalic acid, and other comonomers such as isophthalic acid, cyclohexene dimethanol, etc.), poly(butylene terephthalate) (PBT), and poly(hexamethylene terephthalate); poly(alkylene adipates) such as poly(ethylene adipate), poly(1,4-butylene adipate), and poly(hexamethylene adipate); poly(alkylene suberates) such as poly(ethylene suberate); poly(alkylene sebacates) such as poly(ethylene sebacate); poly(ε-caprolactone) and poly(β-propiolactone); poly(alkylene isophthalates) such as poly(ethylene isophthalate); poly(alkylene 2,6-naphthalene-dicarboxylates) such as poly(ethylene 2,6-naphthalene-dicarboxylate); poly(alkylene sulfonyl-4,4′-dibenzoates) such as poly(ethylene sulfonyl-4,4′-dibenzoate); poly(p-phenylene alkylene dicarboxylates) such as poly(p-phenylene ethylene dicarboxylates); poly(trans-1,4-cyclohexanediyl alkylene dicarboxylates) such as poly(trans-1,4-cyclohexanediyl ethylene dicarboxylate); poly(1,4-cyclohexane-dimethylene alkylene dicarboxylates) such as poly(1,4-cyclohexane-dimethylene ethylene dicarboxylate); poly([2.2.2]-bicyclooctane-1,4-dimethylene alkylene dicarboxylates) such as poly([2.2.2]-bicyclooctane-1,4-dimethylene ethylene dicarboxylate); lactic acid polymers and copolymers such as (S)-polylactide, (R,S)-polylactide, poly(tetramethylglycolide), and poly(lactide-co-glycolide); and polycarbonates of bisphenol A, 3,3′-dimethylbisphenol A, 3,3′,5,5′-tetrachlorobisphenol A, 3,3′,5,5′-tetramethylbisphenol A; polyamides such as poly(p-phenylene terephthalamide); polyethylene Terephthalate (e.g., Mylar™ Polyethylene Terephthalate), combinations thereof, and the like.

In embodiments, the micro-digital light projection system includes a light projection monitoring component having a photodetector. Photodetectors may be any convenient light detecting protocol, including but not limited to photosensors or photodetectors, such as active-pixel sensors (APSs), avalanche photodiodes (APDs), quadrant photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes, phototransistors, quantum dot photoconductors or photodiodes and combinations thereof, among other photodetectors. In certain embodiments, the photodetector is a photomultiplier tube, such as a photomultiplier tube having an active detecting surface area of each region that ranges from 0.01 cm² to 10 cm², such as from 0.05 cm² to 9 cm², such as from, such as from 0.1 cm² to 8 cm², such as from 0.5 cm² to 7 cm² and including from 1 cm² to 5 cm².

In certain embodiments, the light projection monitoring component includes one or more photodetectors that are optically coupled to a slit. Depending on the size of the active detecting surface of the photodetector, slits according to certain instances have a rectangular (or other polygonal shape) opening having a width of from 0.01 mm to 2 mm, such as from 0.1 mm to 1.9 mm, such as from 0.2 mm to 1.8 mm, such as from 0.3 mm to 1.7 mm, such as from 0.4 mm to 1.6 mm, and including a width of from 0.5 mm to 1.5 mm and a length of from 0.01 mm to 2 mm, such as from 0.1 mm to 1.9 mm, such as from 0.2 mm to 1.8 mm, such as from 0.3 mm to 1.7 mm, such as from 0.4 mm to 1.6 mm, and including a length of from 0.5 mm to 1.5 mm. In certain instances, the width of the slit is 1 mm or less, such as 0.9 mm or less, such as 0.8 mm or less, such as 0.7 mm or less, such as 0.6 mm or less, such as 0.5 mm or less and including a width that is 0.4 mm or less. In certain instances, the light detection system includes a photodetector that is optically coupled to a slit having a plurality of openings, such as a slit having 2 or more openings, such as 3 or more openings, such as 4 or more openings, such as 5 or more openings, such as 6 or more openings, such as 7 or more openings, such as 8 or more openings, such as 9 or more openings and including a slit having 10 or more openings.

Light may be measured by the photodetector at one or more wavelengths, such as at 2 or more wavelengths, such as at 5 or more different wavelengths, such as at 10 or more different wavelengths, such as at 25 or more different wavelengths, such as at 50 or more different wavelengths, such as at 100 or more different wavelengths, such as at 200 or more different wavelengths, such as at 300 or more different wavelengths and including measuring light at 400 or more different wavelengths. Light may be measured continuously or in discrete intervals. In some instances, detectors of interest are configured to take measurements of the light continuously. In other instances, detectors of interest are configured to take measurements in discrete intervals, such as measuring light every 0.001 millisecond, every 0.01 millisecond, every 0.1 millisecond, every 1 millisecond, every 10 milliseconds, every 100 milliseconds and including every 1000 milliseconds, or some other interval.

In certain embodiments, the micro-digital light projection system is a digital light processing (DLP) system having a digital micromirror device such as that described in U.S. Patent Publication Nos. 2017/0095972; 2022/0250313; 2022/0048242 and U.S. Pat. Nos. 11,358,342; 11,141,910, the disclosures of which are herein incorporated by reference.

In some embodiments, systems also include a processor having memory operably coupled to the processor where the memory includes instructions stored thereon, which when executed by the processor, cause the processor to irradiate a polymerizable composition positioned between a build elevator and a build surface to generate a polymerizable composition having a first polymerized region of the polymerizable composition in contact with the build elevator and a first non-polymerized region of the polymerizable composition in contact with the build surface; displace the build elevator away from the build surface; irradiate the first non-polymerized region of the polymerizable composition to generate a second polymerized region of the polymerizable composition in contact with the first polymerized region and a second non-polymerized region in contact with the build surface. These steps are repeated in a manner sufficient to generate the polymeric structure having a microstructure that includes one or more microchannels. For example, the steps may be repeated 2 or more times, such as 3 or more times, such as 4 or more times, such as 5 or more times, such as 10 or more times, such as 20 or more times, such as 30 or more times, such as 40 or more times, such as 50 or more times, such as 100 or more times, such as 250 or more times, such as 500 or more times and including 1000 or more times.

In some embodiments, the memory includes instructions to irradiate the polymerizable composition for a duration sufficient to bond the first polymerized region of the polymerizable composition to the build elevator. In some instances, the memory includes instructions to irradiate the polymerizable composition for 1 second or longer to bond the first polymerized region of the polymerizable composition to the build elevator, such as from 5 seconds longer, such as for 10 seconds or longer, such as for 20 seconds or longer, such as for 30 seconds or longer, such as for 1 minute or longer, such as for 5 minutes or longer and including for 10 minutes or longer.

In some embodiments, the memory includes instructions to displace the build elevator in predetermined increments which builds the microstructure of the polymeric structure. In some instances, the memory includes instructions to displace the build elevator in increments of 0.001 μm or more, such as 0.005 μm or more, such as 0.01 μm or more, such as 0.05 μm or more, such as 0.1 μm or more, such as 0.5 μm or more, such as 1 μm or more, such as 2 μm or more, such as 3 μm or more, such as 4 μm or more, such as 5 μm or more and including in increments of 10 μm or more. In certain instances, the memory includes instructions to displace the build elevator in increments of from 0.001 μm to 20 μm, such as from 0.005 μm to 19 μm, such as from 0.01 μm to 18 μm, such as from 0.05 μm to 17 μm, such as from 0.1 μm to 16 μm, such as from 0.2 μm to 17 μm, such as from 0.3 μm to 16 μm, such as from 0.4 μm to 15 μm, such as from 0.5 μm to 14 μm, such as from 0.6 μm to 13 μm, such as from 0.7 μm to 12 μm, such as from 0.8 μm to 11 μm and including from 0.9 μm to 10 μm.

In some embodiments, systems also include a source of the polymerizable composition. In some instances, the source is configured to continuously deliver polymerizable composition through the one or more conduits to the build surface. In some instances, the system is configured to add polymerizable composition to the build surface after each displacement of the build elevator away from the build surface. In some embodiments, the polymerizable composition is selected from polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof. In certain instances, one or more of the polymerizable materials includes carbon nanotubes, such as single-walled carbon nanotubes (SWCNTs) or multi-walled carbon nanotubes (MWCNTs). In some instances, the polymerizable composition conveyed through the conduit has a viscosity of from 100 cP to 7000 cP, such as from 150 cP to 6500 cP, such as from 200 cP to 6000 cP, such as from 250 cP to 5500 cP, such as from 300 cP to 5000 cP, such as from 350 cP to 4500 cP, such as from 400 cP to 4000 cP, such as from 450 cP to 3500 cP and including a viscosity of from 500 cP to 3000 cP.

In some embodiments, the light source is configured to irradiate through the build surface. In some instances, at least a part of the build surface is permeable to a polymerization inhibitor, such as where the polymerization inhibitor is oxygen.

In certain embodiments, the liquid interface polymerization module is a continuous liquid interface production (CLIP) system such as that described in International Patent Publication No. WO 2014/126837; U.S. Patent Publication Nos. 2018/0064920; 2017/0095972; 2021/0246252 and U.S. Patent Publication Nos. 10,155,882; 10,792,857, the disclosures of which are herein incorporated by reference.

Aspects of the present disclosure further include computer-controlled systems, where the systems further include one or more computers for complete automation or partial automation of the methods described herein. In embodiments, the system includes an input module, a processing module and an output module. The subject systems may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

Systems may include a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. The processor may be any suitable analog or digital system.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid-state storage devices (including magnetic or optical disks or tape or RAM, or any other suitable device, either fixed or portable). The processor may include a general-purpose digital microprocessor suitably programmed from a computer readable medium carrying necessary program code. Programming can be provided remotely to processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, an RS-232 port, or any other suitable electrical connection port to allow data communication between the subject systems and other external devices such as a computer terminal (for example, at a physician's office or in hospital environment) that is configured for similar complementary data communication.

In one embodiment, the communication interface is configured for infrared communication, Bluetooth® communication, or any other suitable wireless communication protocol to enable the subject systems to communicate with other devices such as computer terminals and/or networks, communication enabled mobile telephones, personal digital assistants, or any other communication devices which the user may use in conjunction.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or WiFi connection to the internet at a WiFi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT®, Windows XP, Windows 7, Windows 8, iOS, Sun Solaris, Linux, OS/400, Compaq Tru64 Unix, SGI IRIX, Siemens Reliant Unix, and others.

### Non-Transitory Computer-Readable Storage Medium

Aspects of the present disclosure further include non-transitory computer readable storage mediums having instructions for practicing the subject methods. Computer readable storage mediums may be employed on one or more computers for complete automation or partial automation of a system for practicing methods described herein. In certain embodiments, instructions in accordance with the method described herein can be coded onto a computer-readable medium in the form of “programming”, where the term “computer readable medium” as used herein refers to any non-transitory storage medium that participates in providing instructions and data to a computer for execution and processing. Examples of suitable non-transitory storage media include a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS), whether or not such devices are internal or external to the computer. A file containing information can be “stored” on computer readable medium, where “storing” means recording information such that it is accessible and retrievable at a later date by a computer. The computer-implemented method described herein can be executed using programming that can be written in one or more of any number of computer programming languages. Such languages include, for example, Python, Java, Java Script, C, C#, C++, Go, R, Swift, PHP, as well as any many others.

In some instances, the non-transitory computer readable storage medium has instructions stored thereon that include: algorithm for conveying a polymerizable composition through a conduit into a space between a build elevator and a build surface of a liquid interface production module, algorithm for irradiating the polymerizable composition positioned between the build elevator and the build surface to generate a polymerizable composition having a first polymerized region of the polymerizable composition having a microchannel in contact with the build elevator and a first non-polymerized region of the polymerizable composition in contact with the build surface, algorithm for displacing the build elevator away from the build surface, algorithm irradiating the first non-polymerized region of the polymerizable composition to generate a second polymerized region of the polymerizable composition in contact with the first polymerized region and a second non-polymerized region in contact with the build surface and algorithm for repeating one or more steps in a manner sufficient to generate a polymeric structure that includes one or more microchannels positioned within the polymeric structure. In some instances, the non-transitory computer readable storage medium has algorithm for injecting the polymerizable composition through the conduit with a syringe pump.

In some instances, the non-transitory computer readable storage medium has algorithm for conveying a plurality of different polymerizable materials through a plurality of different conduits into the space between the build elevator and the build surface. In certain instances, the non-transitory computer readable storage medium has algorithm for conveying a first polymerizable material through a first conduit into the space between the build elevator and the build surface; and algorithm for conveying a second polymerizable material through a second conduit into the space between the build elevator and the build surface. In certain instances, the non-transitory computer readable storage medium has algorithm for modeling a predetermined fluidic network geometry for the microchannels positioned within the polymeric structure. In some instances, the non-transitory computer readable storage medium has algorithm for determining the position of one or more injection nodes. In certain instances, the non-transitory computer readable storage medium has algorithm for determining the position for injection nodes to be at a position in the fluidic network where suction forces generated when displacing the build elevator away from the build surface are minimized. In some instances, the non-transitory computer readable storage medium has algorithm for determining the size of each microchannel to be generated within the polymeric structure. In some instances, the non-transitory computer readable storage medium has algorithm for determining the number of microchannels to be generated within the polymeric structure. In some instances, the non-transitory computer readable storage medium has algorithm for modeling the predetermined fluidic network geometry for the microchannels positioned within the polymeric structure based on the three-dimensional shape of the generated polymeric structure. In certain instances, the non-transitory computer readable storage medium has algorithm for determining the size and position of the microchannel after each displacement of the build elevator. In some embodiments, the non-transitory computer readable storage medium has algorithm for adding polymerizable composition to the build surface after each displacement of the build elevator away from the build surface.

The non-transitory computer readable storage medium may be employed on one or more computer systems having a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as those mentioned above, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques.

Polymeric Structures Having a Microstructure with a Microchannel

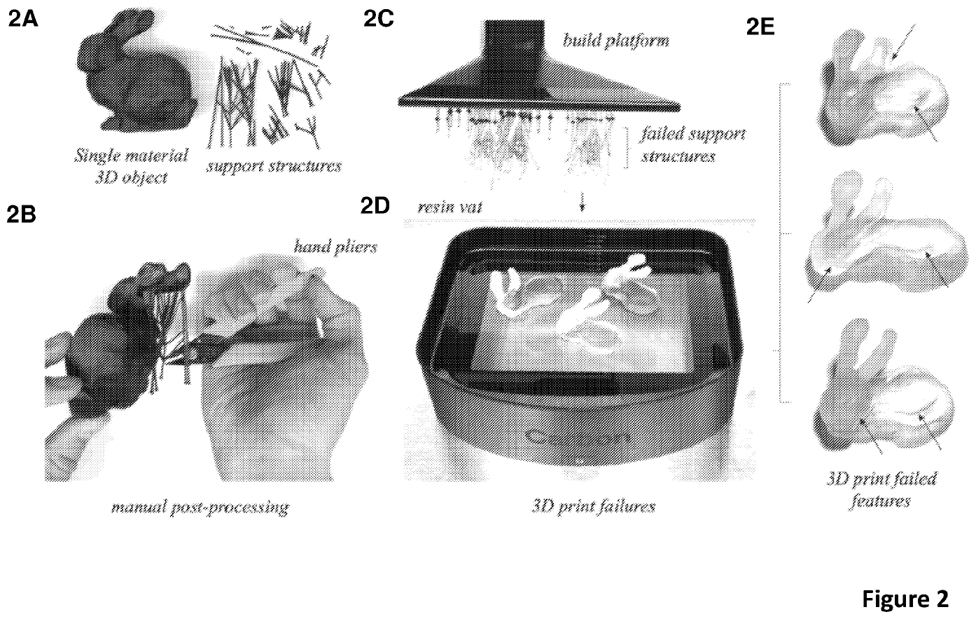

Aspects of the present disclosure also include polymeric structures having one or more microchannels positioned within the polymeric structure prepared by the subject methods described herein. As described in greater detail below, in certain instances the polymeric structures are formed by injection continuous liquid interface production (e.g., iCLIP) which provides for additive manufacture and vat photopolymerization that overcomes mass transport limitations on resin flow, such as Stefan adhesion forces. In some instances, the subject polymeric structures are formed without the use of support structures or where the use of support structures is reduced by 10% or more, such as by 25% or more, such as by 50% or more, including by 75% or more. FIGS. 2A-2E depict conventional 3D printing approaches which require the use of supports to avoid print failures. FIG. 2A depicts a single material 3D object printed with the use of support structures. In order to obtain the final printed product, print supports need to be manually removed as shown in FIG. 2B. In addition, support structures can fail during printing as shown by the failed support structures on build platform depicted in FIG. 2C. Without support structures, conventional 3D printing approaches can result in print failures shown in the resin vat of FIG. 2D. FIG. 2E depicts the specific failure points of the object when printed using conventional 3D printing approaches.

Polymer structures of interest may include one or more distinct microchannels, such as 2 or more, such as 3 or more, such as 4 or more, such as 5 or more and including 10 or more distinct microchannels. In some instances, one or more of the microchannels includes one or more bifurcations, such as 2 or more bifurcations, such as 3 or more, such as 4 or more, such as 5 or more and including 10 or more bifurcations. In some instances, the microchannels extend through the polymeric structure. In some instances, the microchannels are fluidically interconnected. In some instances, the polymeric structure has a single network of fluidically interconnected microchannel networks. In other instances, the polymeric structure has a plurality of fluidically interconnected microchannel networks. In some embodiments, each microchannel has a diameter of 0.01 μm or more, such as 0.05 μm or more, such as 0.1 μm or more, such as 0.5 μm or more, such as 1 μm or more, such as 2 μm or more, such as 3 μm or more, such as 4 μm or more, such as 5 μm or more, such as 10 μm or more, such as 15 μm or more, such as 20 μm or more, such as 25 μm or more, such as 50 μm or more, such as 75 μm or more and including 100 μm or more. In certain instances, each microchannel has a diameter of from 0.01 μm to 75 μm, such as from 0.05 μm to 50 μm, such as from 0.1 μm to 25 μm, such as from 0.5 μm to 20 μm.

In some instances, the polymeric structure has a solid microstructure. In some instances, the polymeric structure has a lattice microstructure. In certain instances, the polymeric structure has a heterogeneously solid-latticed microstructure. In some embodiments, the lattice microstructures of the polymeric structures described herein have 2 or more repeating lattice cell units, such as 3 or more repeating lattice cell units, such as 4 or more repeating lattice cell units and including 5 or more repeating lattice cell units. In some instances, the lattice microstructure has a lattice shape selected from tetrahedral, Kagome, rhombic, icosahedral, Voronoi or triangular. In some instances, the lattice microstructure is composed of two or more lattice cell units having different lattice shapes, such where the lattice microstructure is composed of 3 or more different lattice shapes, such as 4 or more different lattice shapes and including where the lattice microstructure is composed of 5 or more different lattice shapes. In some embodiments, the lattice microstructure is formed from lattice cells having a unit size of from 1 μm to 1000 μm, such as from 5 μm to 950 μm, such as from 10 μm to 900 μm, such as from 15 μm to 850 μm, such as from 20 μm to 800 μm, such as from 25 μm to 750 μm, such as from 30 μm to 700 μm, such as from 35 μm to 650 μm, such as from 40 μm to 600 μm, such as from 45 μm to 550 μm and including from 50 μm to 500 μm, for example from 200 μm to 500 μm. In embodiments, the lattice microstructure has a volume of from 0.01 μL to 25 μL, such as from 0.02 μL to 24.5 μL, such as from 0.03 μL to 24 μL, such as from 0.04 μL to 23.5 μL, such as rom 0.05 μL to 23 μL, such as from 0.6 μL to 22.5 μL, such as from 0.07 μL to 22 μL, such as from 0.08 μL to 21.5 μL, such as from 0.09 μL to 21 μL, such as from 0.1 μL to 20 μL, such as from 0.5 μL to 19 μL, such as from 1 μL to 18 μL, such as from 2 μL to 17 μL, such as from 3 μL to 16 μL and including from 4 μL to 15 μL. As described in greater detail below, the polymeric structure may be configured to contain a composition within the lattice microstructure (e.g., a fluidic composition) where in some embodiments the lattice microstructure is configured to contain a volume of from 0.1 μL to 25 μL, such as from 0.2 μL to 24 μL, such as from 0.3 μL to 23 μL, such as from 0.4 μL to 22 μL, such as rom 0.5 μL to 21 μL, such as from 0.6 μL to 20 μL, such as from 0.7 μL to 19 μL, such as from 0.8 μL to 18 μL, such as from 0.9 μL to 17 μL and including where the lattice microstructure is configured to contain a volume of from 1 μL to 15 μL.

FIGS. 3A-3I depict polymeric structures having solid and lattice microstructures having a microchannel positioned therein according to certain embodiments. FIG. 3A depicts an image slice of a solid microstructure polymeric structure where dots in the image slice show a cross-section of microchannels extending through the polymeric structure. FIG. 3B depicts an image slice for a heterogeneously solid-latticed polymeric structure having an internally solid and an externally latticed microstructure. The dots in the solid component show the microchannels extending through the solid microstructure of the polymeric structure. FIG. 3C depicts an image slice for a polymeric structure having a fully latticed microstructure. The circular spots show a cross-section of microchannels that extend through the latticed microstructure. FIG. 3D depicts an isometric CT scan of the polymeric structure having a solid microstructure depicted in FIG. 3A. FIG. 3E depicts an isometric CT scan of the heterogeneously solid-latticed polymeric structure depicted in FIG. 3B. FIG. 3F depicts an isometric CT scan of the fully latticed polymeric structure of FIG. 3C. FIG. 3G depicts the microchannels present in the polymeric structure having a solid microstructure depicted in FIG. 3A. FIG. 3H depicts the microchannels present in the heterogeneously solid-latticed polymeric structure depicted in FIG. 3B. FIG. 3I depicts the microchannels present in the fully latticed polymeric structure of FIG. 3C.

In certain instances, polymeric structures having a lattice microstructure can alter geometry or shape in response to an applied stimulus. In certain embodiments, the stimulus is applied mechanical pressure. In some instances, the dynamic polymeric structure is compliant and exhibits motion through elastic deformation of the polymeric microstructure. FIG. 4 depicts deformation of a polymeric structure having a lattice microstructure according to certain embodiments. In other instances, polymeric structures having a lattice microstructure exhibit a mechanical integrity sufficient to be load bearing. Depending on the density of the lattice microstructure, in some embodiments polymeric structures exhibit a mechanical integrity sufficient to carry a load of 0.1 N or more, such as 0.5 N or more, such as 1 N or more, such as 2 N or more, such as 3 N or more, such as 4 N or more, such as 5 N or more, such as 10 N or more, such as 15 N or more, such as 20 N or more, such as 25 N or more, such as 50 N or more, such as 75 N or more and including 100 N or more.

In embodiments, the polymeric structure is formed from one or more polymerizable materials which may include but is not limited to polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof. In certain embodiments, the polymeric structure is formed from polyethylene glycol dimethacrylate (PEGDMA). In certain embodiments, the polymeric structure is formed from trimethylolpropane triacrylate (TMPTA) monomer. In certain embodiments, the polymerizable material is selected from polycarbonates, polyvinyl chloride (PVC), polyurethanes, polyethers, polyamides, polyimides, or copolymers of these thermoplastics, such as PETG (glycol-modified polyethylene terephthalate), among other polymeric plastic materials. In certain embodiments, the polymeric structure is formed from a polyester, where polyesters of interest may include, but are not limited to, poly(alkylene terephthalates) such as poly(ethylene terephthalate) (PET), bottle-grade PET (a copolymer made based on monoethylene glycol, terephthalic acid, and other comonomers such as isophthalic acid, cyclohexene dimethanol, etc.), poly(butylene terephthalate) (PBT), and poly(hexamethylene terephthalate); poly(alkylene adipates) such as poly(ethylene adipate), poly(1,4-butylene adipate), and poly(hexamethylene adipate); poly(alkylene suberates) such as poly(ethylene suberate); poly(alkylene sebacates) such as poly(ethylene sebacate); poly(ε-caprolactone) and poly(β-propiolactone); poly(alkylene isophthalates) such as poly(ethylene isophthalate); poly(alkylene 2,6-naphthalene-dicarboxylates) such as poly(ethylene 2,6-naphthalene-dicarboxylate); poly(alkylene sulfonyl-4,4′-dibenzoates) such as poly(ethylene sulfonyl-4,4′-dibenzoate); poly(p-phenylene alkylene dicarboxylates) such as poly(p-phenylene ethylene dicarboxylates); poly(trans-1,4-cyclohexanediyl alkylene dicarboxylates) such as poly(trans-1,4-cyclohexanediyl ethylene dicarboxylate); poly(1,4-cyclohexane-dimethylene alkylene dicarboxylates) such as poly(1,4-cyclohexane-dimethylene ethylene dicarboxylate); poly([2.2.2]-bicyclooctane-1,4-dimethylene alkylene dicarboxylates) such as poly([2.2.2]-bicyclooctane-1,4-dimethylene ethylene dicarboxylate); lactic acid polymers and copolymers such as(S)-polylactide, (R,S)-polylactide, poly(tetramethylglycolide), and poly(lactide-co-glycolide); and polycarbonates of bisphenol A, 3,3′-dimethylbisphenol A, 3,3′,5,5′-tetrachlorobisphenol A, 3,3′,5,5′-tetramethylbisphenol A; polyamides such as poly(p-phenylene terephthalamide); polyethylene Terephthalate (e.g., Mylar™ Polyethylene Terephthalate), combinations thereof, and the like.

In some embodiments, the polymeric structure is formed from one or more polymerizable materials, such as two or more different polymerizable materials, such as three or more and including four or more different polymerizable materials. In certain instances, one or more of the polymerizable materials includes carbon nanotubes, such as single-walled carbon nanotubes (SWCNTs) or multi-walled carbon nanotubes (MWCNTs).

In some embodiments, one or more of the microchannels includes a composition positioned therein which fills at least a portion of the void volume of the microchannels. In some instances, 1% or more of the void volume of the microchannel is filled with a composition, such as 2% or more, such as 3% or more, such as 4% or more, such as 5% or more, such as 10% or more, such as 15% or more, such as 20% or more, such as 25% or more, such as 50% or more, such as 75% or more, such as 90% or more, such as 95% or more, such as 97% or more, such as 99% or more and including where the entire void volume (i.e., 100%) is filled with a composition. In some instances, the composition that fills the void volume of the microchannel is a non-polymerizable composition. In some instances, the non-polymerizable composition is a composition selected from a Newtonian liquid, a shear thinning liquid, a shear thickening liquid, a magnetorheological liquid, an electric field responsive liquid and a gas. In some instances, the microchannels of the polymeric structure is filled with a polymeric composition, such as a polymerizable material selected from polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof. In certain embodiments, the polymerizable material used to fill the microchannels of the polymeric structure is the same polymerizable material used to form the polymeric structure. In certain instances, the composition that fills the void volume of the microchannels includes carbon nanotubes.

Notwithstanding the appended claims, the disclosure is also defined by the following clauses:

1. A method for making a polymeric structure comprising one or more microchannels positioned within the polymeric structure, the method comprising:
a) conveying a polymerizable composition through a conduit into a space between a build elevator and a build surface of a liquid interface production module;
b) irradiating the polymerizable composition positioned between the build elevator and the build surface to generate a polymerizable composition comprising a first polymerized region of the polymerizable composition comprising a microchannel in contact with the build elevator and a first non-polymerized region of the polymerizable composition in contact with the build surface;
b) displacing the build elevator away from the build surface;
c) irradiating the first non-polymerized region of the polymerizable composition to generate a second polymerized region of the polymerizable composition in contact with the first polymerized region and a second non-polymerized region in contact with the build surface; and
d) repeating steps a)-c) in a manner sufficient to generate a polymeric structure comprising one or more microchannels positioned within the polymeric structure.

2. The method according to 1, wherein the method comprises injecting the polymerizable composition through the conduit with a syringe pump.

3. The method according to any one of 1-2, wherein the polymerizable composition is conveyed through two or more conduits into the space between the build elevator and the build surface.

4. The method according to any one of 1-3, wherein the conduit is positioned internal to the generated polymeric structure.

5. The method according to any one of 1-3, wherein the conduit is positioned external to the generated polymeric structure.

6. The method according to any one of 1-5, wherein the polymerizable composition is conveyed through a conduit that passes through the build elevator.

7. The method according to any one of 1-6, wherein the method comprises conveying two or more different polymerizable materials into the space between the build elevator and the build surface.

8. The method according to 7, wherein the method comprises:
conveying a first polymerizable material through a first conduit into the space between the build elevator and the build surface; and
conveying a second polymerizable material through a second conduit into the space between the build elevator and the build surface.

9. The method according to 7, wherein the method comprises conveying a plurality of different polymerizable materials through a plurality of different conduits into the space between the build elevator and the build surface.

10. The method according to any one of 1-9, wherein the polymerizable material has a viscosity of from 100 cP to 7000 cP.

11. The method according to any one of 1-10, wherein the polymerizable material is conveyed through the conduit into the space between the build elevator and the build surface at a flow rate of from 0.1 μL/s to 50 μL/s.

12. The method according to any one of 1-10, wherein the polymerizable material is conveyed into the space between the build elevator and the build surface at a flow rate of from 5 μL/s to 30 μL/s.

13. The method according to any one of 1-10, wherein the polymerizable material is conveyed into the space between the build elevator and the build surface at a flow rate of from 7 μL/s to 27 μL/s.

14. The method according to any one of 1-13, wherein the polymeric structure is generated at a rate of from 5 mm/hr to 150 mm/hr.

15. The method according to any one of 1-13, wherein the polymeric structure is generated at a rate of from 25 mm/hr to 125 mm/hr.

16. The method according to any one of 1-15, wherein the method comprises modeling a predetermined fluidic network geometry for the microchannels positioned within the polymeric structure.

17. The method according to 16, wherein modeling the predetermined fluidic network geometry for the microchannels positioned within the polymeric structure comprises determining the position of one or more injection nodes.

18. The method according to 17, wherein injection nodes are determined to be at a position in the fluidic network where suction forces generated when displacing the build elevator away from the build surface are minimized.

19. The method according to any one of 16-18, wherein modeling the predetermined fluidic network geometry comprises determining the size of each microchannel to be generated within the polymeric structure.

20. The method according to any one of 16-19, wherein modeling the predetermined fluidic network geometry comprises determining the number of microchannels to be generated within the polymeric structure.

21. The method according to any one of 16-20, wherein the predetermined fluidic network geometry of the microchannels is based on the three-dimensional shape of the generated polymeric structure.

22. The method according to any one of 16-21, wherein modeling the predetermined fluidic network geometry comprises determining the size and position of the microchannel after each displacement of the build elevator.

23. The method according to any one of 1-22, wherein the build elevator is displaced in predetermined increments of from 0.5 μm to 1.0 μm.

24. The method according to 23, wherein the method further comprises adding polymerizable composition to the build surface after each displacement of the build elevator away from the build surface.

25. The method according to any one of 1-24, wherein the polymerizable composition is irradiated through build surface.

26. The method according to any one of 1-25, wherein the polymerizable composition is irradiated in the presence of a polymerization inhibitor.

27. The method according to any one of 1-26, wherein the polymerizable composition is continuously polymerized while displacing the build elevator away from the build surface.

28. The method according to any one of 26-27, wherein the build surface is permeable to the polymerization inhibitor.

29. The method according to 28, wherein the polymerization inhibitor is oxygen.

30. The method according to any one of 1-29, wherein the polymerizable composition is irradiated with light.

31. The method according to 30, wherein the polymerizable composition is irradiated with a micro-digital light projection system.

32. The method according to 31, wherein the micro-digital light projection system comprises:
a light beam generator component; and
a light projection monitoring component.

33. The method according to 32, wherein the light beam generator component comprises:
a light source;
a tube lens; and
one or more projection lenses.

34. The method according to any one of 32-33, wherein the light projection monitoring component comprises a photodetector.

35. The method according to any one of 1-34, wherein the polymerizable composition comprises a polymerizable material selected from the group consisting of polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof.

36. The method according to 35, wherein the polymerizable material comprises carbon nanotubes.

37. The method according to any one of 1-36, wherein method further comprises filling at least a portion of the void volume of one or more microchannels of the generated polymeric structure.

38. The method according to 37, wherein the method comprises filling 5% or more of the void volume of the microchannels.

39. The method according to any one of 37-38, wherein the void volume of the microchannels is filled with a polymerizable material.

40. The method according to 39, wherein the polymerizable material is selected from the group consisting of polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof.

41. The method according to any one of 39-40, wherein the polymerizable material comprises carbon nanotubes.

42. A system for making a polymeric structure comprising one or more microchannels positioned within the polymeric structure, the system comprising:
a light source;
a liquid interface polymerization module comprising a build elevator and a build surface configured for generating the polymeric structure comprising one or more microchannels from a polymerizable composition positioned therebetween; and
a conduit for conveying polymerizable composition to the liquid interface polymerization module.

43. The system according to 42, wherein the system further comprises a syringe pump configured to inject the polymerizable composition into the liquid interface polymerization module through the conduit.

44. The system according to any one of 42-43, wherein the system comprises two or more conduits in fluid communication with a source of the polymerizable composition and the liquid interface polymerization module.

45. The system according to any one of 42-44, wherein the conduit passes through the build elevator.

46. The system according to any one of 42-45, wherein the system comprises a plurality of conduits for conveying polymerizable composition to the liquid interface polymerization module.

47. The system according to 46, wherein the system comprises:
a first conduit in fluid communication with a source of a first polymerizable material and the liquid interface polymerization module; and
a second conduit in fluid communication with a source of a second polymerizable material and the liquid interface polymerization module.

48. The system according to 46, wherein the system comprises a plurality of conduits configured to convey a plurality of different polymerizable materials to the liquid interface polymerization module.

49. The system according to any one of 42-48, wherein the system is configured to convey the polymerizable composition through the conduit to the liquid interface polymerization module at a flow rate of from 0.1 L/s to 50 μL/s.

50. The system according to any one of 42-48, wherein the system is configured to convey the polymerizable composition through the conduit to the liquid interface polymerization module at a flow rate of from 5 μL/s to 30 μL/s.

51. The system according to any one of 42-48, wherein the system is configured to convey the polymerizable composition through the conduit to the liquid interface polymerization module at a flow rate of from 7 μL/s to 27 μL/s.

52. The system according to any one of 42-51, wherein the system further comprises a processor comprising memory operably coupled to the processor wherein the memory comprises instructions stored thereon, which when executed by the processor, cause the processor to:
a) irradiate a polymerizable composition positioned between the build elevator and the build surface to generate a polymerizable composition comprising a first polymerized region of the polymerizable composition in contact with the build elevator and a first non-polymerized region of the polymerizable composition in contact with the build surface;
b) displace the build elevator away from the build surface;
c) irradiate the first non-polymerized region of the polymerizable composition to generate a second polymerized region of the polymerizable composition in contact with the first polymerized region and a second non-polymerized region in contact with the build surface; and
d) repeat steps a)-c) in a manner sufficient to generate a polymeric structure comprising one or more microchannels positioned within the polymeric structure.

53. The system according to 52, wherein the memory comprises instructions stored thereon, which when executed by the processor cause the processor to model a predetermined fluidic network geometry for the microchannels positioned within the polymeric structure.

54. The system according to 53, wherein the memory comprises instructions stored thereon, which when executed by the processor cause the processor to determine the position of one or more injection nodes.

55. The system according to 54, wherein the memory comprises instructions stored thereon, which when executed by the processor cause the processor to determine the position of one or more injection nodes where suction forces generated when displacing the build elevator away from the build surface are minimized.

56. The system according to any one of 53-55, wherein the memory comprises instructions stored thereon, which when executed by the processor cause the processor to determine the size of each microchannel to be generated within the polymeric structure.

57. The system according to any one of 53-56, wherein the memory comprises instructions stored thereon, which when executed by the processor cause the processor to determine the number of microchannels to be generated within the polymeric structure.

58. The system according to any one of 53-57, wherein the predetermined fluidic network geometry of the microchannels is based on the three-dimensional shape of the generated polymeric structure.

59. The system according to any one of 53-28, wherein the memory comprises instructions stored thereon, which when executed by the processor cause the processor to determine the size and position of the microchannel after each displacement of the build elevator.

60. The system according to any one of 52-59, wherein the memory comprises instructions stored thereon, which when executed by the processor cause the processor to displace the build elevator in predetermined increments of from 0.5 μm to 1.0 μm.

61. The system according to any one of 52-60, wherein the memory comprises instructions stored thereon, which when executed by the processor cause the processor to add polymerizable composition to the build surface after each displacement of the build elevator away from the build surface.

62. The system according to any one of 42-61, wherein the light source is configured to irradiate through the build surface.

63. The system according to any one of 42-62, wherein at least part of the build surface is permeable to a polymerization inhibitor.

64. The system according to 63, wherein the polymerization inhibitor is oxygen.

65. The system according to any one of 42-64, wherein the system comprises a micro-digital light projection system comprising a light beam generator component and a light projection monitoring component.

66. The system according to 65, wherein the light beam generator component comprises:
a light source;
a tube lens; and
one or more projection lenses.

67. The system according to any one of 65-66, wherein the light projection monitoring component comprises a photodetector.

68. A polymeric structure comprising one or more microchannels positioned within the polymeric structure.

69. The polymeric structure according to 68, wherein polymeric structure comprises a plurality of microchannels.

70. The polymeric structure according to any one of 68-69, wherein one or more of the microchannels comprises at least one bifurcation.

71. The polymeric structure according to any one of 68-70, wherein one or more of the microchannels extends through the polymeric structure.

72. The polymeric structure according to any one of 68-71, wherein the microchannels are fluidically interconnected.

73. The polymeric structure according to 72, wherein the polymeric structure comprises a single network of fluidically interconnected microchannels.

74. The polymeric structure according to 73, wherein the polymeric structure comprises a plurality of fluidically interconnected microchannel networks.

75. The polymeric structure according to any one of 68-74, wherein each microchannel comprises a diameter of from 0.1 μm to 20 μm.

76. The polymeric structure according to any one of 68-75, wherein the polymeric structure comprises a lattice microstructure having one or more lattice cell units.

77. The polymeric structure according to any one of 68-76, wherein the polymeric structure comprises a solid microstructure.

78. The polymeric structure according to any one of 68-77, wherein the polymeric structure is formed from one or more polymerizable materials.

79. The polymeric structure according to 78, wherein the polymeric structure is formed from two or more different polymerizable materials.

80. The polymeric structure according to 78, wherein the polymeric structure is formed from three or more different polymerizable materials.

81. The polymeric structure according to 78, wherein the polymeric structure is formed from four or more different polymerizable materials.

82. The polymeric structure according to any one of 78-81, wherein each polymerizable material is selected from the group consisting of polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof.

83. The polymeric structure according to 82, wherein the polymerizable material comprises carbon nanotubes.

84. The polymeric structure according to any one of 68-83, wherein one or more microchannels comprises a composition positioned therein that fills at least a portion of the void volume of the microchannels.

85. The polymeric structure according to 84, wherein the composition fills 5% or more of the void volume of the microchannels.

86. The polymeric structure according to any one of 84-85, wherein the composition is a polymeric composition.

87. The polymeric structure according to 86, wherein the composition is polymerizable material selected from the group consisting of polycaprolactone, polyalycolic acid, polylactic acid, polylactic-co-glycolic acid, polyethylene glycol, polyethylene glycol dimethacrylate (PEGDMA), thiol-enes, anhydrides, polyacrylic acid, poly methylmethacrylate, trimethylolpropane triacrylate (TMPTA) monomer, polyvinyl alcohol, polyvinylpyrrolidone, vinyl carbonates, vinyl esters, acrylamides, hyaluronic acid, chitosan, collagen, gelatin, carboxymethylcellulose, and blends or copolymers thereof.

88. The polymeric structure according to any one of 86-87, wherein the polymeric composition comprises carbon nanotubes.

89. A non-transitory computer readable storage medium for making a polymeric structure in a liquid interface production module, wherein the non-transitory computer readable storage medium comprises instructions stored thereon, the instruction comprising:
algorithm for conveying a polymerizable composition through a conduit into a space between a build elevator and a build surface of a liquid interface production module;
algorithm for irradiating the polymerizable composition positioned between the build elevator and the build surface to generate a polymerizable composition comprising a first polymerized region of the polymerizable composition comprising a microchannel in contact with the build elevator and a first non-polymerized region of the polymerizable composition in contact with the build surface;
algorithm for displacing the build elevator away from the build surface;
algorithm irradiating the first non-polymerized region of the polymerizable composition to generate a second polymerized region of the polymerizable composition in contact with the first polymerized region and a second non-polymerized region in contact with the build surface; and
algorithm for repeating one or more steps in a manner sufficient to generate a polymeric structure comprising one or more microchannels positioned within the polymeric structure.

90. The non-transitory computer readable storage medium according to 89, wherein the non-transitory computer readable storage medium comprises algorithm for injecting the polymerizable composition through the conduit with a syringe pump.

91. The non-transitory computer readable storage medium according to any one of 89-90, wherein the non-transitory computer readable storage medium comprises:
algorithm for conveying a first polymerizable material through a first conduit into the space between the build elevator and the build surface; and
algorithm for conveying a second polymerizable material through a second conduit into the space between the build elevator and the build surface.

92. The non-transitory computer readable storage medium according to any one of 89-90, wherein the non-transitory computer readable storage medium comprises algorithm for conveying a plurality of different polymerizable materials through a plurality of different conduits into the space between the build elevator and the build surface.

93. The non-transitory computer readable storage medium according to any one of 89-92, wherein the non-transitory computer readable storage medium comprises algorithm for modeling a predetermined fluidic network geometry for the microchannels positioned within the polymeric structure.

94. The non-transitory computer readable storage medium according to 93, wherein the non-transitory computer readable storage medium comprises algorithm for determining the position of one or more injection nodes.

95. The non-transitory computer readable storage medium according to 93, wherein the non-transitory computer readable storage medium comprises algorithm for determining the position for injection nodes to be at a position in the fluidic network where suction forces generated when displacing the build elevator away from the build surface are minimized.

96. The non-transitory computer readable storage medium according to any one of 93-95 wherein the non-transitory computer readable storage medium comprises algorithm for determining the size of each microchannel to be generated within the polymeric structure.

97. The non-transitory computer readable storage medium according to any one of 93-96 wherein the non-transitory computer readable storage medium comprises algorithm for determining the number of microchannels to be generated within the polymeric structure.

98. The non-transitory computer readable storage medium according to any one of 93-97, wherein the non-transitory computer readable storage medium comprises algorithm for modeling the predetermined fluidic network geometry for the microchannels positioned within the polymeric structure based on the three-dimensional shape of the generated polymeric structure.

99. The non-transitory computer readable storage medium according to any one of 93-98, wherein the non-transitory computer readable storage medium comprises algorithm for determining the size and position of the microchannel after each displacement of the build elevator.

100. The non-transitory computer readable storage medium according to any one of 93-99, wherein the non-transitory computer readable storage medium comprises algorithm for adding polymerizable composition to the build surface after each displacement of the build elevator away from the build surface.

### EXPERIMENTAL

The following examples are offered by way of illustration and not by way of limitation. Specifically, the following examples are of specific embodiments for carrying out the present disclosure. The examples are for illustrative purposes only and are not intended to limit the scope of the present disclosure in any way. Efforts have been made to ensure accuracy with respect to numbers used (e.g., amounts, temperatures, etc.), but some experimental error and deviation should, of course, be allowed for.

### Example 1—Injection Continuous Liquid Interface Production (iCLIP) of 3D Objects

In this example, additive manufacturing with increased print speeds, use of higher-viscosity resins and print with multiple different resins simultaneously is demonstrated. This example provides an unexplored ultraviolet-based photopolymerization three-dimensional printing process. The method exploits a continuous liquid interface—the dead zone—mechanically fed with resin at elevated pressures through microfluidic channels dynamically created and integral to the growing part. Through mass transport control, injection continuous liquid interface production (iCLIP) accelerates printing speeds to 5- to 10-fold over current methods such as continuous liquid interface production (CLIP), can use resins an order of magnitude more viscous than CLIP, and can readily pattern a single heterogeneous object with different resins in all Cartesian coordinates. This example describes process parameters governing iCLIP and demonstrate use cases for rapidly printing carbon nanotube-filled composites, multi-material features with length scales spanning several orders of magnitude, and lattices with tunable moduli and energy absorption.

### Materials and Methods

Design of an iCLIP Printer

For print platform motion, a Nema 57 stepper motor supplied by a 12-V power bank was used to drive vertical build platform translation along a 30.5 cm Stroke Linear Motion router (VXB Ballbearings, Anaheim, CA, USA). The UV light engine used was a 3DLP9000 (Digital Light Innovations, TX, USA) with a 4 million pixel 2560×1600 digital micromirror device (DMD), configured with a 385-nm light-emitting diode (LED) and a 30-μm field-of-view projection lens, with a total projection area of 76.8 mm by 48 mm. The light engine is a combination of a DMD chip set (DLP9000, Texas Instrument, TX) along with a projection lens; the intrinsic specification of the DMD chipset is 385-nm UV wavelength, 2560×1600 DMD array, 7.6-μm by 7.6-μm pixel size, and build area of 19.5 mm by 12.2 mm; the projection lens diverges the UV projection to a 2560×1600 array of 30-μm by 30-μm pixels to a build an area of 76.8 mm by 48.0 mm at a working distance of 126.5 mm. The printer was coordinated with an Arduino MEGA 2560 microcontroller and RAMPS 1.4 shield running open-source Marlin firmware. Custom software, written in C++ and implemented in the Qt Integrated Development Environment to provide a graphical user interface, allowed for tailoring of UV light intensity, UV exposure time, stage speed and acceleration, layer thickness, and delay time after layers, within and between prints.

### Unfilled Resin Formulations

For print speed and resin viscosity experiments, resins of tunable viscosity were prepared by mixing isobornyl methacrylate, bisphenol A ethoxylated acrylate, and bisphenol A glycidyl methacrylate at varying ratios with 0.7 weight % of phenylbis(2,4,6-trimethylbenzoyl) phosphine oxide and 0.06 weight % of UV absorber 2-tert-butyl-6-(5-chloro-2H-benzotriazol-2-yl)-4-methylphenol (BLS 1326), all from Sigma-Aldrich (St. Louis, MO, USA), using a Thinky planetary mixer (Thinky USA Inc., Laguna Hills, CA, USA). Elastomeric resin formulation was prepared with varying ratios of epoxy aliphatic acrylate (trade name Ebecryl 113) and aliphatic urethane based diacrylate (trade name Ebecryl 8413), which were purchased from Allnex (Malaysia), diluted in isobornyl acrylate and mixed with 1.0 weight % of photoinitiator diphenyl(2,4,6-trimethylbenzoyl) phosphine oxide.

### Filled Resin Formulations

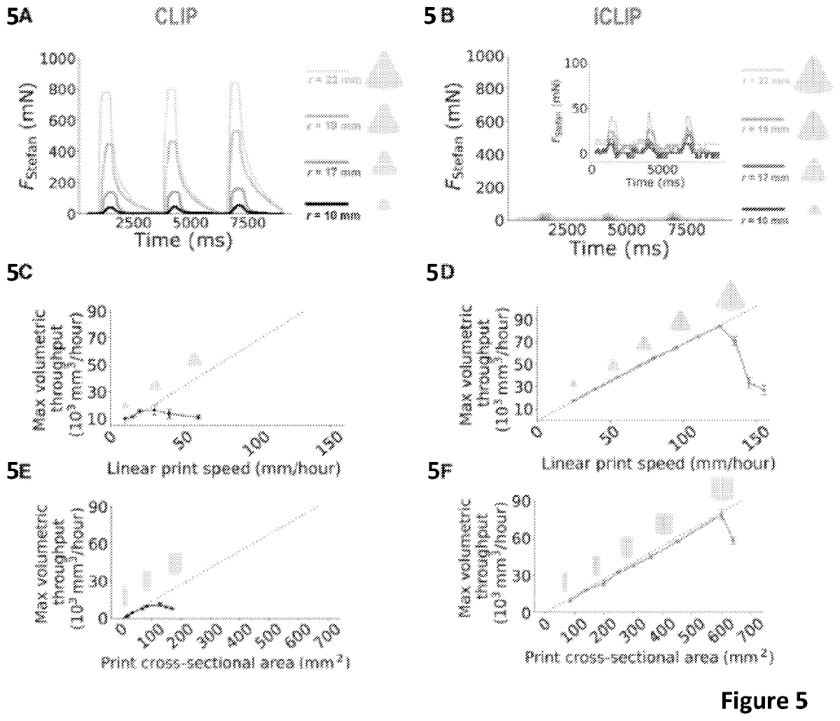

Carbon nanotube-filled resins were prepared by adding varying amounts of MWCNTs with >95% carbon basis and outer diameter of 20 nm to 30 nm (CheapTubes Inc. Grafton, VT, USA) to the base polymer matrix and then by subjecting to high shear mixing for 1 min with a planetary centrifuge and ultrasonicating for 2 hours to improve dispersion, periodically replacing the water bath to prevent overheating. To assess dispersion, MWCNT-filled resins were imaged under an Olympus BX53 optical microscope (with UIS2 optical system, infinity-corrected, and Abbe condenser), under 4× objective. Resins were printed immediately after dispersing to preempt MWCNT sedimentation. In addition to their elevated viscosity, making them unprintable by existing CLIP printing approaches, it is well-known that filling photopolymers with MWCNTs, which are UV absorbing and electron scavenging, decreases their cured thickness. To that end, we performed cure thickness experiments as shown in FIG. 5 to adjust UV light intensity accordingly. Specifically, a square five by five grid image was projected at 18 mW/cm² for 30 s. Afterward, the cured thickness at grid locations was measured with a Mitutoyo electronic indicator with precision of 0.5 μm (Mitutoyo American Corp., Aurora, IL).

### Rheological Characterization

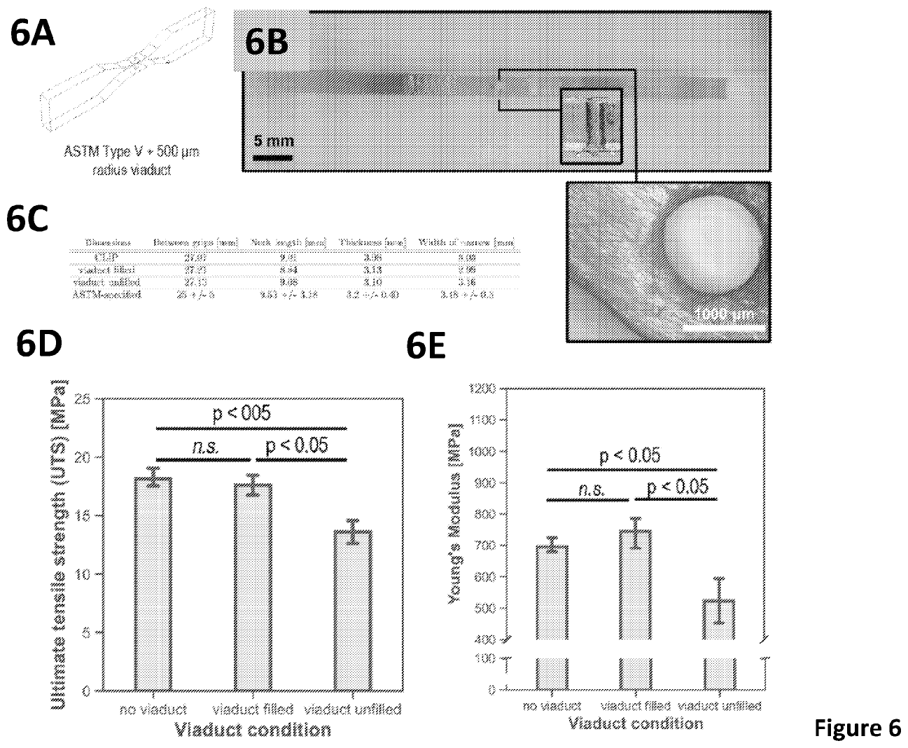

Rheological characterization as shown in FIG. 6 was carried out on uncured (unfilled or filled at different weight percent MWCNT) resin blends using an ARES rheometer [TA Instruments, Sesto San Giovanni (Mi), Italy]. A 25-mm parallel plate configuration was used with 0.1-mm gap between plates. Tests were carried out with the temperature set to 20° C., with shear rate range starting at 1 s⁻¹. Viscosities were then determined by the mean apparent viscosity at shear rates between 10 s⁻¹ and 30 s⁻¹. Apparent viscosity was taken as the average stress/shear ratio between shear rates of 1 s⁻¹ and 10 s⁻¹.

### Load Cell Measurements

The build platform was designed to accommodate Miniature S-Beam Jr. Load Cell 2.0 (Futek, Irvine, CA, USA) of dimensions 1.9 cm by 1.75 cm by 0.66 cm, with a resolution of ±0.05%, a rated output of 1 mV/V (250 g) to 2 mV/V (0.453 to 45.3 kg), a bandwidth of 2000 cycles/s, and with signal processing via a USB Load Cell Digital Amplifier (Futek, Irvine, CA, USA). Measurements were taken at 100 Hz. Force data were obtained midway through the print, i.e., once the build platform had fully exited the resin vat such that buoyancy forces did not change between layers.

### Optical Coherence Tomography

The base unit was the Ganymede Spectral Domain system (GAN621) from Thorlabs (Thorlabs, Newton, NJ, USA), with a center wavelength of 900 nm, a resolution of 3 μm (in air), an imaging depth of 1.9 mm (in air), and an A-scan line rate of 5 to 248 KHz. The GAN621 was equipped with an OCTG9 galvo scanner, and an LK4-BB scan lens with a lateral resolution of 12 μm, 16-mm by 16-mm field of view, and working distance of 42.3 mm. During printing, A-scans were acquired at a frequency of 50 kHz to produce sequential 2D B-scans. A solid cylinder, either without a viaduct for traditional CLIP or with a viaduct for iCLIP, was printed at ˜1 mm from a side of the vat consisting of a transparent glass slide; to capture views from this angle, a rotation mount was used to orient the scanner horizontally. The resin was imaged unfilled, being sufficiently scattering in the near-infrared range to visualize flow.

### Computational Fluid Dynamics Simulations

To control multimaterial iCLIP printing, the flow within the dead zone was simulated using commercially available CFD software (ANSYS Fluent, Canonsburg, PA, USA). The resin was simulated as a homogenous fluid with a non-Newtonian viscosity profile. The fluid was given a density of 1120 kg/m3. The computational domain consisted of the vat resin and dead zone, modeled as fluid, and the printed, and the printed object, as solid. The domain was discretized using an unstructured, hexahedral cell mesh composed of a Cartesian core mesh. A no-slip boundary condition was prescribed on the dead zone-window interface. At the viaduct inlet of the computational domain, a mass influx profile is applied corresponding to the prescribed flow rate. The steady-state solution of the flow within the iCLIP printer is obtained by solving the conservation of mass and momentum equations on the computational mesh. Meshes were generated with an element size of 0.01 mm. Simulations were either run as static, when validating against injection calibration experiments, or dynamic, when guiding multimaterial prints.

Simulations were validated experimentally by visualizing the spatial distribution of injected resin in the dead zone, during printing, with red resin dye (non-385-nm UV absorbing) mixed into transparent resin by planetary centrifugation and were digitally imaged from underneath the vat through the optically transparent window. After printing, to quantify the distribution of injected resin in the printed part itself, horizontal ˜5-mm cross sections were sliced using a MultiPro Dremel tool and digitally imaged. All image postprocessing and Red-Green-Blue pixel colorimetric quantification and curve fitting were performed in Python using the Python Imaging Library.

### Finite Element Analysis Simulations

Finite element analysis (FEA) simulations of three-point bending and uniaxial compression tests on composite prints were run with the commercially available software package ANSYS Mechanical Explicit (ANSYS Inc., Canonsburg, PA, USA), with fixed boundary conditions to simulate outer sup-ports in three-point bending and a downwards pressure condition simulating the load applied.

### Mechanical Testing

Before testing, prints were postprocessed by washing with 99% isopropanol, wicking away excess resin with Kimwipes, and post-UV curing by irradiating either in an APM LED UV CUBE II oven (APM Technica, Switzerland, 365 nm) or with a handheld Loctite CureJet UV LED controller (Henkel Corp., Dusseldorf, Germany).

Tensile testing of iCLIP-fabricated ASTM D638 type V dog bones, assessed for dimensional accuracy using a micrometer, was conducted using an Instron 5566 (Universal Testing Systems, Stoneham, MA, USA) with a cross-head speed of 1 mm/min at 25° C. to achieve the break at roughly 60 s, which is in accordance to 30 s to 5 min outlined in ASTM D638, with a 100-N load cell. Tensile strength was calculated using the maximum load of the stress/strain curve and Young's modulus using the linear portion of the stress/strain curve.

Mechanical properties tests of composite prints were performed with an MTS Criterion Model 42 Universal Testing machine (MTS Systems Corporation, Eden Praire, MN, USA), equipped with a 100-N load cell and either with fixtures for three-point bending or platens for uniaxial and transverse compression. For uniaxial cyclic compression tests, the specific energy absorption of the cylindrical specimens (in joules per kilogram) was calculated as the energy dissipated (from the area between the loading and unloading curves in the hysteresis loop) per unit mass. Stiffness (in newtons per millimeter) was measured by subjecting prints to transverse compression at discrete spatial locations in the longitudinal direction and computed as the slope of the load displacement curve. From three-point bending tests, the flexural modulus (E) of the cylindrical beams (in newtons per square millimeter) was then calculated as the slope of the flexural stress-strain curve derived from load displacement data as

$$E = \frac{{L}^{3}}{48 I} \frac{F}{δ} = \frac{{L}^{3}}{12 π {D}^{4}} \frac{F}{δ}$$

where I is the polar moment of inertia for a cylinder under bending, L is the crosshead support distances, D is sample diameter in millimeters, F is load in newtons, and δ is deflection in millimeters.

### Results

Injection into a Dead Zone Alleviates Suction Forces to Accelerate Printing of 3D Geometries

Without high-pressure injection, we recapitulate a traditional CLIP process (FIG. 5A), and suction forces scale with part cross-sectional area, as expected from the aforementioned lubrication theory. Without limiting the volumetric print speeds, significant defects and premature delamination from the platform can result. These mass transport limitations can be visualized experimentally using optical coherence tomography (OCT): Without injection, part lifting is accompanied by high-velocity resin influx from part periphery into the dead zone, due to the correspondingly high suction forces.

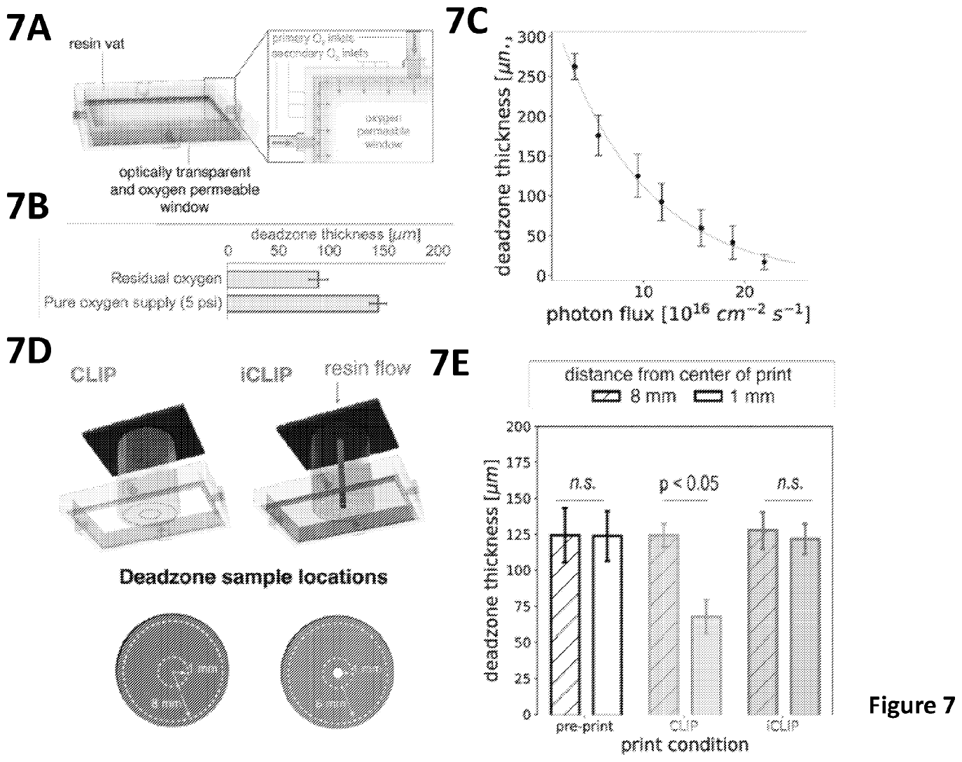

Here, a single viaduct is shown to offset these forces. From the lubrication theory, one can determine that a single viaduct, whose area can be varied dynamically by software during printing, introduces a positive pressure increment by administering resin at a volumetric flow rate Q, according to

$${p}_{viaduct} \sim \frac{μ LQ}{{Ah}^{3}}$$

where μ is the resin viscosity, L is the part length, A is the viaduct area, and h is the dead zone thickness. Dead zone thicknesses in iCLIP are very small, as in traditional CLIP and as expected from analytical models, measured to be on the order of tens of micrometers (FIG. 7). With injection, the lubrication theory predicts the (nondimensionalized) pressure field in the dead zone to be

$$p ( r ) = 6 Q {β}^{2} ln ( \frac{1}{r} ) + 3 ( {r}^{2} - 1 )$$

where p is the pressure, r is the radial position, Q is the administered resin flow rate relative to part draw rate, and β is the viaduct radius increment from injection to offset Stefan adhesion forces is directly proportional to the flow rate administered, along with the relative size of the duct facilitating flow, and decays with distance from the duct. Integrated over the newly cured part surface, we obtain a re-vised (nondimensionalized) Stefan adhesion force

$${F}_{Stefan}^{iCLIP} = {\int }_{r = 0}^{r = 1} {\int }_{θ = 0}^{θ = 2 π} p ( r ) = \frac{π ( {β}^{2} Q - 3 )}{2}$$

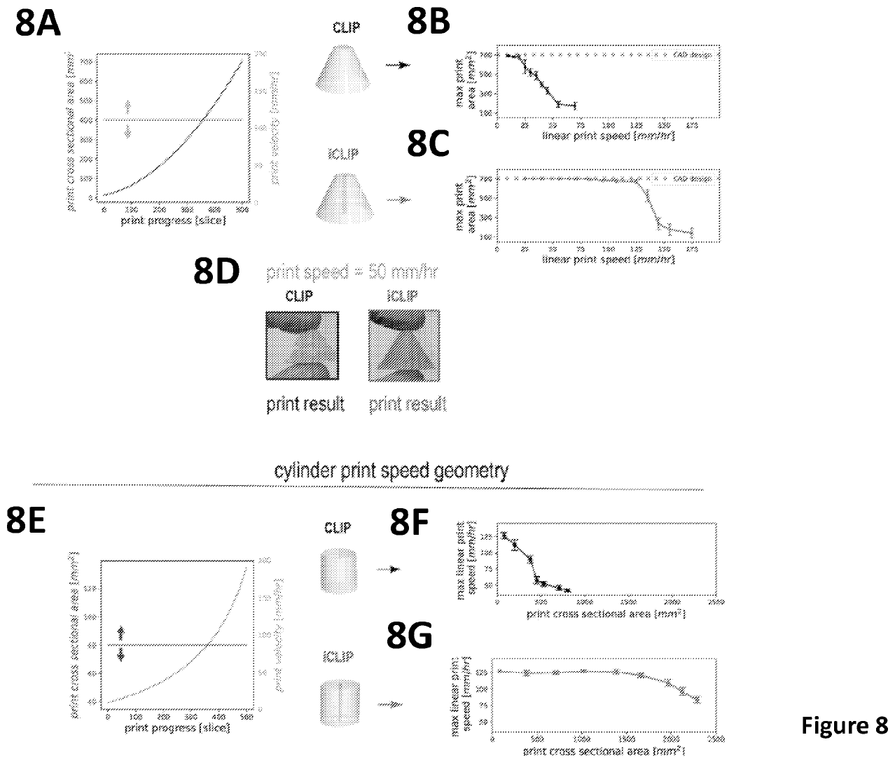

This positive pressure increment allows iCLIP to significantly reduce Stefan adhesion forces—for large area parts by almost two orders of magnitude (FIG. 5B)—and eliminates common defects in CLIP-based printing (FIG. 8). While some scaling of measured Stefan adhesion forces with part cross-sectional area is still observed, this scaling is much less marked than in traditional CLIP. OCT visualizations corroborate the reduction in suction forces: In iCLIP, resin flows gradually through the viaduct to supply part production with constant and tunable flow rates.

These resin injection ducts enable a significant reduction in suction forces that, in turn, allows iCLIP to achieve significant increases in print speed. For both CLIP and iCLIP, maximum printable speeds for a given cross-sectional area can be quantified as the part draw rate at which delamination events occur, at statistically significant levels, for multiple primitive geometries. Injecting resin through a single central viaduct, increases in the maximum achievable print rates observed is determined to be between 5- and 10-fold (FIG. 2, C to F) over CLIP. For a solid conical part with a cross-sectional radius growing from 2 to 20 mm, for instance, the maximum linear print speed with traditional CLIP before delamination occurs is ˜20 mm/hour. With iCLIP, by contrast, maximum print speeds of up to ˜125 mm/hour are achievable. With a single resin injection channel, delamination does still occur at an elevated print speed for a given part cross-sectional area due to the difficulties in administering sufficient resin flow through a single duct, a shortcoming that can be overcome by more complex duct geometries as described in the following section.

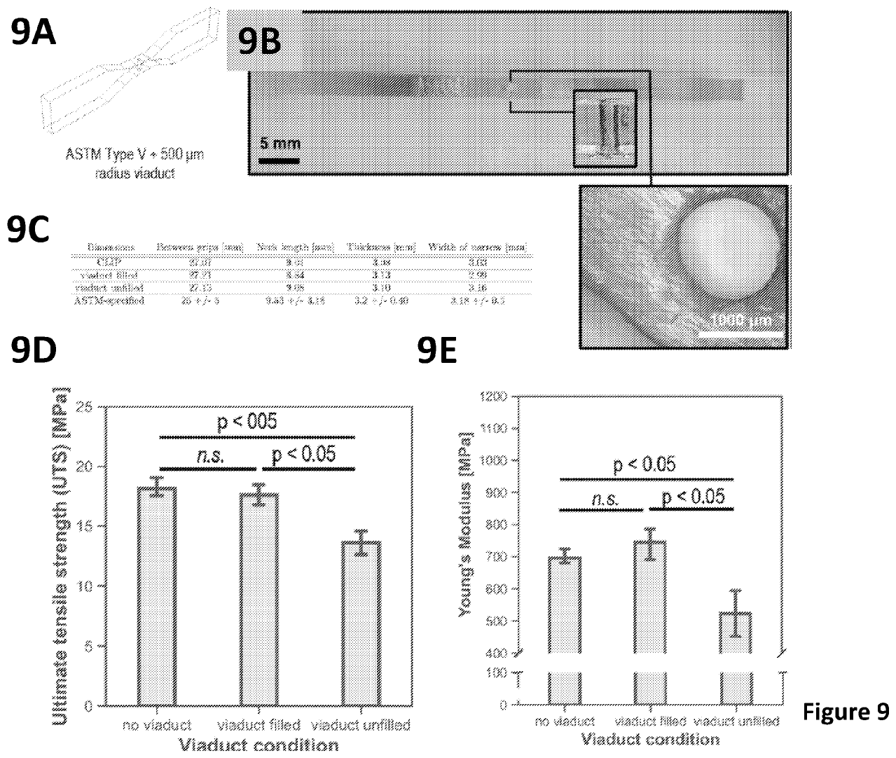

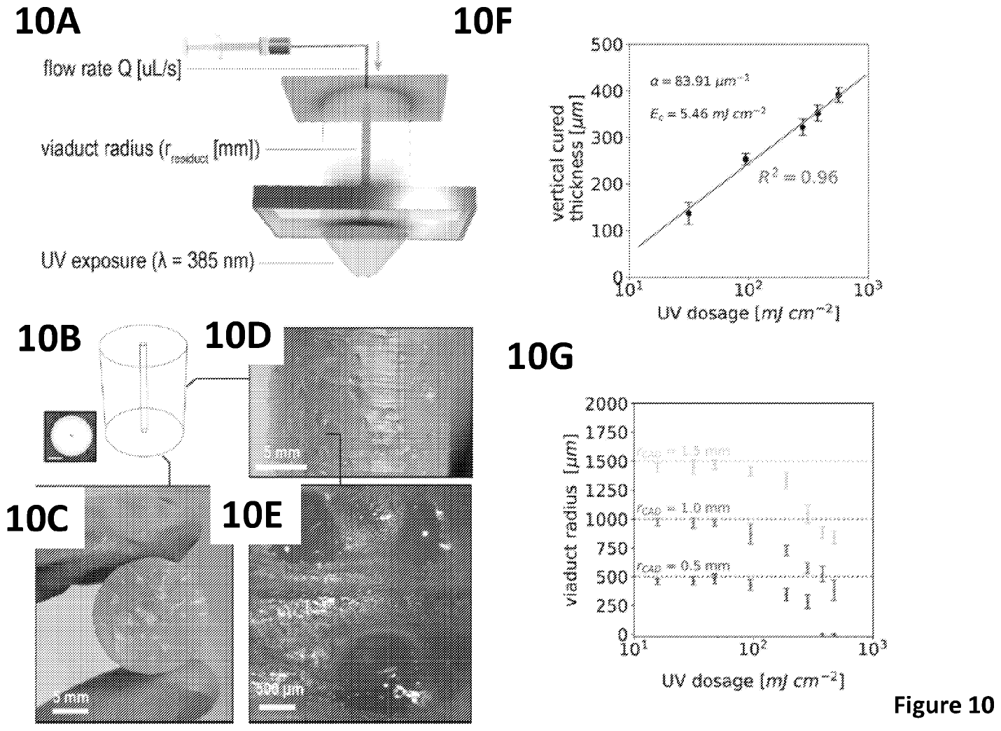

These ducts need not have detrimental impacts on the mechanical properties of the final part with appropriate postprocessing. In this example, viaduct channels were sealed after printing by using a postprinting UV cure to the resin-filled channels. When these standard protocols are followed, no difference in mechanical properties is observed between CLIP and iCLIP printed dog bones, as shown in FIG. 9. The requirement to integrate ducts into a part can affect the resolution of iCLIP in comparison with CLIP traditionally, but with careful design strategies, this can be minimized. In areas of the part where ducts must be included, feature resolution does drop to the minimum achievable channel diameter before concerns arise such as capillary collapse, if the channel is freestanding, or channel cure through, if the channel is embedded (FIG. 10). Moreover, viaduct channels can be designed to have larger radii than this achievable minimum, because of the challenges associated with enforcing viscous flow through a narrow channel, according to the Hagan-Poiseuille equation

$$Δ P = \frac{8 μ LQ}{π {R}^{4}}$$

where P is the pressure, μ is the dynamic viscosity, L is the channel length, Q is the flow rate, and R is the channel radius. Flow rates typically range, in this study's experiments, from 7 to 27 μL/s.

While these channels can therefore be detrimental to iCLIP resolution in some circumstances, note that ducts need not be engineered into all regions of an iCLIP part. Here, the native feature resolution of a traditional CLIP process generalizes to this new printing platform, along with the same trade-off between print speed and feature resolution. Given that the smallest features are those that experience the smallest Stefan adhesion forces, which thus do not likely require active injection to offset, these high-resolution features can be preserved in iCLIP parts. Moreover, because of the software-guided nature of the integration of ducts into iCLIP parts, ducts can be designed to avoid such high-resolution features.

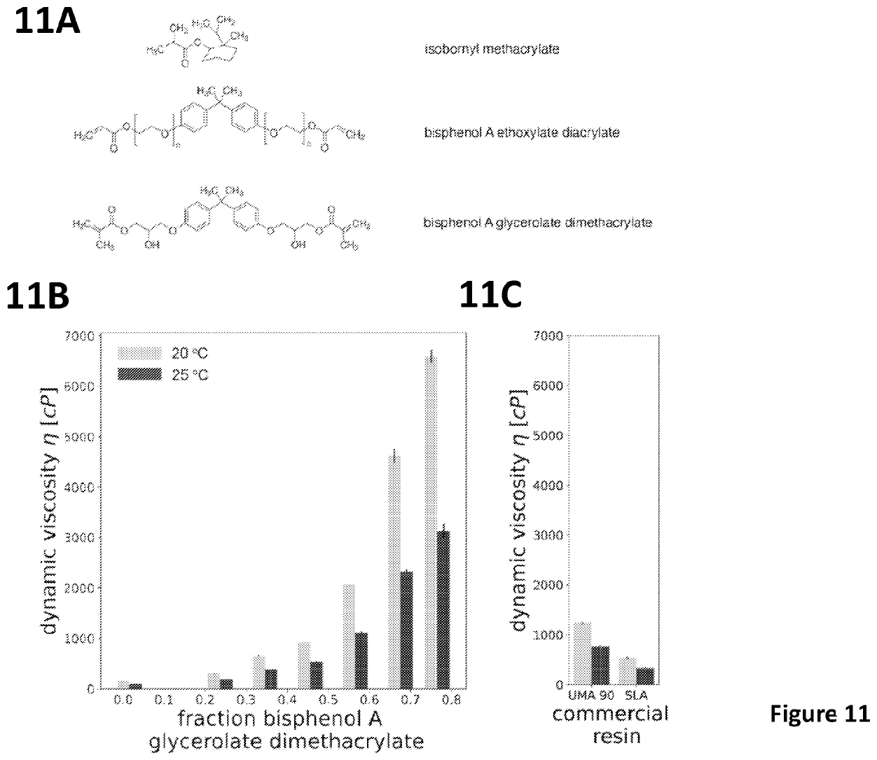

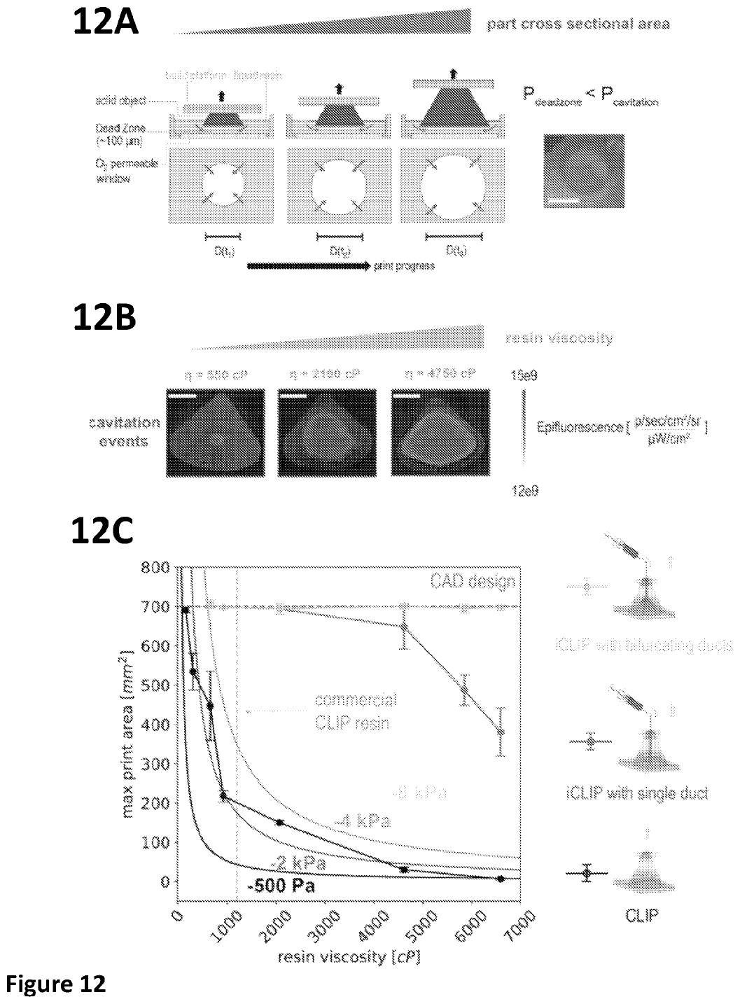

A second limitation on traditional CLIP is the “material bottleneck,” i.e., filled resins, attractive for their superior mechanical, electrical, and other properties, which are too viscous to flow passively through the thin dead zone. To quantify these limitations, print studies were conducted by traditional CLIP with resins of viscosities ranging from 100 to 7000 cP (FIG. 11). If the negative hydrostatic dead zone pressure exceeds cavitation pressure, then dissolved gases nucleate a bubble during printing, manifested as voids in the part (FIGS. 12A and 12B). These bubbles nucleate at the part's center, where the negative pressure is predicted to be highest in magnitude. From basic nucleation theory, the negative pressure threshold below which cavitation occurs decreases in magnitude with the temperature of the system T, the time elapsed τ, and the saturated vapor pressure of the liquid Pₛₐₜ.

$${P}_{cavitation} ∝ {P}_{sat} - {C ( T ln τ )}^{- \frac{1}{2}}$$

where C is a constant. Quantitatively, we observe that this critical cavitation pressure is smaller for more viscous resins, scaling with a predicted minimum negative dead zone pressure of roughly −2 kPa (FIG. 12C). Commercial printers can alleviate this problem somewhat by slowing down printing to allow time for resin reflow, by preheating resin in the vat to decrease viscosity, or by performing so-called “pumped” stage motions to encourage reflow, but these do not fundamentally address the mass transport limitations. Combined with the speed limitations described above, a clear and unavoidable trade-off exists between resin viscosity η and printable part radius rₚ in CLIP, according to

$$Speed ∝ \frac{1}{η {r}_{p}^{2}}$$

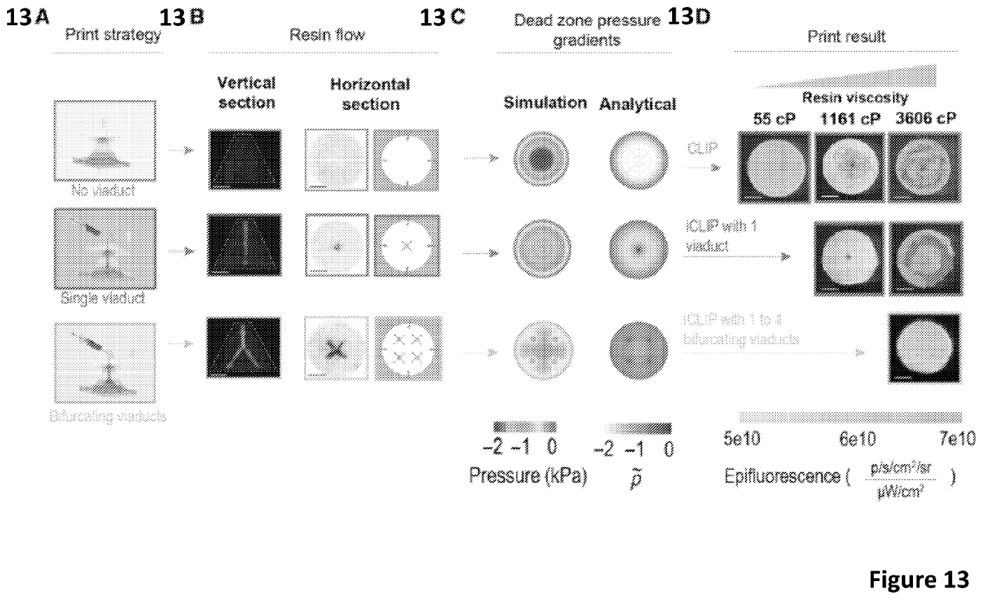

iCLIP circumvents this trade-off by mechanically injecting viscous resin to offset the otherwise negative dead zone pressure, rendering otherwise unprocessable resins printable at higher cross-sectional areas (FIGS. 13A-13D). A single viaduct becomes insufficient for extremely high-viscosity resins, as driving viscous flow through a single ˜500 μm-radius viaduct causes pump stalling; cavitation recurs between the viaduct source and periphery, which both computational fluid dynamics (CFD) simulations and analytical lubrication theory predict is the region of greatest (magnitude) negative pressure. However, to stay above this critical cavitation pressure, multiple ducts can be engineered into the part, each facilitating positive pressure resin flow into the lubrication theory thin gap. As a result, distributing resin through four bifurcating viaducts once again ameliorates cavitation.

While raising the upper limit on printable resin viscosities in comparison with traditional CLIP, iCLIP is still limited by the high force required to drive viscous flow through a narrow channel, which scales inversely with the fourth power of channel radius at a fixed flow rate according to the aforementioned Hagan-Poiseuille equation. Even with bifurcating duct arrangements, enforcing flow through narrow microfluidic ducts with resins of viscosities above ˜6700 cP became prohibitive, leading to hardware-related pump stalling and subsequent print failure. Still, these viscosities are roughly an order of magnitude higher than those printable by high-throughput traditional CLIP at the same print speeds and part areas. In this manner, iCLIP strikes a balance between high-throughput and high-viscosity 3D printing.

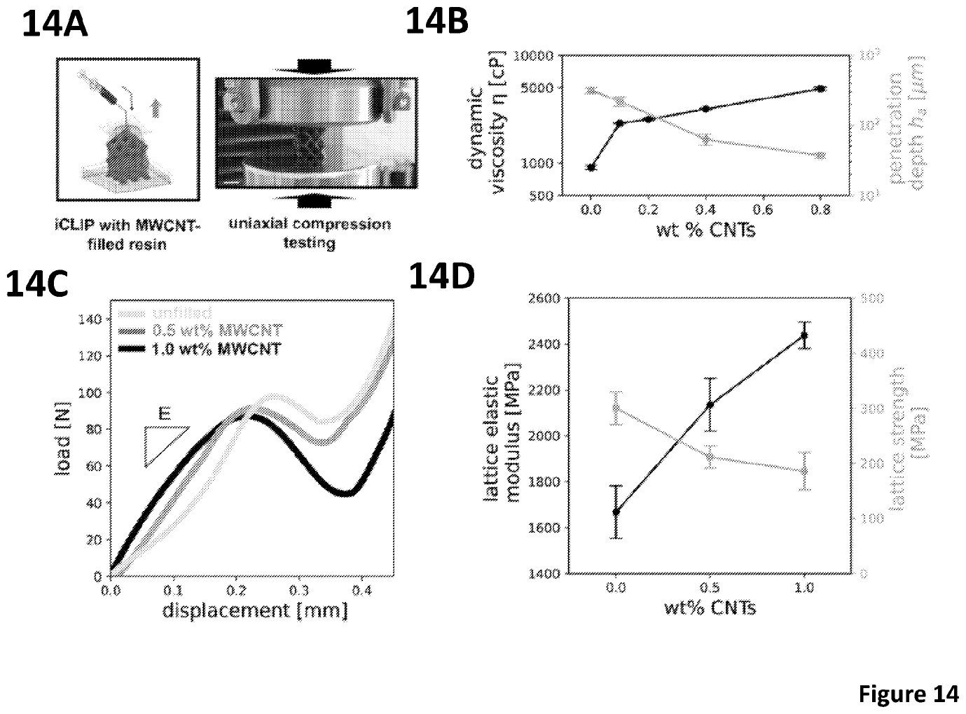

As a result, resins with highly attractive material properties that are too viscous for CLIP are thus accessible to iCLIP, at high volumetric throughputs. Multiwalled carbon nanotubes (MWCNTs), for instance, are extremely attractive additives for their electrical, thermal, and mechanical properties, with applications in, e.g., strain sensors, wearable electronics, and structural health monitoring. iCLIP can readily process such a filled resin, forming a body-centered cubic lattice with MWCNT-filled resin flowed through lattice struts at percolation threshold-exceeding concentrations without cavitation; this renders the lattices stiffer but more brittle (FIG. 14). Resins with up to 1.0 weight % of CNTs were found printable by iCLIP before two factors interfered with reliable printing: the aforementioned challenges associated with driving viscous flow through narrow ducts, along with the decrease in resin penetration depth due to the UV-absorbing properties of CNTs.

Printing with multiple materials simultaneously is key to achieve broad adoption of UV resin-based AM approaches, with potential applications in tunable energy absorption in highly personalized human protection, wearable electronics, and functionally graded materials. Although, with existing VP approaches, multimateriality is only possible using cumbersome vat-switching methods, which seriously limits printing speed.

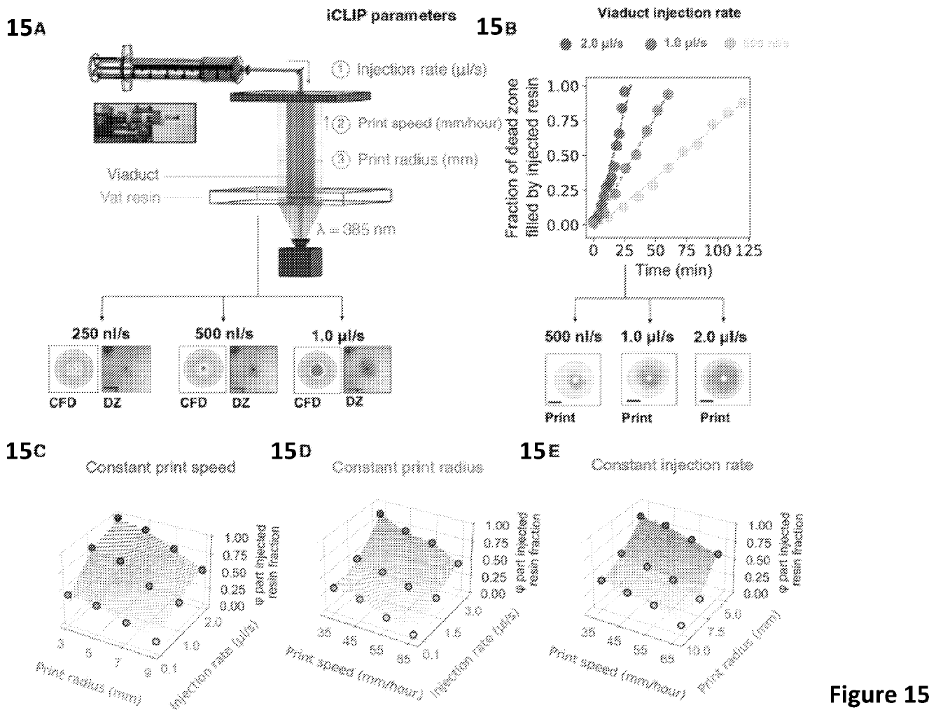

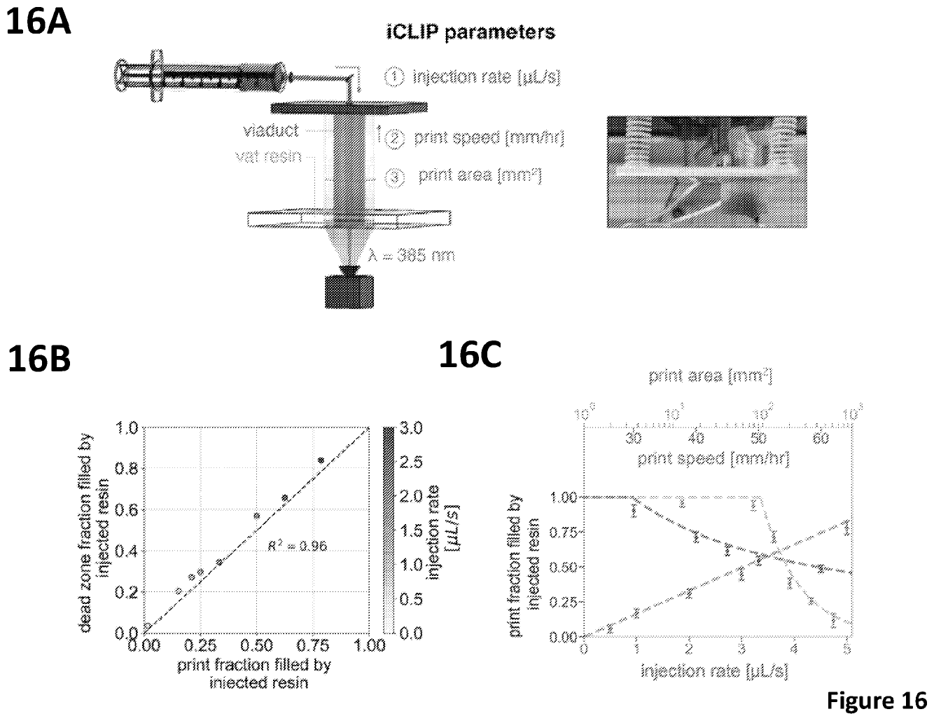

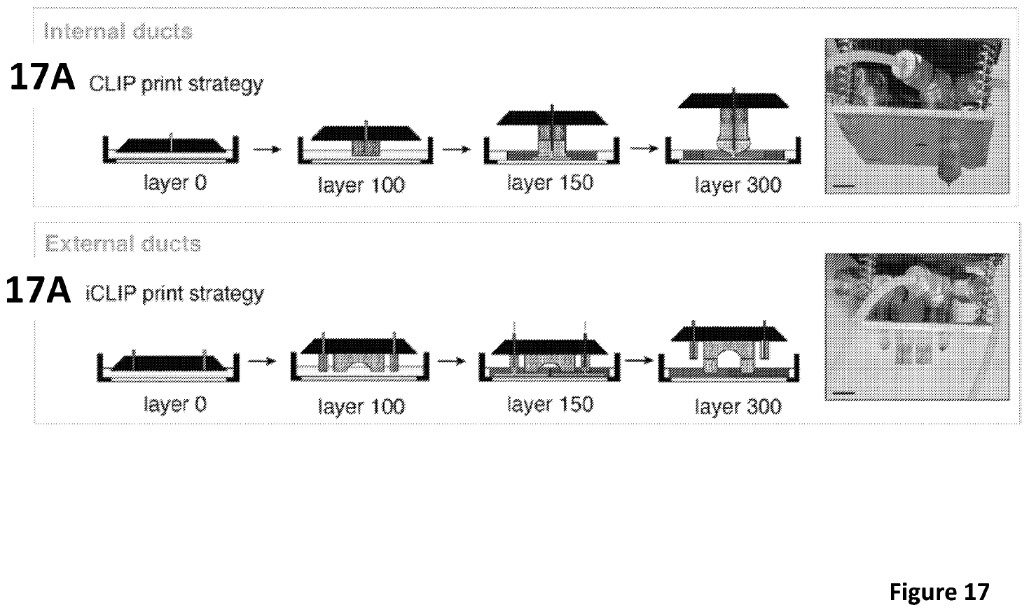

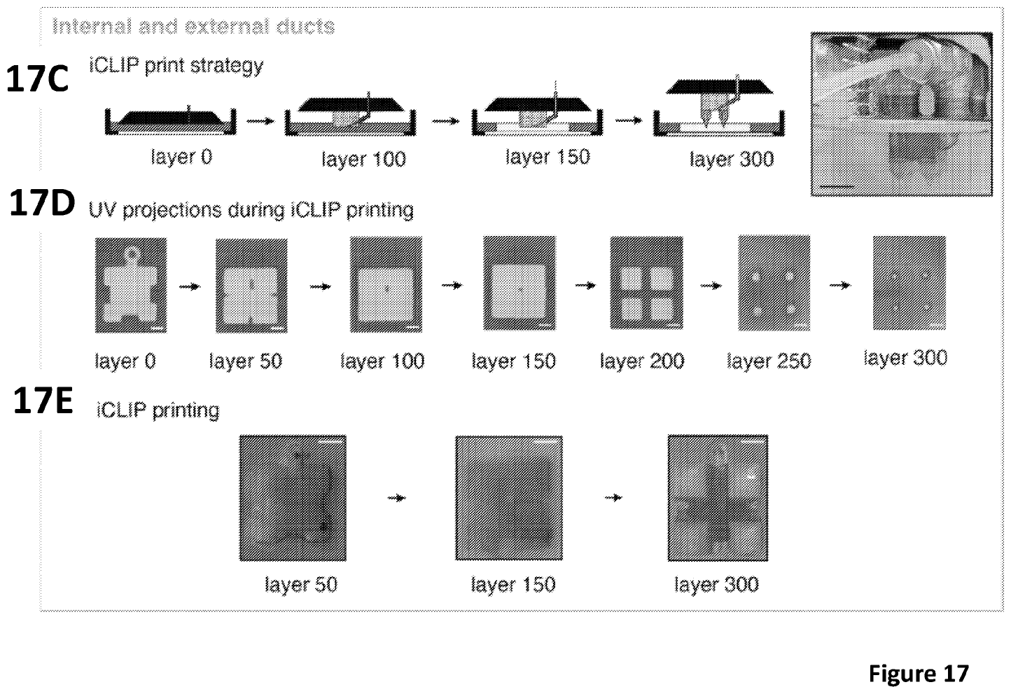

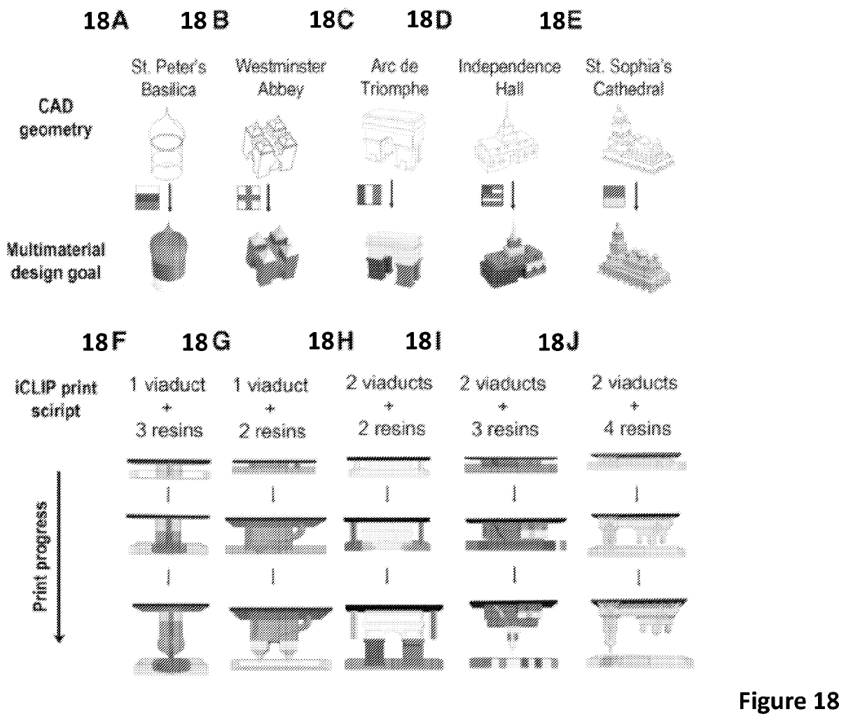

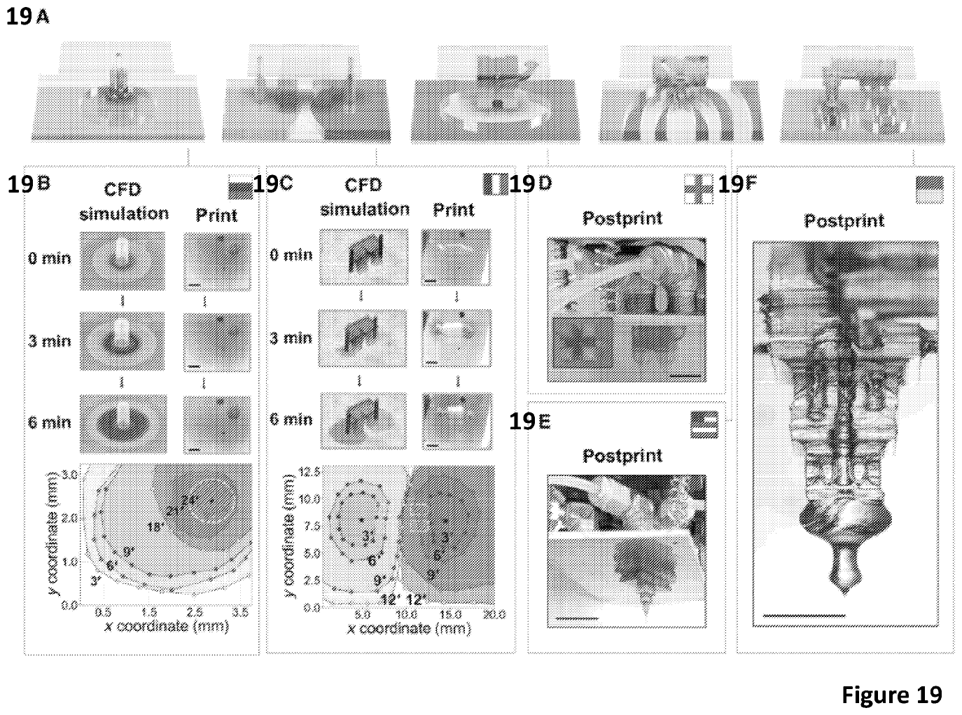

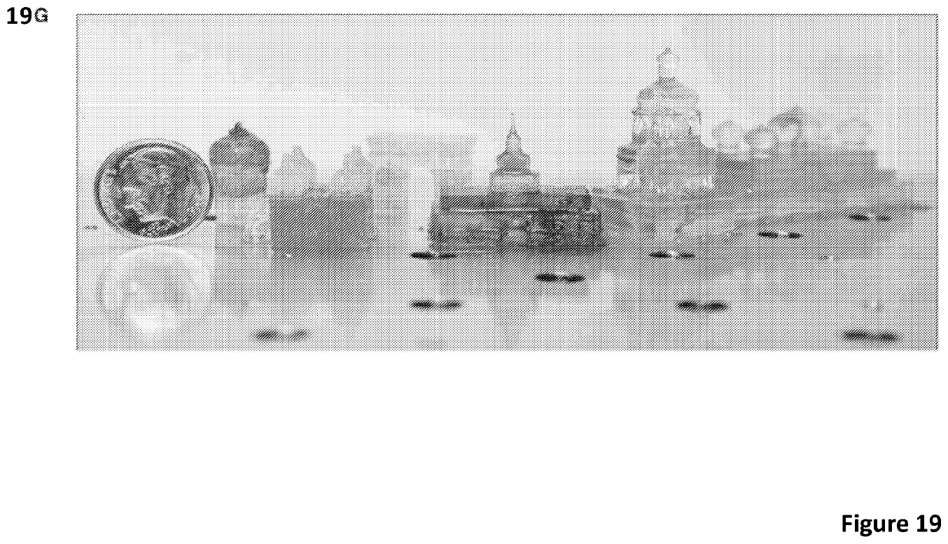

iCLIP as described hereinabove, by mechanically injecting different resins through viaduct(s), can create multimaterial composite architectures in all three Cartesian dimensions. A custom CFD simulation-guided and microfluidics-enabled multimaterial control methodology was implemented and is described. In a multimaterial iCLIP-printed part, resin may either be supplied by the vat or through injection. Salient parameters for setting this ratio, and thus tuning multimaterial iCLIP printing, include injection rate, print speed, and print area (FIG. 15A). Increasing injection rates lead to a linearly increasing fraction of injected-to-vat resin in the final part (FIG. 15B), which correlates with higher fractions of the dead zone filled by injected resin (FIG. 16). Varying two parameters at a time yielded calibration curves to guide multimaterial iCLIP printing (FIGS. 15C-15E). Resin flow can be administered either through ducts fully internal to the part, fully external to the part, or a combination thereof (FIG. 17). To demonstrate the feasibility of such a simulation-driven control strategy for more complex designs, injection profiles were designed for five increasingly intricate architectural models, optimizing viaducts and resin flow rates to imprint on each of their country-of-origin flags (FIG. 18). These print scripts were validated experimentally. Observed injection flow boundaries during printing corresponded with simulation predictions (FIGS. 19A-19C), and the resulting models displayed the desired gradients (FIGS. 19D-19G).

Multimaterial iCLIP takes advantage of a continuous liquid interface to achieve high volumetric throughput; specifically, the multimaterial architectures were printed at part draw rates ranging from 50 to 80 mm/hour. Moreover, compared with other multimaterial VP methods that require frequent vat switching by rotating carousels, iCLIP minimizes additional hardware accessories required by printing heterogeneous objects in a software-driven manner, engineering ducts into the part in a distinct manner for every print. By administering tunable flow profiles in spatiotemporally controlled fashion, iCLIP also eliminates the need for extensive pauses in printing, as are required by approaches that actively switch out resin every time a material gradient is desired.

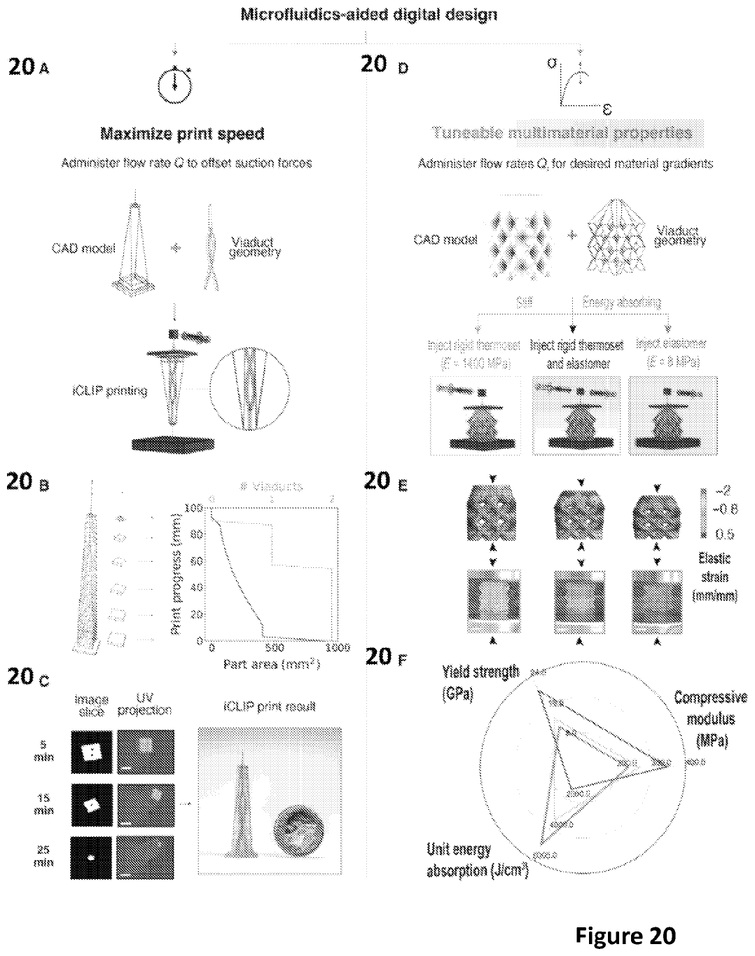

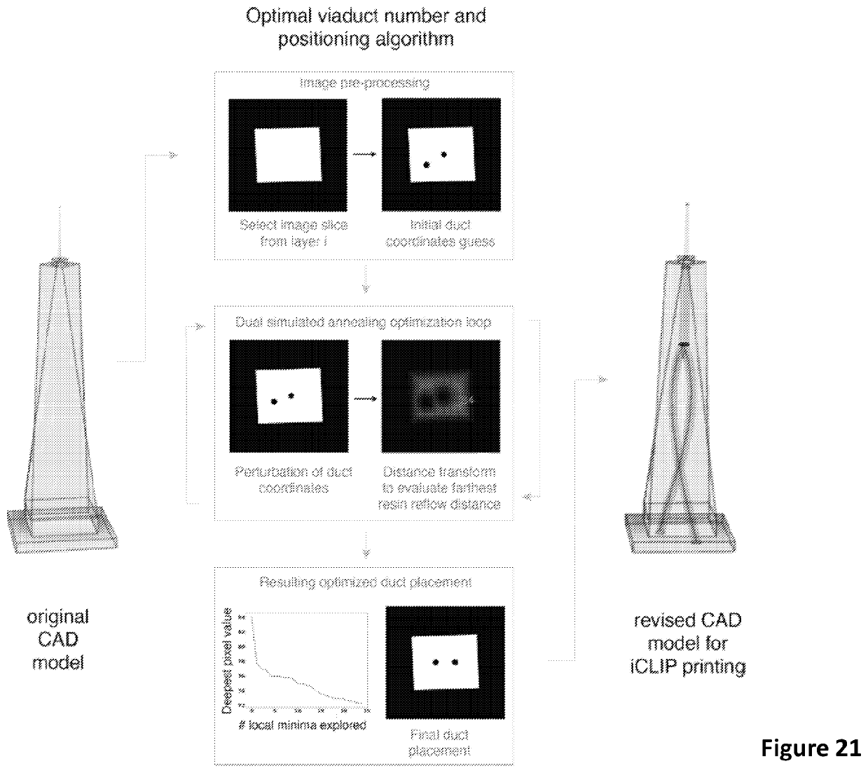

The dual print speed and multimaterial goals outlined above in some instances use different iCLIP injection profiles, necessitating a new 3D printing design methodology we term microfluidics-aided digital design. To optimize speed, viaducts are digitally designed using a software that implements a dual simulated annealing algorithm and B-spline interpolations to minimize the resin flow distance for a given part cross-sectional area (FIGS. 20A-20C). More details of our mass transport optimization algorithm can be found in FIG. 21. If tunable multimaterial architectures are desired instead (FIG. 20D), e.g., to modulate a lattice's energy absorption and/or modulus (FIG. 20E), then viaducts are integrated to alternately transport stiff and elastic resins throughout all lattice struts, thus maximizing control over material distributions. As predicted by finite element analysis (FEA) simulation and confirmed by mechanical testing, increasing injected elastomer volume fractions produced more compliant lattices (FIG. 20F).

Summarizing this example, iCLIP as described herein is a novel 3D printing method using active control of mass transport during continuous liquid interface printing to synergistically enhance print speeds, enable printing of high-viscosity resins, and allow rapid printing of multiple different resins simultaneously at varying scales and with tunable mechanical properties. Ongoing work in optimizing the existing iCLIP process focuses on detailed modeling of the flow boundaries in the dead zone to more finely tune multimaterial gradients, optimizing flow rates to minimize Stefan adhesion forces and cavitation and automating the generation of viaduct geometries and injection profiles to accelerate multimaterial iCLIP printing. Future work in extending iCLIP to new materials and geometries will focus on testing a broader range of viscous-filled resins with superior mechanical and electrical properties for applications in smart and sensor-embedded product designs, along with developing predictive models for analyzing the mechanical properties of multimaterial iCLIP structures for applications in 4D printing and soft robotics, among other areas.

Derivation of Pressure and Velocity Fields with and without Viaduct Flow

To predict the pressure gradients and velocity flow fields in CLIP traditionally, and with injection in iCLIP, because the dead zone gap is in this case very small compared to the part radius, we can use the lubrication equation for nondimensionalized pressure, expressed in polar coordinates:

$$\tilde{p} = \frac{12}{} ( \tilde{r} , θ )$$

where \tilde{r} is radial distance, θ angle, and [symbol] the vertical velocity field, and \tilde{h} dead zone thickness. This is non-dimensionalized with the characteristic part radii, dead zone thicknesses, pressures, and print velocities:

$$\tilde{r} = \frac{r}{R} \\ \tilde{h} = \frac{h}{b} \\ \tilde{p} = \frac{p}{\frac{μ {UR}^{2}}{{b}^{3}}} \\ \tilde{u} = \frac{{u}_{z}}{U}$$

where U is part draw rate, R part radius, μ resin viscosity, and b dead zone thickness. Assuming dead zone thickness is constant, i.e.

\tilde{h}=1

then:

[symbol]

\tilde{p}=12 [symbol] (\tilde{r},θ)

If we assume a constant dead zone thickness, reducing \tilde{h} to 1, this results in a negative pressure [symbol] in the dead zone without injection due to upwards part drawing:

$${\tilde{p}}^{( 1 )} = 3 ( {\tilde{r}}^{2} - 1 )$$

Integrated over the part's cross-sectional area, this yields the familiar Stefan force, which nondimensionalized is:

$${\tilde{F}}_{Stefan} = \frac{- 3 π}{2}$$

The negative quantity indicates the force is acting downwards, “pulling” against the adhesion of the part to the platform. Expressed in dimensional form, this is:

$${F}_{Stefan} = \frac{- 3 πμ {R}^{4}}{2 {b}^{3}}$$

The radial velocity field can then be simply derived as, without viaduct flow:

$${u}_{r} = - 6 \tilde{r} z ( 1 - z )$$

where z is the vertical distance above the window in the dead zone. Using the lubrication theory equation for pressure to determine the pressure increment from viaduct flow, where Q is defined as the flow velocity out of the viaduct relative to the part draw rate U, the pressure increment due to viaduct injection is:

$$\tilde{p} = - \frac{12 Q}{}$$

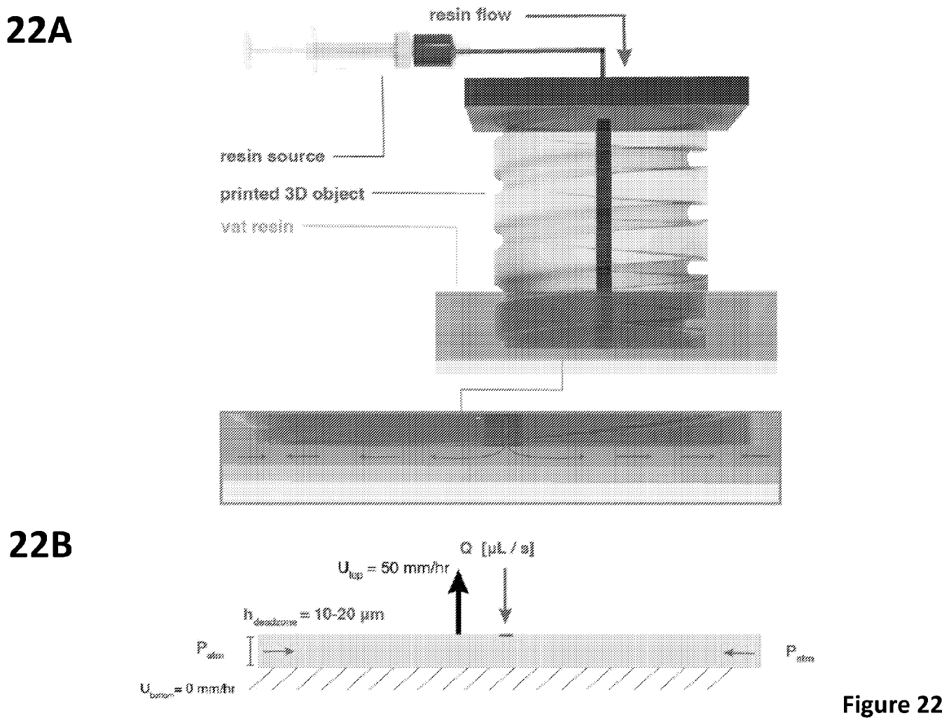

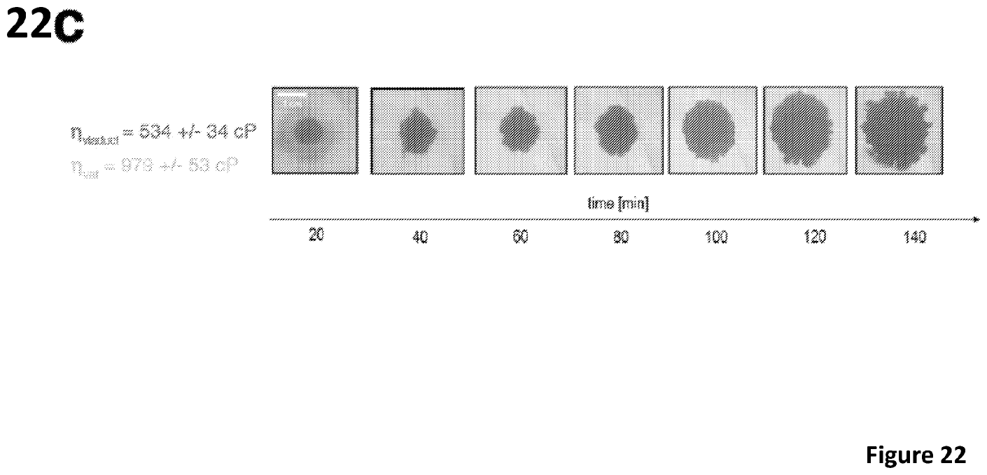

Evidence that this physical model, also known as a lifting plate Hele-Shaw gap, indeed accurately describes the iCLIP process comes from observations of viscous fingering during iCLIP printing, as viewed from beneath the optically transparent window by a digital imaging camera. In particular, instabilities in the flow boundary between a lower viscosity resin, injected through a central viaduct into the dead zone, and a higher viscosity resin, already present in the vat, are readily observed (FIG. 22).

Within the viaduct, i.e., for \tilde{r}≤β, this results in a combined pressure of:

$$\tilde{p} = + = 3 ( - 1 ) + 3 Q ( {β}^{2} - \tilde{{r}^{2}} ) + 6 Q {β}^{2} ln ( \frac{1}{β} )$$

And for \tilde{r}>β:

$$\tilde{p} = 3 ( - 1 ) + 6 Q {β}^{2} ln ( \frac{1}{\tilde{r}} )$$

which is clearly continuous at \tilde{r}=β and well-defined everywhere. Integrating over the surface of the cured part, i.e., outside the viaduct at \tilde{r}>β, this yields a revised (again nondimensionalized) Stefan force:

$${F}_{Stefan} = 3 π Q {β}^{2} - \frac{3 π}{2}$$

For the revised velocity fields with viaduct flow, specifically within the viaduct i.e., \tilde{r}≤β, we derive:

$${u}_{r} = ( - 6 \tilde{r} - 3 Q ( 2 \tilde{r} ) ) z ( 1 - z )$$

And outside the viaduct, i.e., \tilde{r}>β:

$${u}_{r} = ( - 6 \tilde{r} + 6 Q {β}^{2} ( ) ) z ( 1 - z )$$

### Determination Print Failure Mode Experiments

The limitations on CLIP and iCLIP print speeds were quantified by printing one of two test geometries, a cylinder or spherically symmetrical cone, according to the print scripts in FIGS. 8A and 8E, respectively. Prior to each print, resin in the vat was stirred to ensure homogeneity and filled to the same height in the vat. Only one part was printed per experimental trial so that resin flow from adjacent parts would not interfere with the fluid dynamics governing flow for one part. Overall print speed was varied by systematically changing the time between UV exposures (“delay time”), and correspondingly the stage velocity. All other parameters (e.g., UV light intensities, resin formulations, exposure times, printer hardware) were held constant, to isolate injection as the sole difference between traditional CLIP and iCLIP trials. The geometrical versatility of the software-driven resin delivery approach provided for iCLIP prints which could be conducted with a wide range of viaduct cross sectional areas, from 5 to 50% of part area, which could be dynamically tuned between, or over the course of, single prints. Trials for iCLIP and CLIP were performed in alternated fashion, to further control for any extraneous external factors (e.g., changing resin temperature, oxygenation conditions, etc.). Then, to quantify print failures in print speed experiments, the cross-sectional area at which delamination occurred was measured with a stainless-steel digital Vernier caliper, with an accuracy of 10 μm. The maximum printing speed for a given cross sectional area was quantified as the overall speed at which average print height dropped below the design print height at statistically significant levels (p<0.05), using a two-way ANOVA test of statistical significance.

Optical Coherence Tomography Imaging of Mass Transport in CLIP and iCLIP

The suction forces limiting the traditional CLIP process can be visualized using optical coherence tomography. In CLIP, the continued mobility of particles even after UV exposure provides evidence of a dead zone near the window interface. From a Lagrangian fluid dynamics perspective, which treats an observed area of near-IR scatter as a surrogate marker for resin particles, fluid accelerates in the dead zone from near quiescence to velocities approaching ˜10³ μm/s during part lifting. At volumetric injection rates of 1 μL/s and 10 μL/s, fluid velocities of ˜10² μm/s and between 10³ and 10⁴ μm/s are observed, respectively. From recordings of flow through the dead zone in traditional CLIP, the large magnitude pressure gradients are reflected in the very high fluid particle accelerations observed. Notably, particle motion into the dead zone is only observed simultaneous with platform lifting, i.e., due to suction forces. In contrast, while injecting resin at a constant rate during printing, continuous flow in the opposite direction of part movement can be observed. As shown in the video, such flow rates can be tuned to be either lower or higher than part production. In either case, the absence of dramatic fluid particle accelerations, i.e., the decoupling of part lifting with mass transport, provides visual evidence for the lower suction forces quantified in FIG. 5. Here, the absence of high fluid particle accelerations provides visual evidence of the alleviation of suction forces, demonstrating how increasing flow rates can offset increasing suction forces.

### Cavitation Print Failure Mode Experiments

For quantifying the resin viscosity limitations of the traditional CLIP process, viscosity was varied by changing the percentage of high viscosity bisphenol A glycerolate methacrylate vs. low viscosity bisphenol ethoxylate diacrylate in the formulation (FIG. 11A). The viscosity range of these custom resins was comprehensive (FIG. 11B), with the minimum below and the maximum exceeding those of commercial CLIP and SLA resins (FIG. 11C). When printing with these resins, the cross-sectional area at which cavitation occurred during printing was then captured by imaging the print from underneath the vat (FIG. 12). To visualize cavitation print failure results, fluorescent resin dye (Alumilite, Galesburg, MI, USA) was pipetted into the cavitation region after printing and imaged using an In Vivo Imaging System (IVIS) 100 Series, with a Cy5.5 excitation filter of 430 nm and ICG emission filter 500 nm (PerkinElmer, Waltham MA, USA). In all fluorescence images to visualize the cavitation process, excitation and emission filters, and maximum captured epi-fluorescence (radiant efficiency), and fluorescent dye concentration, were kept constant.

The cavitation failures observed with these resins due to the evaporation of dissolved gases in viscous resins have been noted by others, specifically those performing continuous printing with a liquid window noting that for large cross-sectional areas, such large negative pressure gradients in fact lift the liquid window material into the part, causing cavities. While ours is a solid, stiff window, we observe similar cavitation failures in parts, as shown in FIG. 12.

Mathematically, the magnitude of this negative pressure threshold required to drop below for cavitation to occur increases with the surface tension of the liquid r, and decreases with the temperature of the system T and saturated vapor pressure of the liquid Psat, according to

$${P}_{cav} = {P}_{sat} - {C ( T {ln}_{T} )}^{- 1 / 2}$$

where C is a constant.

Cavitation failures are not a limitation of only CLIP, but also of all light-based resin printing; in traditional SLA, the lift mechanism can, if the part's cross-sectional area is large enough, leave an empty area in the vat. Strategies do exist to alleviate this in traditional SLA, e.g. with wipers. In the CLIP process, the lift mechanism is eliminated, but time is still required to allow resin to reflow through the dead zone, which can be even longer due to its thin height and the unfeasibility of any wiping mechanism. Commercial printers attempt to alleviate this problem by heating the resin vat to accelerate reflow, or utilizing “pumping” mechanisms whereby the stage motion can facilitate reflow, but this does not accelerate resin reflow dramatically, as mechanical injection in iCLIP can.

Negligible Impact of Post-Cured Viaduct on iCLIP Printed Part Mechanical Properties

If left uncured, a part generated by iCLIP having hollow viaducts can in some instances diminish the mechanical properties of printed parts. To ameliorate this issue, parts were rendered fully solid by post UV curing resin left in the viaducts. To demonstrate equivalent mechanical properties to traditional CLIP printed parts, ASTM D638 Type V dogbones were prepared both via traditional and iCLIP (FIG. 9A), thereafter washing with isopropyl alcohol and post UV curing the resin-filled viaducts in a APM LED UV CUBE II (APM Technica, 365 nm) for 2 minutes. As a negative control, the resin was pipetted out from the viaducts of a second group of iCLIP printed dogbones, leaving behind a hollow channel (FIG. 9B). All samples were dimensionally accurate, satisfying ASTM specifications (FIG. 9C). Then, tensile tests were performed on these specimens. While a statistically significant decrease in ultimate tensile strength (UTS) and Young's modulus was observed for viaduct-uncured dogbones, no such difference was observed when the viaduct was post-cured (FIG. 9D). This demonstrates that with proper post-processing, iCLIP viaducts that are embedded within the part itself need not affect part mechanical properties.

Optimization of Viaduct Geometry During iCLIP

In some instances, to achieve flow through viaducts to the dead zone, two defects in viaduct geometry are common and must be avoided: lateral cure through due to too high UV intensity, and unvented cavities due to insufficient resin flow, as explained below.

The problem of vertical cure through is well-studied in the 3D printing literature, but for iCLIP, lateral cure through is in some embodiments also a concern (FIG. 10). Namely, the integrity of the viaduct is crucial to maintain during iCLIP; if obstructed by lateral cure through due to light piping or “funneling”, whereby an optically transparent material (such as an acrylate) directs light through a low refractive index material, then injected resin exacerbates, rather than alleviates, the aforementioned suction forces pulling down on the part, and also causes random macroscopic channels and voids in the part from uncontrolled fluid flow escape (FIGS. 10C-10E). Preventing this is possible, however, by calibrating the projected UV light intensity to the desired software designed viaduct size (FIG. 10F). To demonstrate, parts were printed to the equivalent of 100 layers, washed with isopropanol, and then channels measured with an Olympus-BX53 optical microscope (with UIS2 optical system, infinity-corrected, and Abbe condenser), under 4× objective. With such calibration, viaduct radii of 500 μm are readily achievable in UV intensity ranges sufficient for printing (FIG. 10G).

Conversely, viaduct diameter may expand uncontrollably without sufficient injected resin flow. The physical reason is the well-known design limitation of unvented cavities in resin printing, which prohibits geometries with voids lacking ventilation. While some have creatively exploited the physics of unvented cavities in CLIP to draw uncured resin into voids in the part and make thermoset-elastomer composite structures, we find that when no resin is injected into a central viaduct, the print “bursts” from the low pressure build-up in such unvented cavities.

Optimization of Viaduct Position and Flow Rates During iCLIP

Determining the optimal position of and flow rate through viaducts during iCLIP is key to achieving its technical improvements over the traditional CLIP process. In addition to allowing higher print speeds by alleviating suction forces, as shown in FIG. 5, and alleviating cavitation, as shown in FIG. 13, we also find that injection may help to prevent dead zone thicknesses from shrinking towards the center of the part where fresh resin from the periphery struggles to reflow FIGS. 7D-7E, as others have observed.

The process for finding the optimal viaduct placement for an image slice for a given layer, as shown in FIG. 21, is as follows. The image slice and initial guess for viaduct placement coordinates is fed into a dual simulated annealing optimization loop which outputs optimized viaduct placement coordinates. The optimal viaduct number and placement is determined by quantifying the distance from the part edge to the deepest pixel, for increments during the print. The output is, for each image slice in the geometry, a sequence of optimal resin source positions that can be interpolated smoothly with B splines in standard CAD software to reconstruct a revised CAD geometry with viaducts for resin flow.

The calibration of injection rates through viaducts differs based upon the goal of iCLIP: if multimaterial printing is desired, the flow boundaries must be monitored according to FIG. 15, along with FIGS. 16-17. If seeking to alleviate suction forces and negative hydrostatic pressures in the dead zone gap causing either cavitation or delamination failure, instead, an injection rate that completely satisfies part production can be administered, for a simple cylinder, according to:

Q=Uπr²

where Q is flow rate, U is continuous print speed, and r is part cross-sectional radius. Flow rates typically range, in this study's experiments, from 7 μL to 27 μL.

Theoretically, a single viaduct facilitating pressure driven resin flow could offset Stefan adhesion forces and/or the negative dead zone pressure over any arbitrary area or viscosity by correspondingly increasing flow rate. However, when resin viscosity η and/or print cross-sectional radius r grow high enough, it becomes unfeasible to infuse this volumetric flow rate through one 500 μm radius viaduct port, which produces too high a backpressure for the syringe pump to overcome, causing pump stalling. Quantitatively, the force required to pump an incompressible, Newtonian fluid of arbitrary viscosity experiencing laminar flow with low Reynolds number through a pipe, which accurately describes resin flow through a viaduct, scales according to the Hagan Poiseuille law with η/r⁴ where η is resin viscosity and r is the viaduct radius. According to CFD simulations, creating a net zero pressure across the cross-sectional area of the part with high viscosity resins necessitates a very high positive pressure at the viaduct port, causing pump stalling. For a resin of viscosity 3600 cPs, for instance, this was empirically determined to be a part radius of 14.6 mm.

As such, it becomes more practical to distribute resin flow through several viaducts, which bifurcate through the z axis, to offset the negative pressure in the dead zone with a more uniform hydrostatic pressure distribution across the part's cross-sectional area, as shown in FIG. 13.

Control Methodology for Multi-Material iCLIP Printing

A flow matrix system can then be used to dynamically toggle the resin injected through a particular viaduct during printing to produce the gradients modelled in FIG. 18. For St. Basil's Cathedral, a single viaduct conduits three different resins to the dead zone to produce z axis gradients in a single print, i.e., the Russian tricolor. For the Arc de Triomphe, two viaducts transport red and blue resins, along with existing white vat resin, to produce the French tricolor. For Westminster Abbey, resin is flowed first in a viaduct external to the object and then merged into the part's interior, to produce the cross of St. George viewed from below. And for Independence Hall and St. Sophia's Cathedral, resin is flowed through multiple viaducts internal to the object to obtain gradients in both the horizontal and vertical directions, to produce the American and Ukrainian flags, respectively. By guiding the flow boundaries according to the CFD simulation predictions for iCLIP shown in e.g. FIG. 15, the multi-material prints shown in FIG. 20 are achieved.

If minimal part disruption is desired during such multi-material iCLIP printing, the viaduct need not be fully internal to the part. For this approach, a support viaduct begins external to the part, thereafter becoming internalized (FIG. 17C). An added benefit is that, like the flying buttresses that provide structural strength to the walls of Westminster Abbey, external viaducts act as pseudosupport structures during the print. During iCLIP printing, thanks to the moving software-integrated dark spot in the UV projection (FIG. 17D), injected resin can flow through the external viaduct and to the part build area, producing the desired Cross of St. George pattern in the print (FIG. 17E).

Resolution-Throughput Tradeoff in iCLIP Compared with Other Multi-Material Printing Approaches

From print hardware parameters, e.g., nozzle diameter, linear feed rate, and material switching times in direct ink write, inkjet, and polyjet 3D printers, it is possible to estimate resolution and throughput. While not taking into account factors such as “slump” in FDM printers extruding viscoelastic material, or start up and post-processing times, these are useful for comparative purposes. Of the reported multi-material polymeric 3D printing approaches, fused filament fabrication (FFF) can have very high throughput of multiple different extruded thermoplastics, but resolution through such large nozzles sizes is limited. Selective laser sintering (SLS) with multiple powders, while higher in resolution than FFF and benefitting from high laser scan rates, still suffers from the resolution limitations of the resulting melt, Direct ink write (DIW), and especially inkjet (IJ), approaches can display even higher spatial resolution, but volumetric injection rates are low, leading to low throughput. And traditional vat photopolymerization (VP) approaches, which can be high resolution as well, nonetheless suffer in throughput from the requirement to lift and retract every layer.

Unlike these multi-material printing platforms, iCLIP combines controlled mass transport of multiple materials in a high throughput printing process, with high pixel resolution. iCLIP, with a 30 μm UV projection pixel resolution and 50 mm/hr print speed implemented during multi-material print experiments, does not exceed the throughput of the fastest FFF multi-material printers or the resolution of the most detailed IJ printers, but strikes a unique balance between these considerations.

### Example 2—Fluidics-Informed Fabrication: A Novel Co-Design for Additive Manufacturing Framework

Effective design for additive manufacturing (DfAM) tools for ensuring digital models are 3D printable are crucial for realizing the benefits of this burgeoning fabrication technology. However, existing tools do not allow engineers to co-design the part itself for the manufacturing process, instead imposing cumbersome support structures on the model after the design stage. In this example a physics-informed generative design framework is presented allowing designers to readily take into account complex printing process fluid dynamics concurrent with 3D model development, facilitating printability and multimaterial printing.

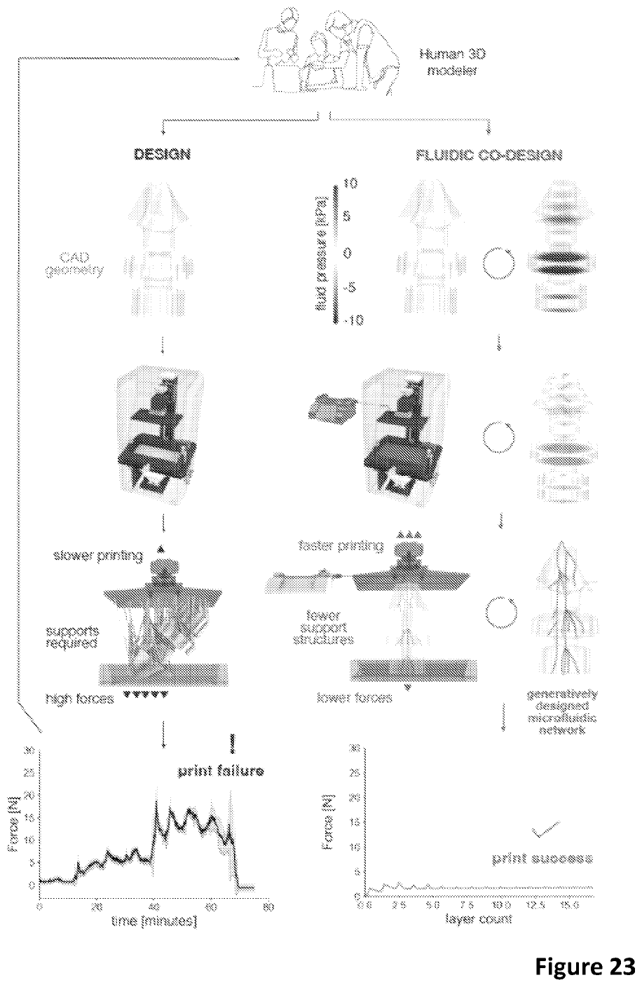

To provide a more user-friendly computational tool for designers seeking to use 3D printing, here we describe a novel 3D printing method that in some instances obviates the need for such supports in injection 3D printing. Injection printing as described herein is a fast, high-resolution vat-based 3D printing method that infuses resin through fluidic channels within the 3D model itself. Salient differences between traditional 3D printing and injection 3D printing are summarized in FIG. 23. Existing design for additive manufacturing approaches do not account for the fluid dynamics of the printing process itself, instead imposing cumbersome support structures that fail to prevent print failures. The generative co-design method described herein integrates design with fluid dynamics modeling to minimize forces during printing and thus maximize printability. Injection can effectively offset suction forces, hence reducing the need for supports, during printing. In addition, such channels can rapidly and spatial selectivity infuse multiple materials into the printer vat, or the object itself, through software-designed channels specifically designed to craft multimaterial objects. No commercially-available resin printers can currently enable the user to engage in such multimaterial printing.

In some instances, the design of a fluidic system within or around an object to satisfactorily offset suction forces and guide multimaterial distributions is described. To achieve this, also outlined is an algorithmic workflow that provides for multimaterial injection printing.

### Experimental User Design Testing

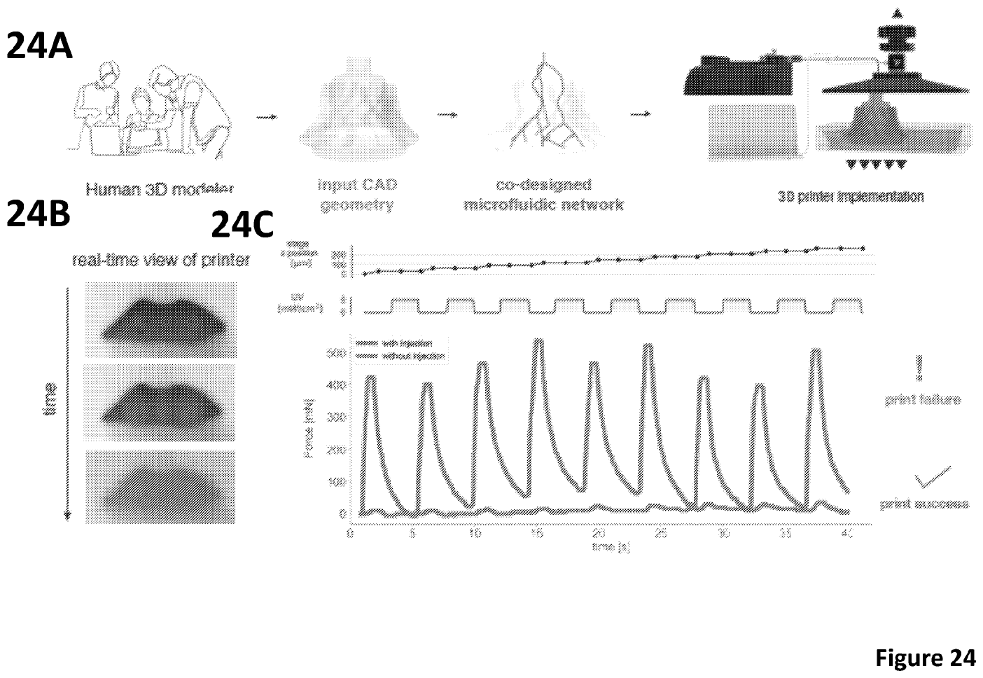

To validate experimentally, this example provides for the additive manufacturing of a mechanical turbine, as shown in FIGS. 24A-24C. During printing, as viewed in real time from beneath the printer apparatus, fluidic networks are confirmed to allow designers to precisely control fluid flows within the printer. To confirm that such networks also offset failure-inducing forces, a force sensor was installed on the printer. Every layer during printing, which corresponds with the lifting of the platform, a peak in force reading, of variable amplitude, is recorded by this force sensor. High forces are likely to cause print failures, as indicated in gray in the figure. This occurs when there is not injection during printing. By contrast, low forces allow print success, as indicated in red in the figure. As assessed by such online force sensors, injection through generatively-designed networks allow designers to significantly reduce forces during printing, compared with control experiments without injection.

### Visualization of Multi-Material Injection Printing

This example also experimentally validates that such variable-density generatively-designed fluidic networks, beyond reducing forces during fabrication to aid designers in making their models 3D printable, also allow designers to adjust the fraction of the print region filled by different materials. Such multimaterial injection 3D printing demands such careful control over fluid distributions during printing. To that end, integrated into the generative design software is a module to predict, as explained in more detail below, using surrogate fluid dynamics modeling, outflows of injected material during printing. This allows the user to adjust the fraction of an object filled by different materials, including with materials otherwise too viscous to print with because of the aforementioned suction forces. FIG. 24B illustrates boundaries between differently colored materials brought into the printer, either through injection or suction.

### Generative Design Methodology

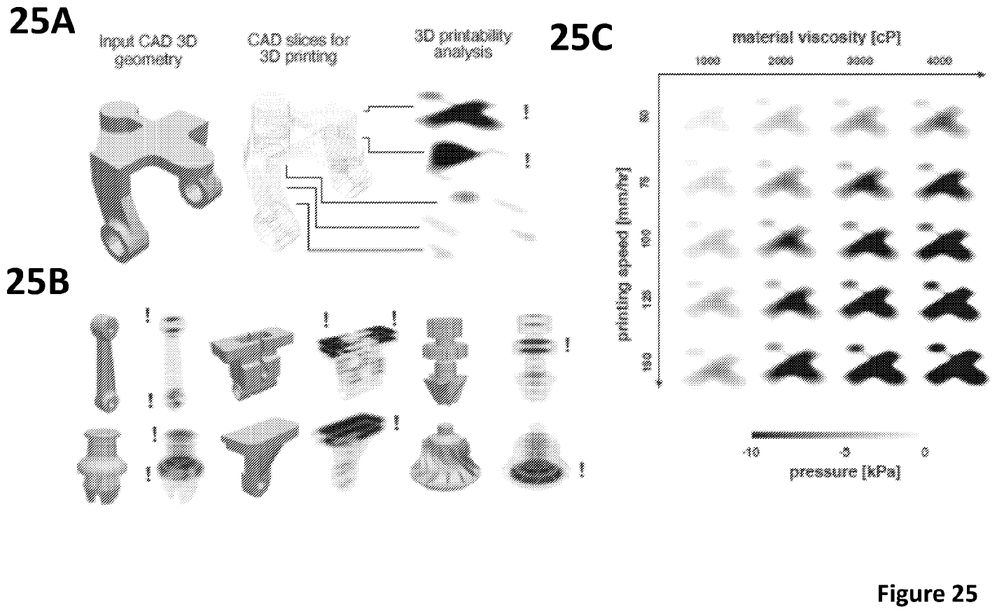

For an arbitrary 3D model provided as input by a CAD modeler and 3D printer user, a fluidic network that offsets suction can be constructed, in order to effectively replace, or minimize, support structures required. This example describes the software modules used to prepare a mechanical hinge structure, which possesses multiple arms and rapidly changing cross sectional areas, making the design of a corresponding fluidic network non-intuitive. A corresponding suitable 3D printable fluidic network is computationally designed that innervates the part to sufficiently distribute one, or multiple, materials during printing. Specifically, a trajectory optimization formulation fits well the design problem. For an input CAD to be 3D printed via a set of two dimensional layers, the back-end of the system calculates suction forces, which are flagged failure-prone CAD regions to the user (FIG. 25). The fluid dynamics modeling is achieved by modeling printing process fluid dynamics using lubrication theory, solved using Poisson's equation in two dimensions with irregular boundaries. The system achieves: a design that is an optimal graph network having injection nodes and edges to fully offset suction forces for every layer while printing 3D object, along with an appropriate layer-dependent set of pump injection instructions.

The system respects the following geometric requirements in the inverse design of a fluidic system for injection 3D printing. First, the design space for the innervating fluidic network is specified by the frontiers of a given input CAD geometry. Second, the generated channel arrangement at all layers is fully connected; this results from the need for, during printing, all points to be reachable by the injection site on the platform supplied by the pump.

### Procedure Modeling Methodology

The fabrication computational design methodology is divided in this example into three modules. In operation, the three modules can be in certain instances tightly integrated, and run in parallel, to produce a viable fluidic design for injection 3D printing.

### Network Design Module

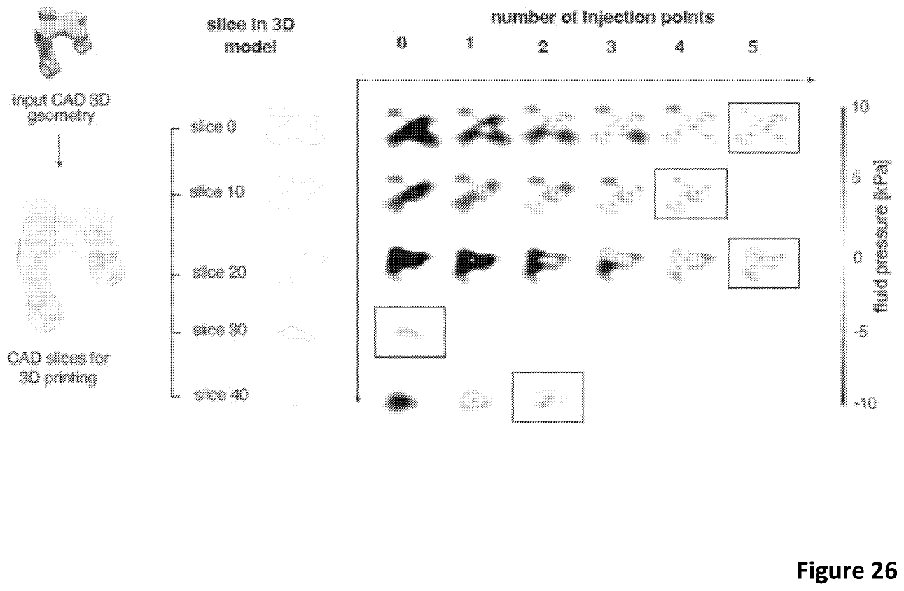

The initial design of our flow network is outlined in Algorithm 1 (Table 2.1), which recursively constructs a fully-connected network graph from an input CAD geometry. Our inverse design approach originates a fluidic network with a single input injection point connected to the build platform and, thus, the syringe pump. Then, injection channels are positioned within the user-provided model at optimal positions as determined by surrogate fluid dynamics modeling, in order to offset suction during printing to minimize need for supports. Specifically, high pressure injection sites are incrementally added to alleviate these suction forces (FIG. 26). The 3D point cloud specifying these microfluidic nodes is connected recursively into network branches, whereby shortest paths to a single input source are solved using a modified Dijkstra's algorithm implementation. Once swept to produce 3D multipipes, Boolean differencing produces negative channels in the original CAD geometry.

TABLE 2.1
Algorithm 1
Algorithm 1 DESIGN FLOW NETWORK

| | |
|---|---|
| 1: | function BUILD MICROFLUIDIC GRAPH(object P) |
| 2: | for slice 1, 2, . . . in P do |
| 3: | Compute force F = f_{x,y} p dxdy |
| 4: | while F < F_{crssscal} do |
| 5: | Add injection point d at argmin p to microfluidic graph μ_{x,y} |
| 6: | Recompute force F |
| 7: | end while |
| 8: | end for |
| 9: | return microfluidic graph μ |
| 10: | end function |

### Genetic Optimization Module

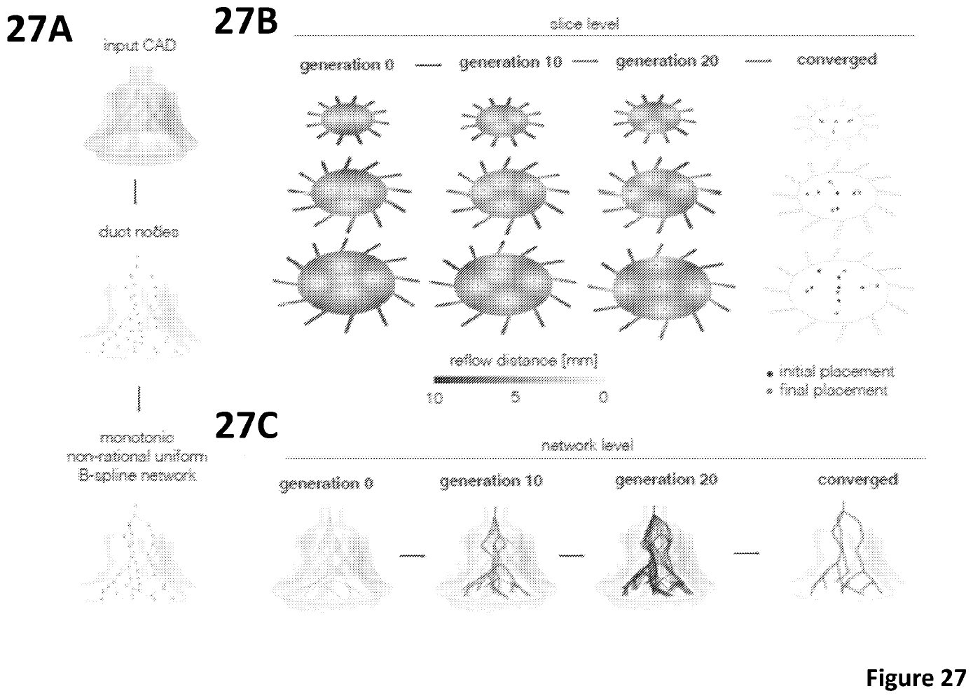

To further enhance microfluidic network design, a genetic optimization loop minimizes maximum fluid reflow distances during printing (FIGS. 27A-27C). Algorithm 2 (Table 2.2) summarizes this module in our generative design tool. A genetic optimization routine is performed to minimize the negative pressure during printing in all 2D cross sections of 3D part, performed on the initial network offsetting suction forces. An optimal solution is that which minimizes negative pressure during printing, but multiple potential solutions are identified by the position of one, or multiple, injection nodes. Potential solutions are mutated by shuffling injection nodes in a given cross section of an object, which can be delineated into a number of Voronoi regions organizing points according to their nearest fluid source, either by one injection node containing all closest pixels or by the part contour supplying fluid via suction. The system then recomputes for the user pressure fields to optimally alleviate negative pressure regions within the part.

TABLE 2.2
Algorithm 2
Algorithm 2 OPTIMIZE MICROFLUIDIO NETWORK

| | |
|---|---|
| 1: | function OPTIMIZE NETWORK(microfluidic graph D) |
| 2: | Compute current force F_{current} = f_{x,y} p dxdy with D |
| 3: | for generations 1, 2 . . . , G do |
| 4: | Mutate and crossover nodes d1, d2, . . . in D |
| 5: | if F_{mutated} < F_{current} then |
| 6: | Set best node positions Dₒₚₜ = D_{mutated} |
| 7: | end if |
| 8: | end for |
| 9: | return Dₒₚₜ |
| 10: | end function |

### Flow Rate Optimization Module

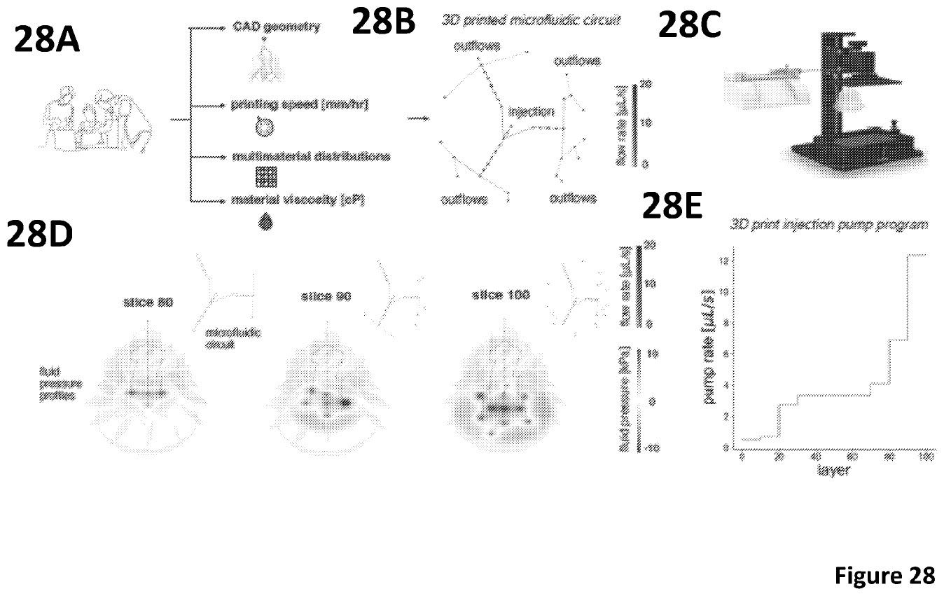

So that the designer need not intuitively guess what injection rates are required to administer through the fluidic network during printing, a module is integrated into the design strategy that computes these rates for all slices during printing. Specifically, optimal flow rates to administer through the network via injection during printing are computed using the circuit analogy for pressure-driven microfluidics. This circuit analogy captures the evolving nature of the network. Branches may be either open (with outlets), or branches may become closed if their termini are solidified within the object, thus not contributing to fluid flow. In the evolving graph, this is described by the case when a parent node in a given layer is assigned no child nodes in the next layer, such that node is a leaf node and the corresponding branch terminates. In this case, input injection flow is redirected to remaining active branches. Algorithm 3 (Table 2.3) summarizes the approach to integrating such flow analysis into the system. In short, input Fluidics-informed fabrication injection rates are incremented until fluid suction forces at a particular layer in the part are offset (FIG. 28).

TABLE 2.3
Algorithm 3
Algorithm 3 OPTIMIZE FLOW RATES

| | |
|---|---|
| 1: | function OPTIMIZE FLOW RATES(object O, microfluidic network N) |
| 2: | for slice s₁, s₂, . . . in O do |
| 3: | Build circuit representation for N supplying slice s |
| 4: | while Force > 0 do |
| 5: | Increment pump flow rate qᵢₙ |
| 6: | Recompute output flows qₒᵤₜ given qᵢₙ |
| 7: | Recompute Force for a given qₒᵤₜ |
| 8: | end while |
| 9: | end for |
| | return pump program P |
| 10: | end function |

### Injection 3D Printing Design Interface

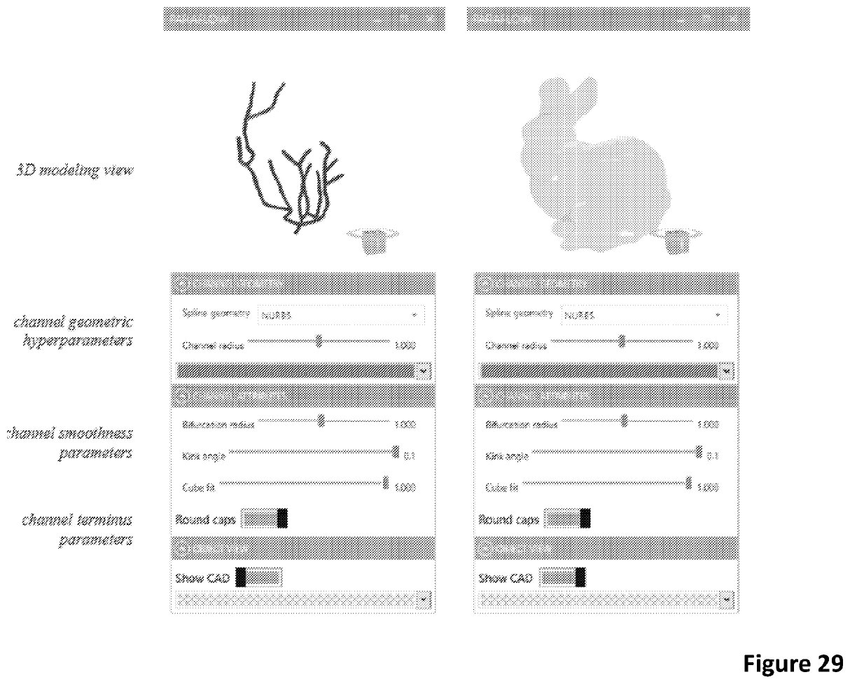

For designing an injection 3D printing, in some instances the system includes a user interface (FIG. 29). The modeling tool described in this example was implemented back-end in Python and is presented as an add-on plug-in to the 3D modeling program Rhinoceros 3D, and specifically its parametric design plug-in Grasshopper (GH). In short, the GH tool enables a Rhino3D CAD designer to design for injection 3D printing. The software imports both the input bounding CAD geometry and the generatively designed network, encoded as a connectivity matrix of nodes and edges. If desired, user modifications may be made via the custom interface. In particular, the user can adjust fluidic network geometry and hyperparameters such as channel radius and curvature prior to printing, using the GH post-processing script. The final network is then translated into spline geometry and then 3D channel geometry to be imported into the Rhino3D design environment.

### Example 3—Computational Co-Design for Supportless Vat Photopolymerization Additive Manufacturing

While 3D printing affords designers unprecedented geometric complexity in product design, currently it requires cumbersome support structures that are materially wasteful, human labor-intensive, time-consuming to remove, damaging to surface finish, and often unreliable in ensuring printability at all. To minimize need for such supports during vat 3D printing, or potentially entirely replace them in certain product cases, this example provides for a novel computational inverse design approach (referred to herein as “Paraflow”). This design innervates the to be printed part with fluidic channels that introduce one, or multiple different, resins into the printer, effectively offsetting forces otherwise necessitating support. This example outlines a fluid dynamics-informed generative design approach, characterize its design space flexibility and limitations, and validate experimentally its ability to offset forces otherwise requiring supports in vat-based 3D printing.

### Theoretical Background

### Modeling of 3D Printing Failure Modes

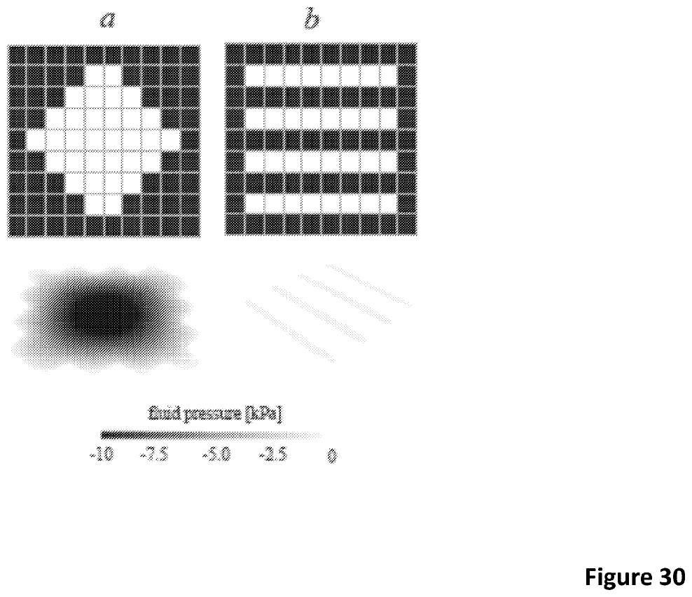

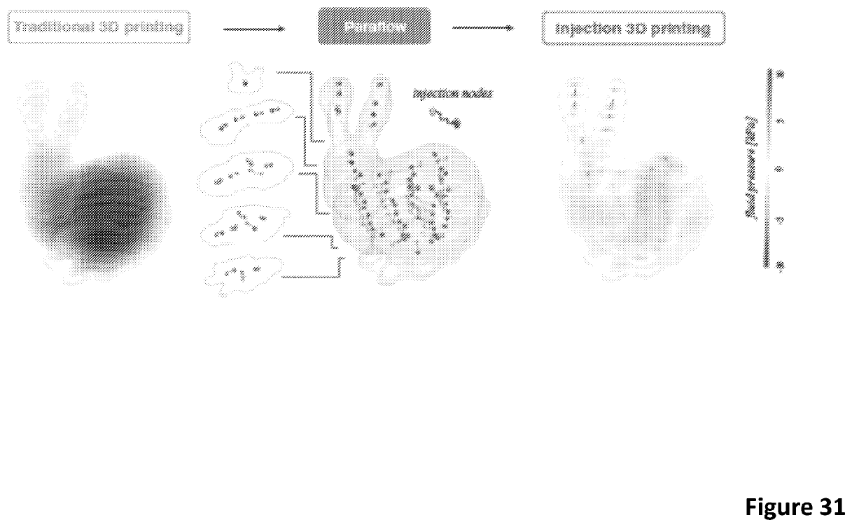

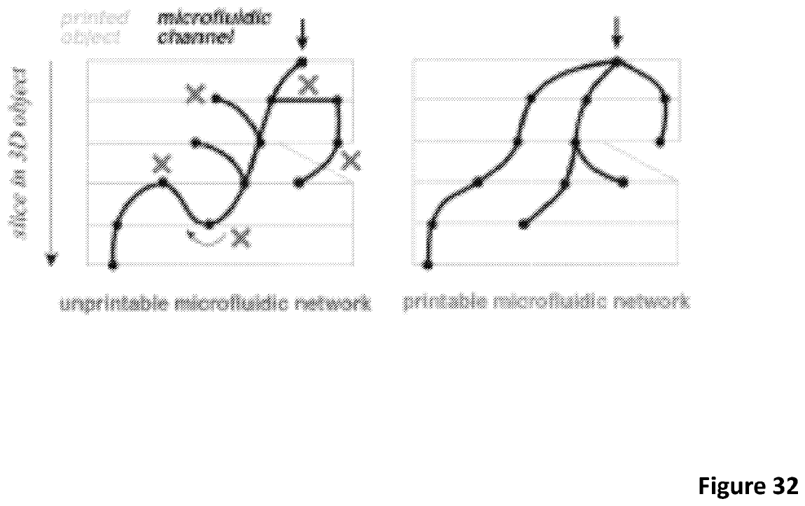

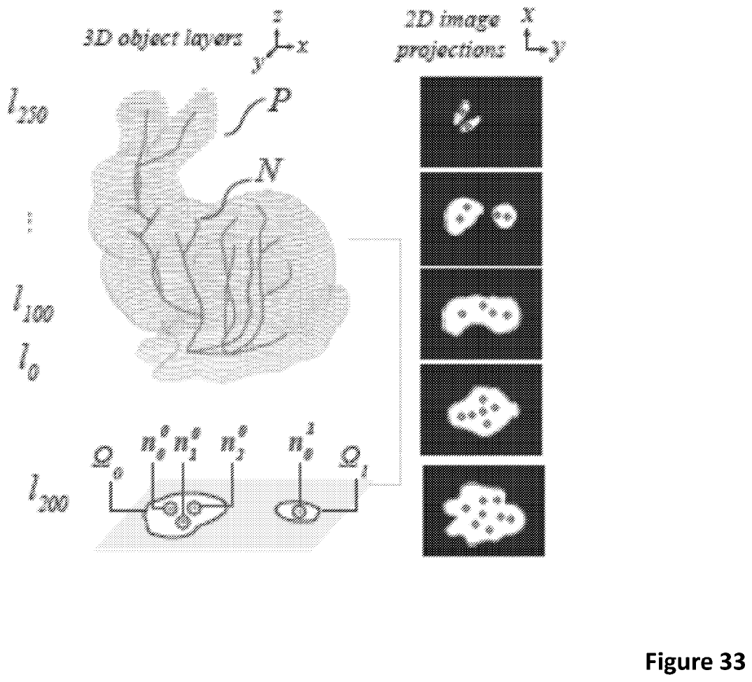

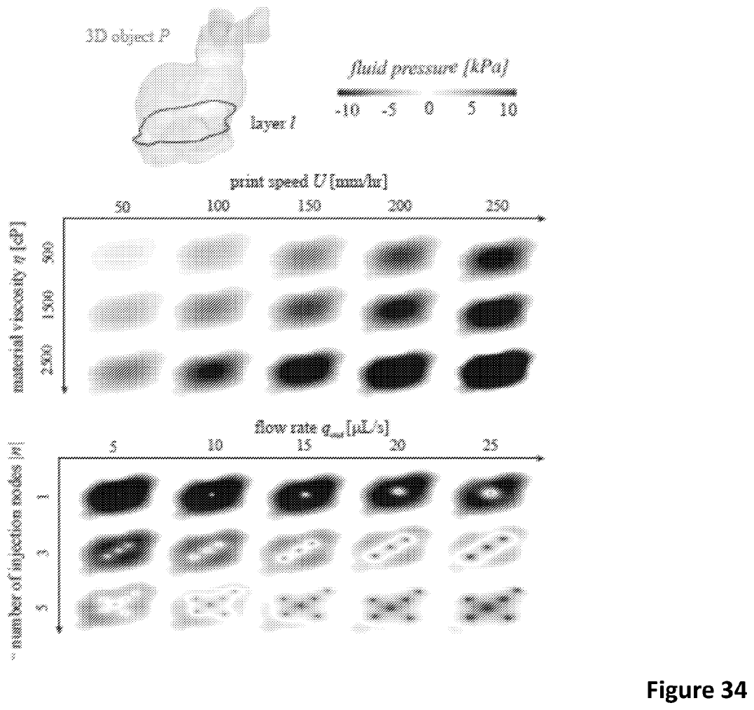

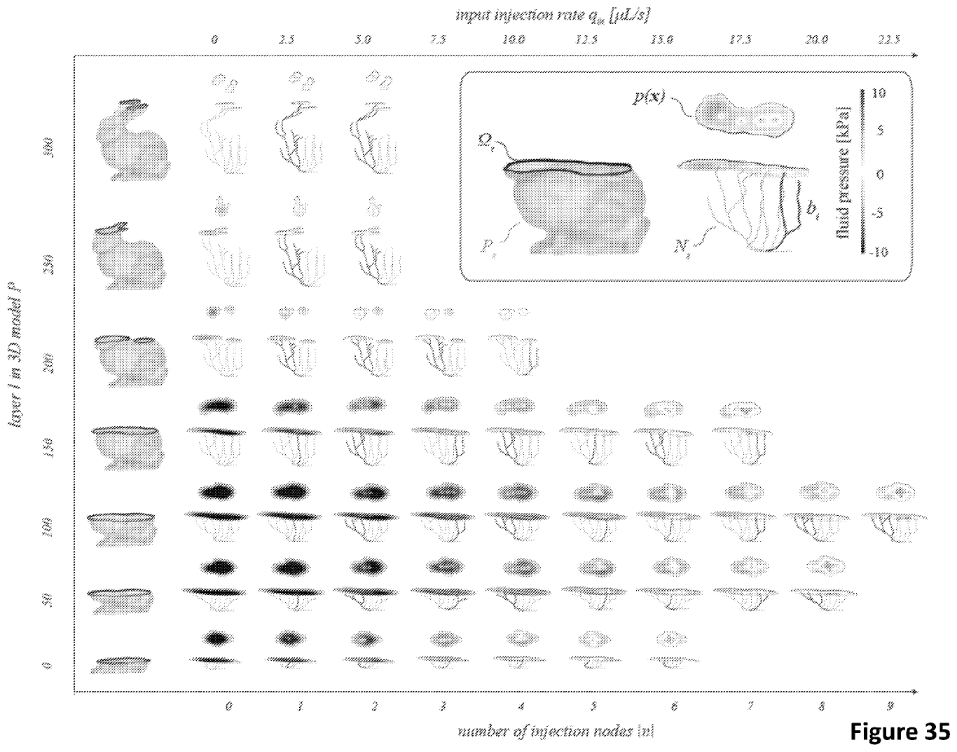

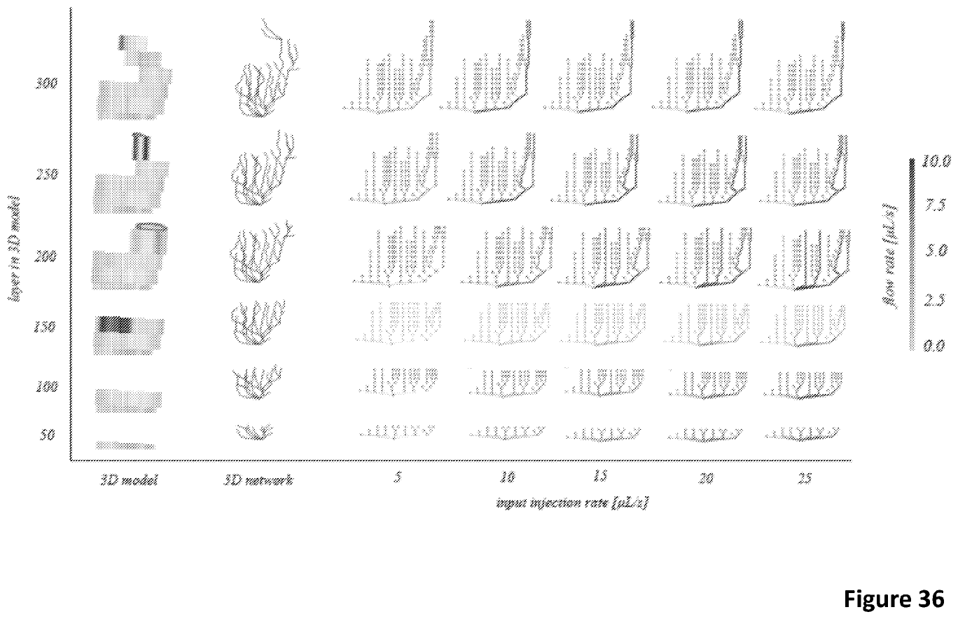

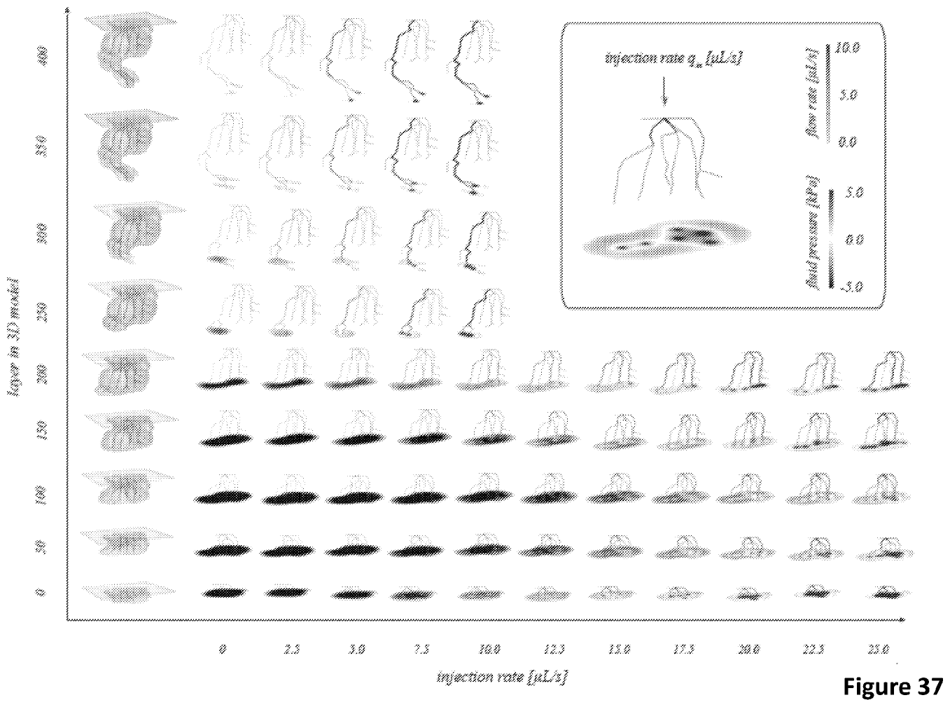

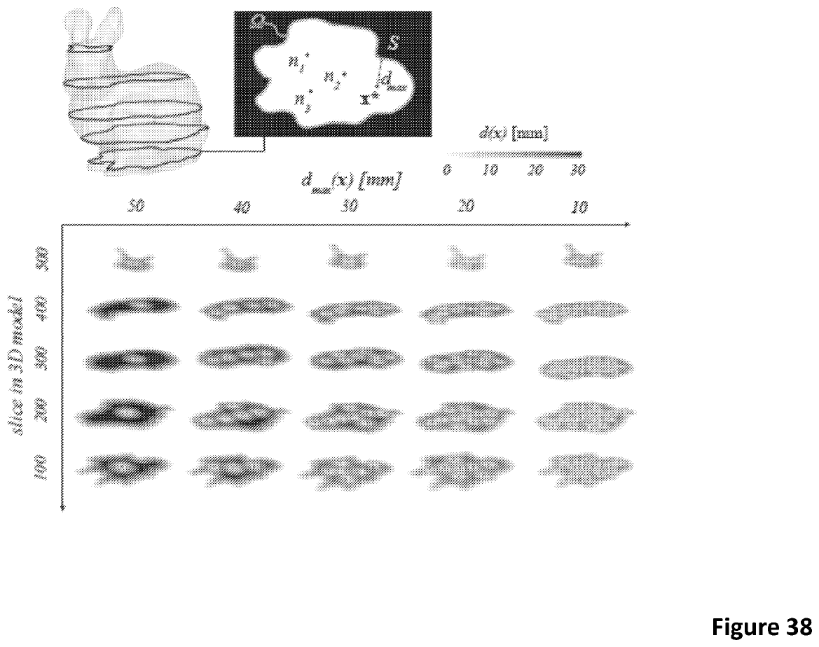

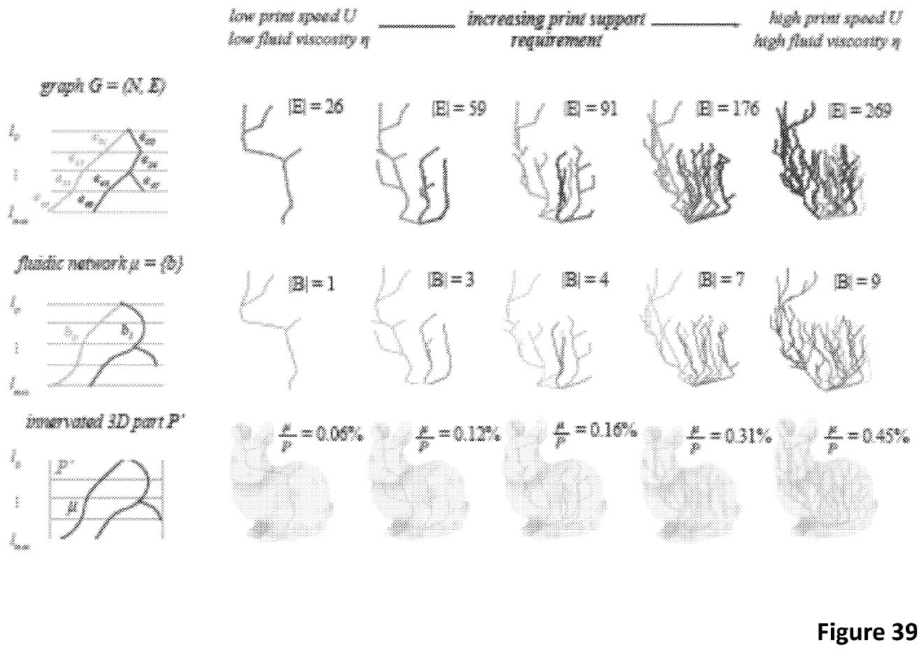

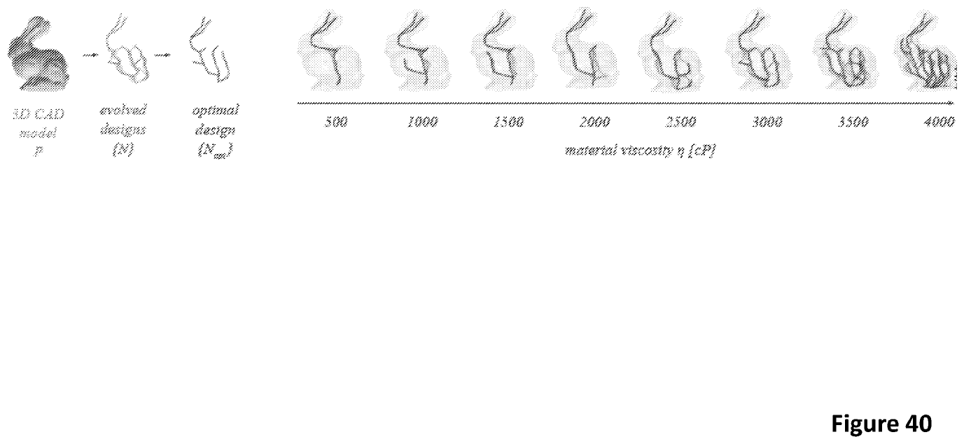

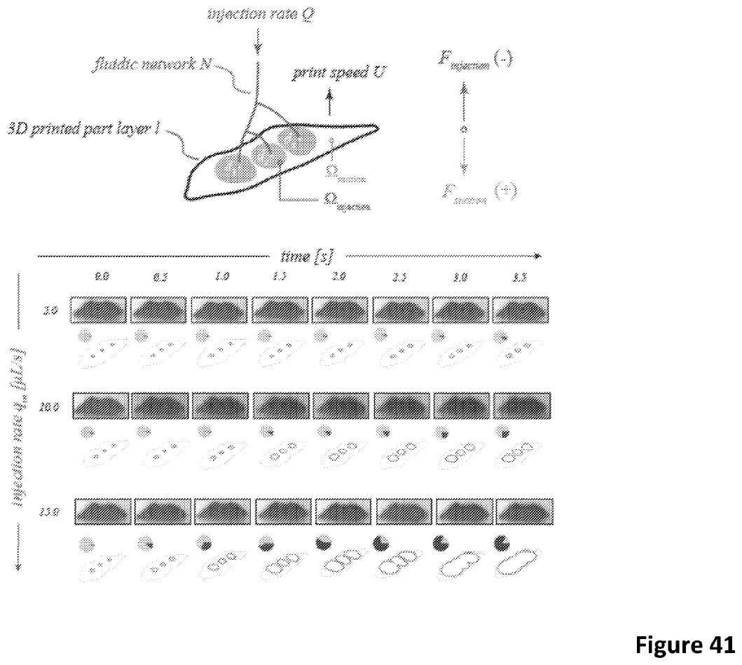

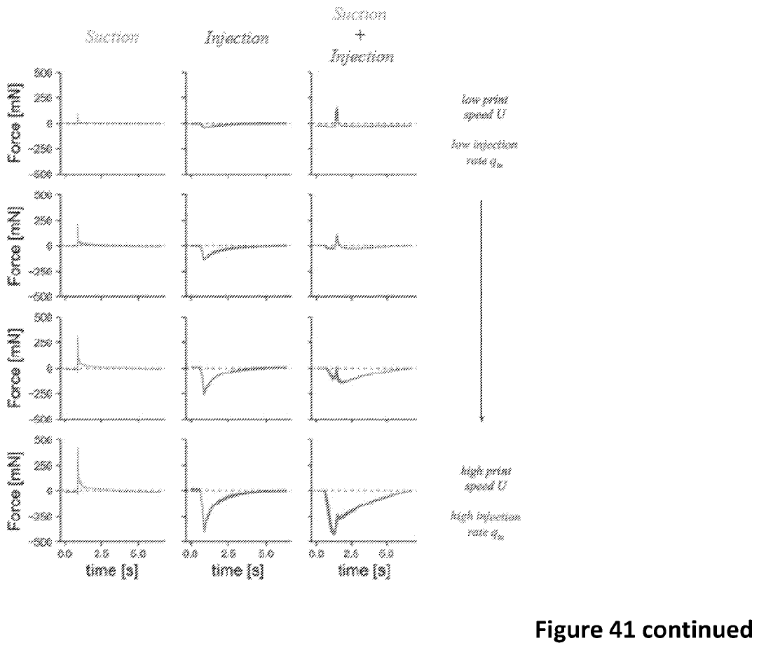

The theoretical prediction of 3D printing failures is a complex fluid-solid interaction problem. Print failure occurs when the downwards suction force Fₛ (“Stefan adhesion”) on a printing object P exceeds the work of adhesion between the object and the build surface. This force scales with cross sectional area, but non-linearly so: Fₛ IS highly dependent upon geometry, as shown in FIG. 30, where an arbitrary square-shaped printed layer/experiences significantly higher Stefan adhesion stresses than an array of thin rectangles, despite same percentage illumination. Lubrication theory constitutes an excellent approximation for fluid flows within thin gaps, where the characteristic horizontal length scale is much greater than the vertical length scale, governed by Poisson's equation in two dimensions. The governing equations for momentum are thus:

$$\frac{\partial p}{\partial z} \approx 0 \qquad ( 1 )$$

$$\frac{{\partial }^{2} \vec{u}}{\partial {z}^{2}} \approx ∇ p \qquad ( 2 )$$

And for continuity:

$$∇ \cdot \vec{u} + \frac{\partial {u}_{z}}{\partial z} = 0 \qquad ( 3 )$$

with the following boundary conditions imposed at the part contour Ω:

$$p = 0 at ( x , y ) ∈ Ω ( z ) \qquad ( 4 )$$

Integrating the equation for momentum gives, for a cylindrical geometry, the fluid velocity in the x and y directions:

$$\vec{u} \approx - \frac{1}{2} ∇ pz ( 1 - z ) \qquad ( 5 )$$

Integrating the equation for continuity give the velocity in the z direction:

$$\vec{{u}_{z}} = {\int }_{0}^{z} ∇ \cdot \vec{u} dz = 3 {u}_{z} ( z = 1 ) [ {z}^{2} - \frac{2}{3} {z}^{3} ] \qquad ( 6 )$$

The resulting suction force on object P resulting from negative pressure gradients can thus be modeled as:

$${∇}^{2} p = 12 {u}_{z} ( z = 1 ) \qquad ( 7 )$$

$$p ( r ) = 3 ( {r}^{2} - 1 ) \qquad ( 8 )$$

Integrated over the footprint of the part gives us an approximation of the force required to offset. For a cylindrical part of radius R:

$${F}_{s} = \frac{3 πμ {UR}^{4}}{2 {h}^{3}} \qquad ( 9 )$$

where μ is resin viscosity, U print speed, R print radius, and h thickness of the gap between printed object and tank. For geometries with irregular cross sections, we solve Poisson's equation in two dimensions to predict pressure profiles, and hence suction forces, during printing:

$$\frac{{\partial }^{2} p}{\partial {x}^{2}} + \frac{{\partial }^{2} p}{\partial {y}^{2}} = {u}_{z} \qquad ( 10 )$$

where μ_{z} describes the speed of printing. To solve this equation for our arbitrary input CAD geometry, we discretize and apply finite differencing on the uniform computational grid:

$$\frac{{p}_{i , j + 1} + {p}_{i , j - 1} - 2 {p}_{i , j}}{{dy}^{2}} + \frac{{p}_{i + 1 , j} + {p}_{i - 1 , j} - 2 {p}_{i , j}}{{dx}^{2}} = {u}_{z} \qquad ( 11 )$$

with an irregular Dirichlet boundary condition of p=0 applied at the boundary of the part approximated on the numerical grid. Integrated over the computational domain gives a numerical approximation for the suction force Fₛ as above.

### Modeling of Injection 3D Printing

When injecting material during printing at a rate Q relative to the printing speed U, the incremental pressure increase to offset suction is proportional to:

$${p}_{injection} ( r ) ∝ 6 \tilde{Q} ln \frac{1}{r} \qquad ( 12 )$$

where r is the distance from the injection site, capturing that the pressure increment is highest near the injection site, decaying with distance. The right-hand side of Equation 10 is modified to account for injection with a forcing term, f(x,y), at discrete locations in the fluid domain, whose magnitude depends upon the injection flow rate Q relative to the print speed u_{z}:

$$\frac{{\partial }^{2} p}{\partial {x}^{2}} + \frac{{\partial }^{2} p}{\partial {y}^{2}} = {u}_{z} - f ( x , y ) \qquad ( 13 )$$

Overall, this means that the suction force Fₛ can be offset, provided a high enough injection rate Q is administered:

$${F}_{inject} = 3 π \tilde{Q} \frac{η {UR}^{4}}{{h}^{3}} \qquad ( 14 )$$

This theoretical underpinning underlies our inverse design approach to alleviate suction during vat 3D printing, described below.

### Inverse Design Approach

### Formulation of the Design Problem

For an arbitrary input 3D model part P, to offset suction forces Fₛ during 3D printing in order to effectively replace, or minimize, support structures required. To achieve this, our tool, termed Paraflow, takes the computational bounding volume represented by P as input and inverse designs a network μ that, at each layer l during printing part P, administers flow to part cross sections S through one or potentially several branches {b} to offset suction Fₛ. All branches b are connected to a single input source node n₀ through which a single input flow rate qᵢₙ is administered. This leads to a natural formal representation of the to-be-printed 3D microfluidic network μ is as a graph G≡(N,E) with nodes N={nᵢ}, where nodes in adjacent layers l and l+1 are connected by edges e∈E={eᵢⱼ}⊂V×V. We store injection node connectivities in an adjacency matrix A where A_{m,n} describes the connectivity between nodes m and n. The problem is therefore twofold: to design an optimal graph network G having injection nodes {n} and edges {eᵢⱼ} to fully offset suction forces Fₛ for every layer l while printing 3D object P, along with an appropriate layer-dependent set of pump injection instructions qᵢₙ(l) to administer during printing. Several 3D printing design space constraints are relevant to such a generative task.

### Definition of the Design Space

Hard Constraints. The inverse designed fluidic network is subject to the following inviolable constraints, summarized to right in two dimensions for clarity. First the network graph G, which is dynamically growing during printing, should at all layers l be fully connected, with all nodes n reachable by the root note n₀ supplied by the pump. (FIG. 32) Never should a partial network Nₜ exist where an outlet node n is not supplied by source n₀. Formally:

$$\{ {n}_{i} , {n}_{0} \} = 1 ∀ {n}_{i} ∈ {N}_{j} \qquad ( 15 )$$

Second, the network must be increasing with respect to the printing axis, as illustrated in FIG. 33. Otherwise, at given times t during additive fabrication, certain sections of the network μ would be unreachable by source node n₀. Mathematically, we enforce this constraint by requiring all edges e in the graph G are monotonically increasing: the z component of the vector describing each edge in the tree, u_{z}(eᵢⱼ), is always negative:

$${u}_{z} ( {e}_{ij} ) < 0 ∀ {e}_{ij} ∈ G \qquad ( 16 )$$

Third, the resulting fluidic network must be a fully closed system; outlets should only direct flow into the vat, and not external to the part into atmosphere; otherwise, output flows qₒᵤₜ into the vat cannot be accurately predicted. Finally, at no time should channel radii fall below the minimum negative feature resolution of the 3D printer, rₘᵢₙ, hence be unprintable.

Soft Constraints. In addition, we encode several soft constraints to facilitate the printability of generatively designed networks. First, it is desirable to minimize the tortuosity τ of the network, to avoid channel solidification during printing caused by penetration of light into channels with large horizontal components. Smooth networks also minimize frictional energy loss around sharp corners during pumping. Relatedly, it is desirable to produce the shortest possible network, given the pump pressure required to drive viscous flow through a fluidic network increases with the total length of the network. With these constraints, we now describe how inverse design approach.

### Inverse Design Algorithm

Procedural fluidic network modeling. The input to our algorithm, described in Algorithm 1 (Table 3.1), is either a mesh or a boundary representation (B-rep) describing the part P. Our first step is an image processing routine performed on P: binary image slices were extracted by drawing incremental planes through an axis-aligned bounding box around the input CAD geometry. Using the elevation distance z of every point on the surface mesh, one, or multiple, part footprints S at a given layer l are identified, as level sets induced by z. For every layer l, the need for support is evaluated by explicitly incorporating physical factors influencing printability including the geometry of S, along with print speed U and material viscosity η. An example slice-by-slice analysis is shown in FIG. 34. Specifically, a partial differential equation-based surrogate fluid dynamics modeling is performed, solving Poisson's equation in two dimensions with Robin boundary conditions.

TABLE 3.1
Algorithm 1
Algorithm 2: CO-DESIGN 3D FLUIDIC NETWORK

| 1 | Function Construct network(P): | | | | [symbol] 3D part P |
|---|---|---|---|---|---|
| 2 | \| | Initialize G ← { } | | | [symbol] tree network G |
| 3 | \| | foreach l = 1, 2, . . . lₘₐₓ do | | | [symbol] 2D layer l |
| 4 | \| | \| | Compute Fₛ = ∫ p dA | | [symbol] force Fₛ, pressure p |
| 5 | \| | \| | Initialize Q₀(l) = 0 | | [symbol] injection inflow Q₀ |
| 6 | \| | \| | while ∃S ϵ l : Fₛ (S) > 0 do | | [symbol] 2D shape S |
| 7 | \| | \| | \| | Add nᵢ at argmin p to G_{x,y} | [symbol] injection node n |
| 8 | \| | \| | \| | Find nearest neighbor nⱼ in layer l − 1 | |
| 9 | \| | \| | \| | Add eᵢⱼ to G | [symbol] channel edge e |
| 10 | \| | \| | \| | Reconstruct circuit description of G | |
| 11 | \| | \| | \| | Increment Q₀ and compute Qₒᵤₜ | [symbol] outflows Oₒᵤₜ |
| 12 | \| | \| | \| | Recompute Fₛ | |

| 13 | \| | \| | end | |
|---|---|---|---|---|
| 14 | \| | \| | Add Q₀(s) to pump program | |
| 15 | \| | end | | |
| 16 | \| | Initialize μ ← { } | | [symbol] fluidic geometry μ |
| 17 | \| | foreach b = 1, 2, . . . ϵ G do | | [symbol] branch b |
| 18 | \| | \| | Construct c from nodes {n} in b | [symbol] NURBS curve c |

| | | | |
|---|---|---|---|
| 19 | \| | \| | Add multipipe swept along c to μ |

| | | | |
|---|---|---|---|
| 20 | \| | end | |
| 21 | \| | Boolean difference P′ = P ⊖ μ | [symbol] innervated part P′ |
| 22 | \| | return P′, pump program | |

23

Increasing print speed U and material viscosity η cause higher suction forces Fₛ, and hence higher likelihoods that a given cross section in the modeled 3D geometry will fail during printing. We then take advantage of injection 3D printing to co-design a network offsetting these forces. To build the network from P, our approach originates the graph G with the single root input injection node n₀ connected to the syringe pump at the first layer in P, l₀. Thereafter, for every layer l, injection nodes n and increment the input flow rate qᵢₙ are inserted until suction forces Fₛ are offset. This approach is shown in FIG. 35. Specifically, injection nodes n are added to the part footprint at positions (x,y) in the 2D slice plane at the global minimum of the predicted fluid pressure profile p(x), i.e.:

$$n \to {x}^{*} = {arg min}_{x} p ( x ) \qquad ( 17 )$$

If multiple such minima exist, we choose the point with the maximum Hausdorff distance to the contour of the printed object, Ω. Every time a node n is added to a layer l in the 3D object P, an edge e connecting that node to the growing network G is also added, such that this node can be supplied with resin at the appropriate time during printing, subject to the constraints of the additive manufacturing process—nodes on layer l must be connected to nodes on adjacent layers l−1 and l+1. Since it is desirable to produce a network that connects the set of nodes N in a graph G with shortest path from a given node n to the source node n₀, an edge e is added to an existing, or new, branch of the network connecting a new node n with its nearest neighbor in layer l−1. Fluid pressure profiles are then recomputed with the added node n and edge e.

Predicting flow through generatively designed fluidic networks. As the network graph G grows in complexity, it becomes important to accurately predict flow from the single input source n₀ with a single input flow rate qᵢₙ to all outlet nodes {n}ₗ in a given layer l with varying outflows qₒᵤₜ (n). For an accurate and computationally tractable estimate, G as an electrical circuit is modeled, as is typical for pressure-driven fluidics. Specifically, a corresponding circuit representation is constructed for every dynamic microfluidic network Nₜ at time t during printing of object P (FIG. 36). This circuit analogy captures the evolving nature of the network G, where branches b may become closed if their termini are solidified within the object, thus not contributing to fluid flow. In evolving graph G, this is described by the case when a parent node n in layer l is assigned no child nodes in layer l+1, such that node n is a leaf node and the corresponding branch b terminates. In this case, input injection flow qᵢₙ is redirected to remaining active branches.

Combined with our forward fluid dynamics model, which predicts pressure profiles p and corresponding suction forces Fₛ for a given layer l with regions S and a distribution of nodes n and given flow rates from every node qₒᵤₜ(n), this allows us to compute a predicted pressure profile using a vector of potentially varying outflows qₒᵤₜ for a given input flow rate qᵢₙ (FIG. 37). Each time a node n is added to a layer l, the input injection rate qᵢₙ is incremented. We repeat until our termination criterion of zero net fluid suction is satisfied, i.e. Fₛ=0 at any section S, or formally:

$${n}_{l} , {q}_{in} ( l ) \to \{ \vert {F}_{s} ( S ) \vert \leq 0 ∀ S ∈ l \} \qquad ( 18 )$$

This produces a time-dependent syringe pump injection profile qᵢₙ(l), which can be sent as serial commands over the course of the entire print. Layers l of the part P containing footprints S with larger cross sectional areas require more injection sites {n}ₗ and, correspondingly, higher input injection rates qᵢₙ to fully offset suction forces Fₛ (FIG. 37).

Optimization of 3D fluidic network. Having generated an initial network G offsetting suction forces Fₛ in all 2D cross sections S of 3D part P, a metaheuristic evolutionary optimization routine is performed to minimize the magnitude of pₘᵢₙ in all layers l. Specifically, we implement a genetic algorithm where a candidate solution {n} is described by the position of one, or multiple, injection nodes n, and an optimal solution {n}ₒₚₜ is that which minimizes |pₘᵢₙ|. To calculate the location x of minimum fluid pressure pₘᵢₙ for a given part cross section S, it is not necessary to solve for the full fluid pressure distribution p(x) every iteration that positions of nodes {n} are updated, which would be computationally expensive. Rather, pₘᵢₙ(x) will be located at the point x in S with the greatest Euclidean distance d(x) to either the part contour Ω or an injection node n:

$$d ( x ) = min \{ {‖ x - n ‖}_{2} ∀ n ∈ n , {‖ x - Ω ‖}_{2} \} \qquad ( 19 )$$

This subdivides S into a number of Voronoi regions equal to |n|+1 for part cross section S, each specified either by one of |n| injection nodes in S containing all points closest to node n:

$$V ( {n}_{i} ) = \{ x : d ( x , {n}_{i} ) \leq d ( x , {n}^{′} ) ∀ {n}^{′} ∈ N \} \qquad ( 20 )$$

or by the part contour Ω supplying fluid via suction and all points closer to Ω than to any node n:

$$V ( Ω ) = \{ x : d ( x , Ω ) \leq d ( x , {n}^{′} ) ∀ {n}^{′} ∈ N \} \qquad ( 21 )$$

Illustrative such Voronoi tessellations V(n, Ω) for varying layers l in a 3D object are shown in FIG. 38, where each node n and part contour Ω in S is assigned a region of closest points x. The objective function to minimize is hence, for every part section S, the maximum distance dₘₐₓ from any point x to a fluid source, either an injection node n or part contour

$$Ω : {d}_{max} ( S , n , Ω ) = {max}_{∀ x ∈ S} d ( x ) .$$

This equates to minimizing the negative fluid pressure |pₘᵢₙ|:

$${\{ n \}}_{opt} = {arg min}_{\{ n \}} \vert {p}_{min} ( x ) \vert \qquad ( 22 )$$

Inverse design solution space. The final network G representing the fluidic system, encoded as a graph connectivity matrix of nodes and edges, is converted to a series of smooth NURBS curves. This parametric CAD is swept to produce a positive network 3D geometry, and finally Boolean differenced with the original B-rep CAD model via surface-to-surface intersection to produce negative channels, hence an innervated part P′ (FIG. 39). While there is one optimal network that minimizes |pₘᵢₙ|, many feasible network configurations may both offset suction Fₛ for all layers l, while satisfying the design space constraints described above. Formally the solution set of potential networks G with a fluid pressure threshold pₘᵢₙ is described by:

$$\{ G \} = \{ G \to ∀ x ∈ P , p ( x ) > {p}_{min} \} \qquad ( 23 )$$

with an optimum that minimizes suction force Fₛ:

$${G}_{opt} = {arg min}_{G ∈ \{ G \}} {\sum }_{l} {F}_{s} ( l ) \qquad ( 24 )$$

Several example solution sets of fluidic networks {G}, with the minimum-pressure solution Gₒₚₜ, are shown in FIG. 40. Higher variance is generally observed in part footprints S with higher cross sectional area A_{c}. All generated fluidic networks satisfy design objectives for a given printer and material configuration provided, but some may be more satisfactory for the given product requirements. Akin to commercially available generative design tools, the designer is presented with multiple potential options. Since designs are loadable into parametric design software, the designer can continue to spatially adjust control points describing NURBS curves that comprise the network G if desired.

### Experimental Validation

To validate our fluidic inverse design approach, our set-up for measuring forces during resin printing is illustrated to right. In brief, we position both a load cell on the platform of our printer, to record suction forces, and a camera underneath the vat, to visualize the flow of injected resin. As shown in FIG. 41, these online force sensors demonstrate that flow through these generatively-designed networks significantly reduce forces during printing, compared with control experiments without injection. This effect scales with the number of injection sites, as expected, and with the area of the printed object. These results demonstrate fluidic injection offers a viable replacement for supports in some product cases. We emphasize that not all scenarios may allow for such an optimistic outcome. In particular, supports are also needed for printing so-called “island” geometries that would otherwise have no pre-existing part onto which to attach.

In this case, supports will still be necessary. Nonetheless, in cases where large part cross sections threaten print failures, this demonstrates fluidic inverse design provide a promising alternative.

### CONCLUSION

Here, we presented our novel injection 3D printing method and its accompanying 3D generative design tool, Paraflow, which together minimize the need for supports on existing resin 3D printers and enable multimaterial printing. Our procedural modeling method can achieve this with minimal changes to the hardware of existing resin printers: only an inexpensive pressure-driven syringe pump is required for our add-on. Future work will seek to incorporate real-time force readings into our computational design approach, improve the computational efficiency of our generative design optimization routine, and further develop computational approaches for fluid injection through multimaterial objects, in particular architected heterogeneous lattice structures.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A method for making a polymeric structure comprising one or more microchannels positioned within the polymeric structure, the method comprising:
a) conveying a polymerizable composition through a conduit into a space between a build elevator and a build surface of a liquid interface production module;
b) irradiating the polymerizable composition positioned between the build elevator and the build surface to generate a polymerizable composition comprising a first polymerized region of the polymerizable composition comprising a microchannel in contact with the build elevator and a first non-polymerized region of the polymerizable composition in contact with the build surface;
c) displacing the build elevator away from the build surface;
d) irradiating the first non-polymerized region of the polymerizable composition to generate a second polymerized region of the polymerizable composition in contact with the first polymerized region and a second non-polymerized region in contact with the build surface; and
e) repeating steps a)-c) in a manner sufficient to generate a polymeric structure comprising one or more microchannels positioned within the polymeric structure.

2. The method according to claim 1, wherein the method comprises injecting the polymerizable composition through the conduit with a syringe pump.

3. The method according to claim 1, wherein the method comprises conveying two or more different polymerizable materials into the space between the build elevator and the build surface.

4. The method according to claim 3, wherein the method comprises:
conveying a first polymerizable material through a first conduit into the space between the build elevator and the build surface; and
conveying a second polymerizable material through a second conduit into the space between the build elevator and the build surface.

5. The method according to claim 3, wherein the method comprises conveying a plurality of different polymerizable materials through a plurality of different conduits into the space between the build elevator and the build surface.

6. The method according to claim 1, wherein the method comprises modeling a predetermined fluidic network geometry for the microchannels positioned within the polymeric structure.

7. The method according to claim 6, wherein the predetermined fluidic network geometry of the microchannels is based on the three-dimensional shape of the generated polymeric structure.

8. The method according to claim 1, wherein method further comprises filling at least a portion of the void volume of one or more microchannels of the generated polymeric structure.

9. A system for making a polymeric structure comprising one or more microchannels positioned within the polymeric structure, the system comprising:
a light source;
a liquid interface polymerization module comprising a build elevator and a build surface configured for generating the polymeric structure comprising one or more microchannels from a polymerizable composition positioned therebetween; and
a conduit for conveying polymerizable composition to the liquid interface polymerization module.

10. The system according to claim 9, wherein the system further comprises a syringe pump configured to inject the polymerizable composition into the liquid interface polymerization module through the conduit.

11. The system according to claim 9, wherein the system comprises a plurality of conduits configured to convey a plurality of different polymerizable materials to the liquid interface polymerization module.

12. The system according to claim 9, wherein the system further comprises a processor comprising memory operably coupled to the processor wherein the memory comprises instructions stored thereon, which when executed by the processor, cause the processor to:
a) irradiate a polymerizable composition positioned between the build elevator and the build surface to generate a polymerizable composition comprising a first polymerized region of the polymerizable composition in contact with the build elevator and a first non-polymerized region of the polymerizable composition in contact with the build surface;
b) displace the build elevator away from the build surface;
c) irradiate the first non-polymerized region of the polymerizable composition to generate a second polymerized region of the polymerizable composition in contact with the first polymerized region and a second non-polymerized region in contact with the build surface; and
d) repeat steps a)-c) in a manner sufficient to generate a polymeric structure comprising one or more microchannels positioned within the polymeric structure.

13. The system according to claim 12, wherein the memory comprises instructions stored thereon, which when executed by the processor cause the processor to model a predetermined fluidic network geometry for the microchannels positioned within the polymeric structure.

14. A polymeric structure comprising one or more microchannels positioned within the polymeric structure.

15. A non-transitory computer readable storage medium for making a polymeric structure in a liquid interface production module, wherein the non-transitory computer readable storage medium comprises instructions stored thereon, the instruction comprising:
algorithm for conveying a polymerizable composition through a conduit into a space between a build elevator and a build surface of a liquid interface production module;
algorithm for irradiating the polymerizable composition positioned between the build elevator and the build surface to generate a polymerizable composition comprising a first polymerized region of the polymerizable composition comprising a microchannel in contact with the build elevator and a first non-polymerized region of the polymerizable composition in contact with the build surface;
algorithm for displacing the build elevator away from the build surface;
algorithm irradiating the first non-polymerized region of the polymerizable composition to generate a second polymerized region of the polymerizable composition in contact with the first polymerized region and a second non-polymerized region in contact with the build surface; and
algorithm for repeating one or more steps in a manner sufficient to generate a polymeric structure comprising one or more microchannels positioned within the polymeric structure.
